(19) United States
(12) Patent Application Publication
(10) Pub. No.: US 2022/0050858 A1
(43) Pub. Date: Feb. 17, 2022

(54) Snapshot-Based Hydration Of A Cloud-Based Storage System

(71) Applicant: PURE STORAGE, INC., Mountain View, CA (US)

(72) Inventors: RONALD KARR, PALO ALTO, CA (US); JOHN COLGROVE, LOS ALTOS, CA (US); ANDREW BERNAT, MOUNTAIN VIEW, CA (US); BENJAMIN BOROWIEC, SAN JOSE, CA (US)

(21) Appl. No.: 17/514,702

(22) Filed: Oct. 29, 2021

Related U.S. Application Data
(63) Continuation-in-part of application No. 16/676,675, filed on Nov. 7, 2019.
Application No. 16/676,675 is a continuation of application No. 14/577,110, filed on Dec. 19, 2014, now Pat. No. 10,545,987.

(51) Int. Cl. G06F 16/27; G06F 16/174; G06F 11/14; G06F 3/06

(52) U.S. Cl. CPC G06F 16/27; G06F 16/1744; G06F 16/1748; G06F 11/1456; G06F 3/0608; G06F 3/061; G06F 2201/84; G06F 3/0617; G06F 3/067; G06F 3/065; G06F 11/1451; G06F 11/1453; G06F 11/1458

(57) ABSTRACT

Systems, methods, and computer readable storage mediums for snapshot-based hydration of a cloud-based storage system, including: storing, in a cloud computing environment, a snapshot of a dataset that is stored on a separate storage system, wherein the snapshot includes a self-described copy of the dataset such that the dataset can be reconstructed without accessing the separate storage system; creating, in a cloud computing environment, at least a portion of a cloud-based storage system; and populating, from the snapshot that is stored in the cloud computing environment, at least a portion of a storage layer within the cloud-based storage system, wherein the cloud-based storage system can service I/O operations to the dataset after the storage layer has been populated.

### CROSS-REFERENCE TO RELATED APPLICATIONS

This is a continuation in-part application for patent entitled to a filing date and claiming the benefit of earlier-filed U.S. patent application Ser. No. 16/676,675, filed Nov. 7, 2019, herein incorporated by reference in its entirety, which is a continuation of U.S. Pat. No. 10,545,987, issued Jan. 28, 2020.

### BRIEF DESCRIPTION OF THE DRAWINGS

FIG. 1A illustrates a first example system for data storage in accordance with some implementations.

FIG. 1B illustrates a second example system for data storage in accordance with some implementations.

FIG. 1C illustrates a third example system for data storage in accordance with some implementations.

FIG. 1D illustrates a fourth example system for data storage in accordance with some implementations.

FIG. 2 is a block diagram illustrating one embodiment of a storage environment.

FIG. 3 is a graphical user interface (GUI) for managing a replication environment.

FIG. 4 is a generalized flow diagram illustrating one embodiment of a method for performing replication.

FIG. 5 is a generalized flow diagram illustrating one embodiment of a method for replicating to the cloud.

FIG. 6 is a generalized flow diagram illustrating one embodiment of a method for performing replication.

FIG. 7 is a generalized flow diagram illustrating one embodiment of a method for performing replication to the cloud.

FIG. 8 is a generalized flow diagram illustrating one embodiment of a method for performing replication to the cloud.

FIG. 9 is a generalized block diagram of one embodiment of a directed acyclic graph (DAG) of mediums.

FIG. 10 illustrates one embodiment of a medium mapping table.

FIG. 11 illustrates one embodiment of a table utilized by a storage controller.

FIG. 12 is a generalized block diagram of one embodiment of a system with multiple storage arrays.

FIG. 13 illustrates one embodiment of a table for mapping original system ID to local medium ID.

FIG. 14 illustrates one embodiment of a set of tables utilized during a replication process.

FIG. 15 illustrates another embodiment of a set of tables utilized during a replication process.

FIG. 16 is a generalized flow diagram illustrating one embodiment of a method for replicating a snapshot at an original storage array.

FIG. 17 is a generalized flow diagram illustrating one embodiment of a method for replicating a snapshot at a replica storage array.

FIG. 18 is a generalized flow diagram illustrating one embodiment of a method for sending a medium ‘M’ to a replica storage array ‘R’.

FIG. 19 is a generalized flow diagram illustrating one embodiment of a method for emitting a sector <M, s>.

FIG. 20 is a generalized flow diagram illustrating one embodiment of a method for utilizing mediums to facilitate replication.

FIG. 21 is a generalized flow diagram illustrating another embodiment of a method for utilizing mediums to facilitate replication.

FIG. 22A is a perspective view of a storage cluster, with multiple storage nodes and internal solid-state memory coupled to each storage node to provide network attached storage or storage area network, in accordance with some embodiments.

FIG. 22B is a block diagram showing a communications interconnect and power distribution bus coupling multiple storage nodes.

FIG. 22C is a multiple level block diagram, showing contents of a storage node and contents of one of the non-volatile solid state storage units in accordance with some embodiments.

FIG. 22D shows a storage server environment, which uses embodiments of the storage nodes and storage units of some previous figures in accordance with some embodiments.

FIG. 22E is a blade hardware block diagram, showing a control plane, compute and storage planes, and authorities interacting with underlying physical resources, in accordance with some embodiments.

FIG. 22F depicts elasticity software layers in blades of a storage cluster, in accordance with some embodiments.

FIG. 22G depicts authorities and storage resources in blades of a storage cluster, in accordance with some embodiments.

FIG. 23A sets forth a diagram of a storage system that is coupled for data communications with a cloud services provider in accordance with some embodiments of the present disclosure.

FIG. 23B sets forth a diagram of a storage system in accordance with some embodiments of the present disclosure.

FIG. 23C sets forth an example of a cloud-based storage system in accordance with some embodiments of the present disclosure.

FIG. 23D illustrates an exemplary computing device that may be specifically configured to perform one or more of the processes described herein.

FIG. 23E illustrates an exemplary fleet of storage systems that provide storage services in accordance with some embodiments of the present disclosure.

FIG. 24 sets forth an example of a cloud-based storage system in accordance with some embodiments of the present disclosure.

FIG. 25 sets forth an example of an additional cloud-based storage system in accordance with some embodiments of the present disclosure.

FIG. 26 sets forth a flowchart illustrating an example method of snapshot-based hydration of a cloud-based storage system in accordance with embodiments of the present disclosure.

FIG. 27 sets forth a flowchart illustrating an additional example method of snapshot-based hydration of a cloud-based storage system in accordance with embodiments of the present disclosure.

FIG. 28 sets forth a flowchart illustrating an additional example method of snapshot-based hydration of a cloud-based storage system in accordance with embodiments of the present disclosure.

While the methods and mechanisms described herein are susceptible to various modifications and alternative forms, specific embodiments are shown by way of example in the drawings and are herein described in detail. It should be understood, however, that drawings and detailed description thereto are not intended to limit the methods and mechanisms to the particular form disclosed, but on the contrary, are intended to cover all modifications, equivalents and alternatives apparent to those skilled in the art once the disclosure is fully appreciated.

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a storage subsystem . . . .” Such a claim does not foreclose the system from including additional components (e.g., a network, a server, a display device).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

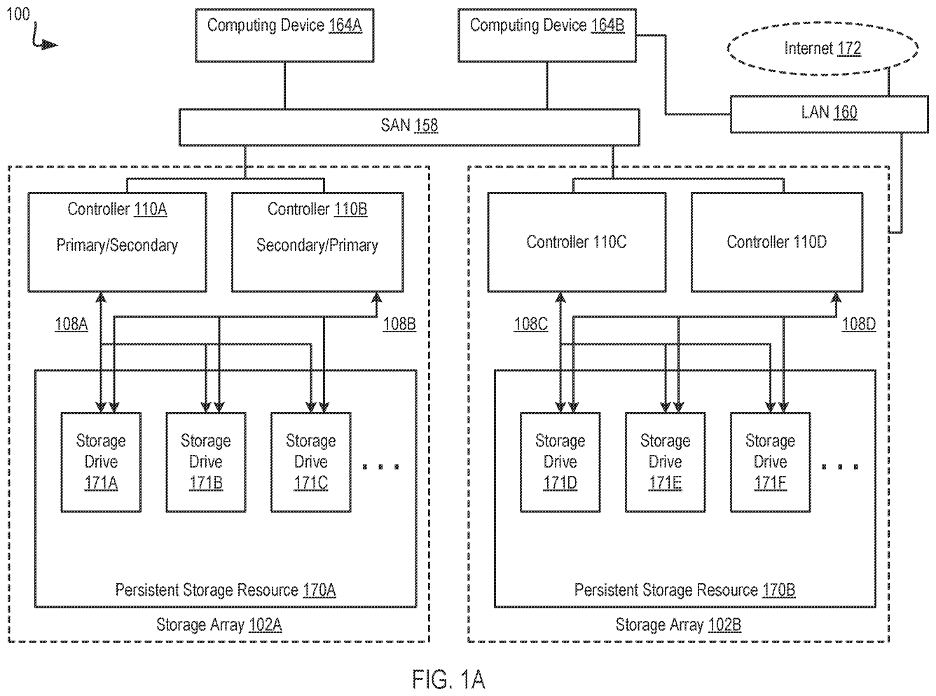

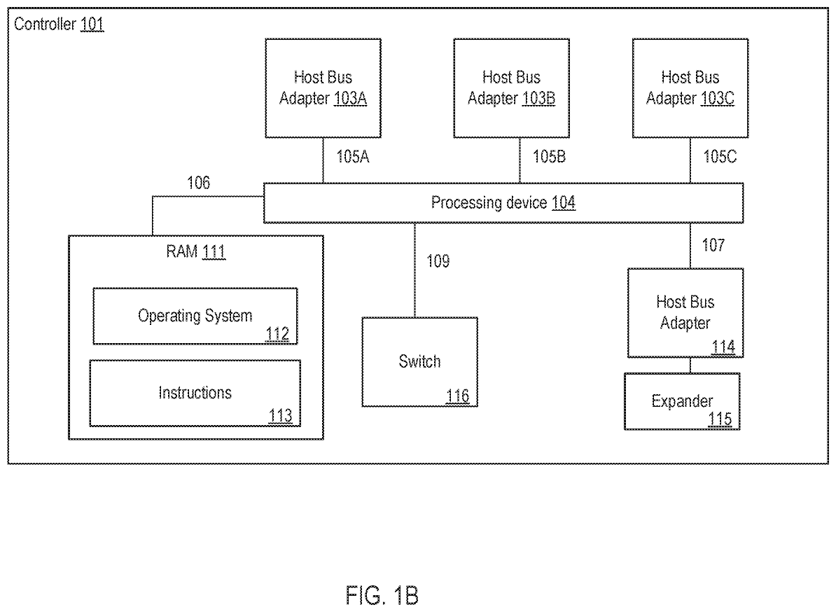

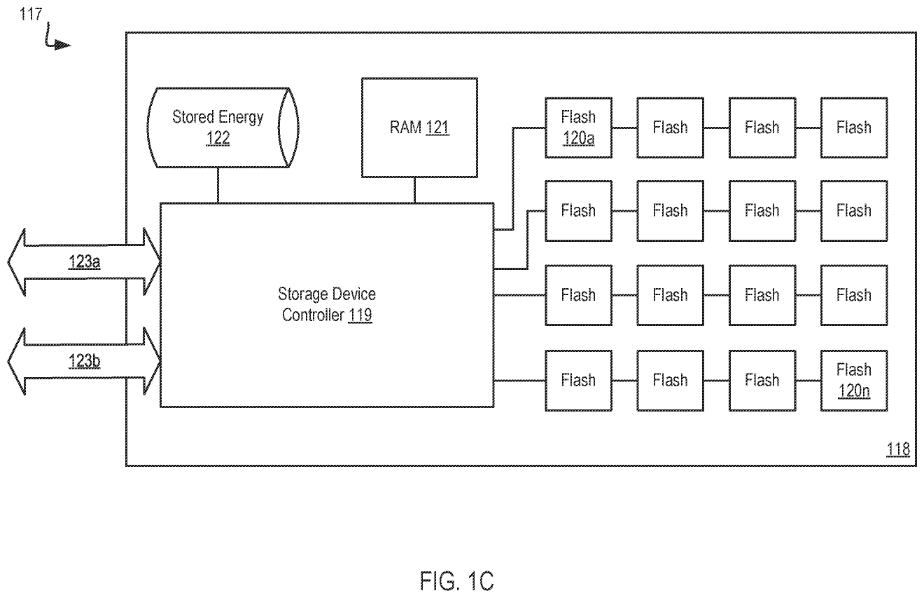

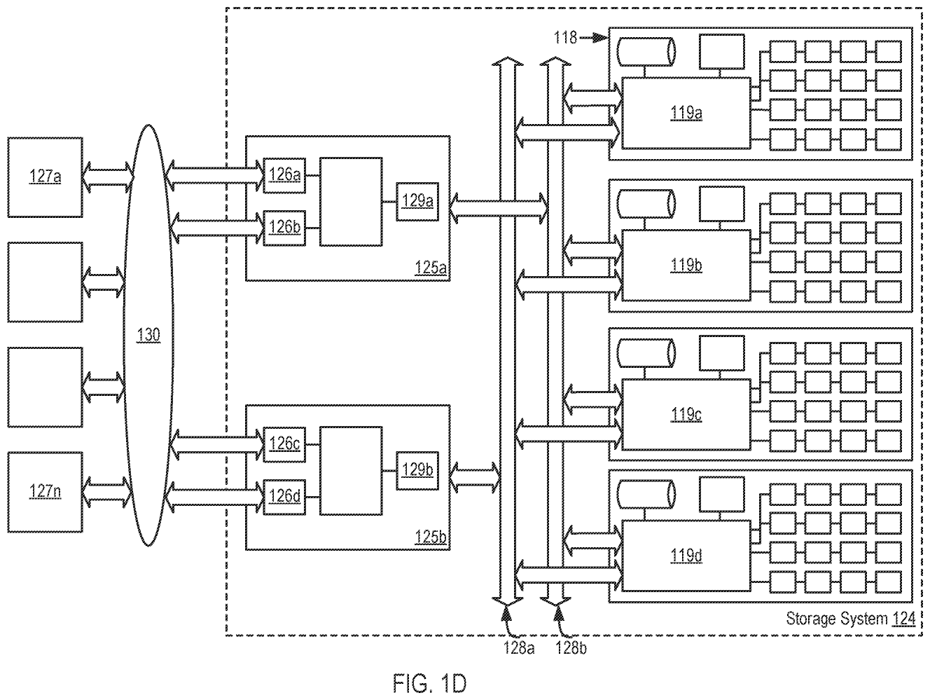

Example methods, apparatus, and products for orchestrating a virtual storage system in accordance with embodiments of the present disclosure are described with reference to the accompanying drawings, beginning with FIG. 1A. FIG. 1A illustrates an example system for data storage, in accordance with some implementations. System 100 (also referred to as “storage system” herein) includes numerous elements for purposes of illustration rather than limitation. It may be noted that system 100 may include the same, more, or fewer elements configured in the same or different manner in other implementations.

System 100 includes a number of computing devices 164A-B. Computing devices (also referred to as “client devices” herein) may be embodied, for example, a server in a data center, a workstation, a personal computer, a notebook, or the like. Computing devices 164A-B may be coupled for data communications to one or more storage arrays 102A-B through a storage area network (‘SAN’) 158 or a local area network (‘LAN’) 160.

The SAN 158 may be implemented with a variety of data communications fabrics, devices, and protocols. For example, the fabrics for SAN 158 may include Fibre Channel, Ethernet, Infiniband, Serial Attached Small Computer System Interface (‘SAS’), or the like. Data communications protocols for use with SAN 158 may include Advanced Technology Attachment (‘ATA’), Fibre Channel Protocol, Small Computer System Interface (‘SCSI’), Internet Small Computer System Interface (‘iSCSI’), HyperSCSI, Non-Volatile Memory Express (‘NVMe’) over Fabrics, or the like. It may be noted that SAN 158 is provided for illustration, rather than limitation. Other data communication couplings may be implemented between computing devices 164A-B and storage arrays 102A-B.

The LAN 160 may also be implemented with a variety of fabrics, devices, and protocols. For example, the fabrics for LAN 160 may include Ethernet (802.3), wireless (802.11), or the like. Data communication protocols for use in LAN 160 may include Transmission Control Protocol (‘TCP’), User Datagram Protocol (‘UDP’), Internet Protocol (‘IP’), HyperText Transfer Protocol (‘HTTP’), Wireless Access Protocol (‘WAP’), Handheld Device Transport Protocol (‘HDTP’), Session Initiation Protocol (‘SIP’), Real Time Protocol (‘RTP’), or the like.

Storage arrays 102A-B may provide persistent data storage for the computing devices 164A-B. Storage array 102A may be contained in a chassis (not shown), and storage array 102B may be contained in another chassis (not shown), in implementations. Storage array 102A and 102B may include one or more storage array controllers 110A-D (also referred to as “controller” herein). A storage array controller 110A-D may be embodied as a module of automated computing machinery comprising computer hardware, computer software, or a combination of computer hardware and software. In some implementations, the storage array controllers 110A-D may be configured to carry out various storage tasks. Storage tasks may include writing data received from the computing devices 164A-B to storage array 102A-B, erasing data from storage array 102A-B, retrieving data from storage array 102A-B and providing data to computing devices 164A-B, monitoring and reporting of disk utilization and performance, performing redundancy operations, such as Redundant Array of Independent Drives (‘RAID’) or RAID-like data redundancy operations, compressing data, encrypting data, and so forth.

Storage array controller 110A-D may be implemented in a variety of ways, including as a Field Programmable Gate Array (‘FPGA’), a Programmable Logic Chip (‘PLC’), an Application Specific Integrated Circuit (‘ASIC’), System-on-Chip (‘SOC’), or any computing device that includes discrete components such as a processing device, central processing unit, computer memory, or various adapters. Storage array controller 110A-D may include, for example, a data communications adapter configured to support communications via the SAN 158 or LAN 160. In some implementations, storage array controller 110A-D may be independently coupled to the LAN 160. In implementations, storage array controller 110A-D may include an I/O controller or the like that couples the storage array controller 110A-D for data communications, through a midplane (not shown), to a persistent storage resource 170A-B (also referred to as a “storage resource” herein). The persistent storage resource 170A-B main include any number of storage drives 171A-F (also referred to as “storage devices” herein) and any number of non-volatile Random Access Memory (‘NVRAM’) devices (not shown).

In some implementations, the NVRAM devices of a persistent storage resource 170A-B may be configured to receive, from the storage array controller 110A-D, data to be stored in the storage drives 171A-F. In some examples, the data may originate from computing devices 164A-B. In some examples, writing data to the NVRAM device may be carried out more quickly than directly writing data to the storage drive 171A-F. In implementations, the storage array controller 110A-D may be configured to utilize the NVRAM devices as a quickly accessible buffer for data destined to be written to the storage drives 171A-F. Latency for write requests using NVRAM devices as a buffer may be improved relative to a system in which a storage array controller 110A-D writes data directly to the storage drives 171A-F. In some implementations, the NVRAM devices may be implemented with computer memory in the form of high bandwidth, low latency RAM. The NVRAM device is referred to as “non-volatile” because the NVRAM device may receive or include a unique power source that maintains the state of the RAM after main power loss to the NVRAM device. Such a power source may be a battery, one or more capacitors, or the like. In response to a power loss, the NVRAM device may be configured to write the contents of the RAM to a persistent storage, such as the storage drives 171A-F.

In implementations, storage drive 171A-F may refer to any device configured to record data persistently, where “persistently” or “persistent” refers as to a device's ability to maintain recorded data after loss of power. In some implementations, storage drive 171A-F may correspond to non-disk storage media. For example, the storage drive 171A-F may be one or more solid-state drives (‘SSDs’), flash memory based storage, any type of solid-state non-volatile memory, or any other type of non-mechanical storage device. In other implementations, storage drive 171A-F may include mechanical or spinning hard disk, such as hard-disk drives (‘HDD’).

In some implementations, the storage array controllers 110A-D may be configured for offloading device management responsibilities from storage drive 171A-F in storage array 102A-B. For example, storage array controllers 110A-D may manage control information that may describe the state of one or more memory blocks in the storage drives 171A-F. The control information may indicate, for example, that a particular memory block has failed and should no longer be written to, that a particular memory block contains boot code for a storage array controller 110A-D, the number of program-erase (‘P/E’) cycles that have been performed on a particular memory block, the age of data stored in a particular memory block, the type of data that is stored in a particular memory block, and so forth. In some implementations, the control information may be stored with an associated memory block as metadata. In other implementations, the control information for the storage drives 171A-F may be stored in one or more particular memory blocks of the storage drives 171A-F that are selected by the storage array controller 110A-D. The selected memory blocks may be tagged with an identifier indicating that the selected memory block contains control information. The identifier may be utilized by the storage array controllers 110A-D in conjunction with storage drives 171A-F to quickly identify the memory blocks that contain control information. For example, the storage controllers 110A-D may issue a command to locate memory blocks that contain control information. It may be noted that control information may be so large that parts of the control information may be stored in multiple locations, that the control information may be stored in multiple locations for purposes of redundancy, for example, or that the control information may otherwise be distributed across multiple memory blocks in the storage drive 171A-F.

In implementations, storage array controllers 110A-D may offload device management responsibilities from storage drives 171A-F of storage array 102A-B by retrieving, from the storage drives 171A-F, control information describing the state of one or more memory blocks in the storage drives 171A-F. Retrieving the control information from the storage drives 171A-F may be carried out, for example, by the storage array controller 110A-D querying the storage drives 171A-F for the location of control information for a particular storage drive 171A-F. The storage drives 171A-F may be configured to execute instructions that enable the storage drive 171A-F to identify the location of the control information. The instructions may be executed by a controller (not shown) associated with or otherwise located on the storage drive 171A-F and may cause the storage drive 171A-F to scan a portion of each memory block to identify the memory blocks that store control information for the storage drives 171A-F. The storage drives 171A-F may respond by sending a response message to the storage array controller 110A-D that includes the location of control information for the storage drive 171A-F. Responsive to receiving the response message, storage array controllers 110A-D may issue a request to read data stored at the address associated with the location of control information for the storage drives 171A-F.

In other implementations, the storage array controllers 110A-D may further offload device management responsibilities from storage drives 171A-F by performing, in response to receiving the control information, a storage drive management operation. A storage drive management operation may include, for example, an operation that is typically performed by the storage drive 171A-F (e.g., the controller (not shown) associated with a particular storage drive 171A-F). A storage drive management operation may include, for example, ensuring that data is not written to failed memory blocks within the storage drive 171A-F, ensuring that data is written to memory blocks within the storage drive 171A-F in such a way that adequate wear leveling is achieved, and so forth.

In implementations, storage array 102A-B may implement two or more storage array controllers 110A-D. For example, storage array 102A may include storage array controllers 110A and storage array controllers 110B. At a given instance, a single storage array controller 110A-D (e.g., storage array controller 110A) of a storage system 100 may be designated with primary status (also referred to as “primary controller” herein), and other storage array controllers 110A-D (e.g., storage array controller 110A) may be designated with secondary status (also referred to as “secondary controller” herein). The primary controller may have particular rights, such as permission to alter data in persistent storage resource 170A-B (e.g., writing data to persistent storage resource 170A-B). At least some of the rights of the primary controller may supersede the rights of the secondary controller. For instance, the secondary controller may not have permission to alter data in persistent storage resource 170A-B when the primary controller has the right. The status of storage array controllers 110A-D may change. For example, storage array controller 110A may be designated with secondary status, and storage array controller 110B may be designated with primary status.

In some implementations, a primary controller, such as storage array controller 110A, may serve as the primary controller for one or more storage arrays 102A-B, and a second controller, such as storage array controller 110B, may serve as the secondary controller for the one or more storage arrays 102A-B. For example, storage array controller 110A may be the primary controller for storage array 102A and storage array 102B, and storage array controller 110B may be the secondary controller for storage array 102A and 102B. In some implementations, storage array controllers 110C and 110D (also referred to as “storage processing modules”) may neither have primary or secondary status. Storage array controllers 110C and 110D, implemented as storage processing modules, may act as a communication interface between the primary and secondary controllers (e.g., storage array controllers 110A and 110B, respectively) and storage array 102B. For example, storage array controller 110A of storage array 102A may send a write request, via SAN 158, to storage array 102B. The write request may be received by both storage array controllers 110C and 110D of storage array 102B. Storage array controllers 110C and 110D facilitate the communication, e.g., send the write request to the appropriate storage drive 171A-F. It may be noted that in some implementations storage processing modules may be used to increase the number of storage drives controlled by the primary and secondary controllers.

In implementations, storage array controllers 110A-D are communicatively coupled, via a midplane (not shown), to one or more storage drives 171A-F and to one or more NVRAM devices (not shown) that are included as part of a storage array 102A-B. The storage array controllers 110A-D may be coupled to the midplane via one or more data communication links and the midplane may be coupled to the storage drives 171A-F and the NVRAM devices via one or more data communications links. The data communications links described herein are collectively illustrated by data communications links 108A-D and may include a Peripheral Component Interconnect Express (‘PCIe’) bus, for example.

FIG. 1B illustrates an example system for data storage, in accordance with some implementations. Storage array controller 101 illustrated in FIG. 1B may be similar to the storage array controllers 110A-D described with respect to FIG. 1A. In one example, storage array controller 101 may be similar to storage array controller 110A or storage array controller 110B. Storage array controller 101 includes numerous elements for purposes of illustration rather than limitation. It may be noted that storage array controller 101 may include the same, more, or fewer elements configured in the same or different manner in other implementations. It may be noted that elements of FIG. 1A may be included below to help illustrate features of storage array controller 101.

Storage array controller 101 may include one or more processing devices 104 and random access memory (‘RAM’) 111. Processing device 104 (or controller 101) represents one or more general-purpose processing devices such as a microprocessor, central processing unit, or the like. More particularly, the processing device 104 (or controller 101) may be a complex instruction set computing (‘CISC’) microprocessor, reduced instruction set computing (‘RISC’) microprocessor, very long instruction word (‘VLIW’) microprocessor, or a processor implementing other instruction sets or processors implementing a combination of instruction sets. The processing device 104 (or controller 101) may also be one or more special-purpose processing devices such as an ASIC, an FPGA, a digital signal processor (‘DSP’), network processor, or the like.

The processing device 104 may be connected to the RAMI 111 via a data communications link 106, which may be embodied as a high speed memory bus such as a Double-Data Rate 4 (‘DDR4’) bus. Stored in RAMI 111 is an operating system 112. In some implementations, instructions 113 are stored in RAM 111. Instructions 113 may include computer program instructions for performing operations in in a direct-mapped flash storage system. In one embodiment, a direct-mapped flash storage system is one that that addresses data blocks within flash drives directly and without an address translation performed by the storage controllers of the flash drives.

In implementations, storage array controller 101 includes one or more host bus adapters 103A-C that are coupled to the processing device 104 via a data communications link 105A-C. In implementations, host bus adapters 103A-C may be computer hardware that connects a host system (e.g., the storage array controller) to other network and storage arrays. In some examples, host bus adapters 103A-C may be a Fibre Channel adapter that enables the storage array controller 101 to connect to a SAN, an Ethernet adapter that enables the storage array controller 101 to connect to a LAN, or the like. Host bus adapters 103A-C may be coupled to the processing device 104 via a data communications link 105A-C such as, for example, a PCIe bus.

In implementations, storage array controller 101 may include a host bus adapter 114 that is coupled to an expander 115. The expander 115 may be used to attach a host system to a larger number of storage drives. The expander 115 may, for example, be a SAS expander utilized to enable the host bus adapter 114 to attach to storage drives in an implementation where the host bus adapter 114 is embodied as a SAS controller.

In implementations, storage array controller 101 may include a switch 116 coupled to the processing device 104 via a data communications link 109. The switch 116 may be a computer hardware device that can create multiple endpoints out of a single endpoint, thereby enabling multiple devices to share a single endpoint. The switch 116 may, for example, be a PCIe switch that is coupled to a PCIe bus (e.g., data communications link 109) and presents multiple PCIe connection points to the midplane.

In implementations, storage array controller 101 includes a data communications link 107 for coupling the storage array controller 101 to other storage array controllers. In some examples, data communications link 107 may be a QuickPath Interconnect (QPI) interconnect.

A traditional storage system that uses traditional flash drives may implement a process across the flash drives that are part of the traditional storage system. For example, a higher level process of the storage system may initiate and control a process across the flash drives. However, a flash drive of the traditional storage system may include its own storage controller that also performs the process. Thus, for the traditional storage system, a higher level process (e.g., initiated by the storage system) and a lower level process (e.g., initiated by a storage controller of the storage system) may both be performed.

To resolve various deficiencies of a traditional storage system, operations may be performed by higher level processes and not by the lower level processes. For example, the flash storage system may include flash drives that do not include storage controllers that provide the process. Thus, the operating system of the flash storage system itself may initiate and control the process. This may be accomplished by a direct-mapped flash storage system that addresses data blocks within the flash drives directly and without an address translation performed by the storage controllers of the flash drives.

In implementations, storage drive 171A-F may be one or more zoned storage devices. In some implementations, the one or more zoned storage devices may be a shingled HDD. In implementations, the one or more storage devices may be a flash-based SSD. In a zoned storage device, a zoned namespace on the zoned storage device can be addressed by groups of blocks that are grouped and aligned by a natural size, forming a number of addressable zones. In implementations utilizing an SSD, the natural size may be based on the erase block size of the SSD. In some implementations, the zones of the zoned storage device may be defined during initialization of the zoned storage device. In implementations, the zones may be defined dynamically as data is written to the zoned storage device.

In some implementations, zones may be heterogeneous, with some zones each being a page group and other zones being multiple page groups. In implementations, some zones may correspond to an erase block and other zones may correspond to multiple erase blocks. In an implementation, zones may be any combination of differing numbers of pages in page groups and/or erase blocks, for heterogeneous mixes of programming modes, manufacturers, product types and/or product generations of storage devices, as applied to heterogeneous assemblies, upgrades, distributed storages, etc. In some implementations, zones may be defined as having usage characteristics, such as a property of supporting data with particular kinds of longevity (very short lived or very long lived, for example). These properties could be used by a zoned storage device to determine how the zone will be managed over the zone's expected lifetime.

It should be appreciated that a zone is a virtual construct. Any particular zone may not have a fixed location at a storage device. Until allocated, a zone may not have any location at a storage device. A zone may correspond to a number representing a chunk of virtually allocatable space that is the size of an erase block or other block size in various implementations. When the system allocates or opens a zone, zones get allocated to flash or other solid-state storage memory and, as the system writes to the zone, pages are written to that mapped flash or other solid-state storage memory of the zoned storage device. When the system closes the zone, the associated erase block(s) or other sized block(s) are completed. At some point in the future, the system may delete a zone which will free up the zone's allocated space. During its lifetime, a zone may be moved around to different locations of the zoned storage device, e.g., as the zoned storage device does internal maintenance.

In implementations, the zones of the zoned storage device may be in different states. A zone may be in an empty state in which data has not been stored at the zone. An empty zone may be opened explicitly, or implicitly by writing data to the zone. This is the initial state for zones on a fresh zoned storage device, but may also be the result of a zone reset. In some implementations, an empty zone may have a designated location within the flash memory of the zoned storage device. In an implementation, the location of the empty zone may be chosen when the zone is first opened or first written to (or later if writes are buffered into memory). A zone may be in an open state either implicitly or explicitly, where a zone that is in an open state may be written to store data with write or append commands. In an implementation, a zone that is in an open state may also be written to using a copy command that copies data from a different zone. In some implementations, a zoned storage device may have a limit on the number of open zones at a particular time.

A zone in a closed state is a zone that has been partially written to, but has entered a closed state after issuing an explicit close operation. A zone in a closed state may be left available for future writes, but may reduce some of the run-time overhead consumed by keeping the zone in an open state. In implementations, a zoned storage device may have a limit on the number of closed zones at a particular time. A zone in a full state is a zone that is storing data and can no longer be written to. A zone may be in a full state either after writes have written data to the entirety of the zone or as a result of a zone finish operation. Prior to a finish operation, a zone may or may not have been completely written. After a finish operation, however, the zone may not be opened a written to further without first performing a zone reset operation.

The mapping from a zone to an erase block (or to a shingled track in an HDD) may be arbitrary, dynamic, and hidden from view. The process of opening a zone may be an operation that allows a new zone to be dynamically mapped to underlying storage of the zoned storage device, and then allows data to be written through appending writes into the zone until the zone reaches capacity. The zone can be finished at any point, after which further data may not be written into the zone. When the data stored at the zone is no longer needed, the zone can be reset which effectively deletes the zone's content from the zoned storage device, making the physical storage held by that zone available for the subsequent storage of data. Once a zone has been written and finished, the zoned storage device ensures that the data stored at the zone is not lost until the zone is reset. In the time between writing the data to the zone and the resetting of the zone, the zone may be moved around between shingle tracks or erase blocks as part of maintenance operations within the zoned storage device, such as by copying data to keep the data refreshed or to handle memory cell aging in an SSD.

In implementations utilizing an HDD, the resetting of the zone may allow the shingle tracks to be allocated to a new, opened zone that may be opened at some point in the future. In implementations utilizing an SSD, the resetting of the zone may cause the associated physical erase block(s) of the zone to be erased and subsequently reused for the storage of data. In some implementations, the zoned storage device may have a limit on the number of open zones at a point in time to reduce the amount of overhead dedicated to keeping zones open.

The operating system of the flash storage system may identify and maintain a list of allocation units across multiple flash drives of the flash storage system. The allocation units may be entire erase blocks or multiple erase blocks. The operating system may maintain a map or address range that directly maps addresses to erase blocks of the flash drives of the flash storage system.

Direct mapping to the erase blocks of the flash drives may be used to rewrite data and erase data. For example, the operations may be performed on one or more allocation units that include a first data and a second data where the first data is to be retained and the second data is no longer being used by the flash storage system. The operating system may initiate the process to write the first data to new locations within other allocation units and erasing the second data and marking the allocation units as being available for use for subsequent data. Thus, the process may only be performed by the higher level operating system of the flash storage system without an additional lower level process being performed by controllers of the flash drives.

Advantages of the process being performed only by the operating system of the flash storage system include increased reliability of the flash drives of the flash storage system as unnecessary or redundant write operations are not being performed during the process. One possible point of novelty here is the concept of initiating and controlling the process at the operating system of the flash storage system. In addition, the process can be controlled by the operating system across multiple flash drives. This is contrast to the process being performed by a storage controller of a flash drive.

A storage system can consist of two storage array controllers that share a set of drives for failover purposes, or it could consist of a single storage array controller that provides a storage service that utilizes multiple drives, or it could consist of a distributed network of storage array controllers each with some number of drives or some amount of Flash storage where the storage array controllers in the network collaborate to provide a complete storage service and collaborate on various aspects of a storage service including storage allocation and garbage collection.

FIG. 1C illustrates a third example system 117 for data storage in accordance with some implementations. System 117 (also referred to as “storage system” herein) includes numerous elements for purposes of illustration rather than limitation. It may be noted that system 117 may include the same, more, or fewer elements configured in the same or different manner in other implementations.

In one embodiment, system 117 includes a dual Peripheral Component Interconnect (‘PCI’) flash storage device 118 with separately addressable fast write storage. System 117 may include a storage device controller 119. In one embodiment, storage device controller 119A-D may be a CPU, ASIC, FPGA, or any other circuitry that may implement control structures necessary according to the present disclosure. In one embodiment, system 117 includes flash memory devices (e.g., including flash memory devices 120a-n), operatively coupled to various channels of the storage device controller 119. Flash memory devices 120a-n, may be presented to the controller 119A-D as an addressable collection of Flash pages, erase blocks, and/or control elements sufficient to allow the storage device controller 119A-D to program and retrieve various aspects of the Flash. In one embodiment, storage device controller 119A-D may perform operations on flash memory devices 120a-n including storing and retrieving data content of pages, arranging and erasing any blocks, tracking statistics related to the use and reuse of Flash memory pages, erase blocks, and cells, tracking and predicting error codes and faults within the Flash memory, controlling voltage levels associated with programming and retrieving contents of Flash cells, etc.

In one embodiment, system 117 may include RAM 121 to store separately addressable fast-write data. In one embodiment, RAM 121 may be one or more separate discrete devices. In another embodiment, RAM 121 may be integrated into storage device controller 119A-D or multiple storage device controllers. The RAM 121 may be utilized for other purposes as well, such as temporary program memory for a processing device (e.g., a CPU) in the storage device controller 119.

In one embodiment, system 117 may include a stored energy device 122, such as a rechargeable battery or a capacitor. Stored energy device 122 may store energy sufficient to power the storage device controller 119, some amount of the RAM (e.g., RAM 121), and some amount of Flash memory (e.g., Flash memory 120a-120n) for sufficient time to write the contents of RAM to Flash memory. In one embodiment, storage device controller 119A-D may write the contents of RAM to Flash Memory if the storage device controller detects loss of external power.

In one embodiment, system 117 includes two data communications links 123a, 123b. In one embodiment, data communications links 123a, 123b may be PCI interfaces. In another embodiment, data communications links 123a, 123b may be based on other communications standards (e.g., HyperTransport, InfiniBand, etc.). Data communications links 123a, 123b may be based on non-volatile memory express (‘NVMe’) or NVMe over fabrics (‘NVMf’) specifications that allow external connection to the storage device controller 119A-D from other components in the storage system 117. It should be noted that data communications links may be interchangeably referred to herein as PCI buses for convenience.

System 117 may also include an external power source (not shown), which may be provided over one or both data communications links 123a, 123b, or which may be provided separately. An alternative embodiment includes a separate Flash memory (not shown) dedicated for use in storing the content of RAM 121. The storage device controller 119A-D may present a logical device over a PCI bus which may include an addressable fast-write logical device, or a distinct part of the logical address space of the storage device 118, which may be presented as PCI memory or as persistent storage. In one embodiment, operations to store into the device are directed into the RAM 121. On power failure, the storage device controller 119A-D may write stored content associated with the addressable fast-write logical storage to Flash memory (e.g., Flash memory 120a-n) for long-term persistent storage.

In one embodiment, the logical device may include some presentation of some or all of the content of the Flash memory devices 120a-n, where that presentation allows a storage system including a storage device 118 (e.g., storage system 117) to directly address Flash memory pages and directly reprogram erase blocks from storage system components that are external to the storage device through the PCI bus. The presentation may also allow one or more of the external components to control and retrieve other aspects of the Flash memory including some or all of: tracking statistics related to use and reuse of Flash memory pages, erase blocks, and cells across all the Flash memory devices; tracking and predicting error codes and faults within and across the Flash memory devices; controlling voltage levels associated with programming and retrieving contents of Flash cells; etc.

In one embodiment, the stored energy device 122 may be sufficient to ensure completion of in-progress operations to the Flash memory devices 120a-120n stored energy device 122 may power storage device controller 119A-D and associated Flash memory devices (e.g., 120a-n) for those operations, as well as for the storing of fast-write RAM to Flash memory. Stored energy device 122 may be used to store accumulated statistics and other parameters kept and tracked by the Flash memory devices 120a-n and/or the storage device controller 119. Separate capacitors or stored energy devices (such as smaller capacitors near or embedded within the Flash memory devices themselves) may be used for some or all of the operations described herein.

Various schemes may be used to track and optimize the life span of the stored energy component, such as adjusting voltage levels over time, partially discharging the stored energy device 122 to measure corresponding discharge characteristics, etc. If the available energy decreases over time, the effective available capacity of the addressable fast-write storage may be decreased to ensure that it can be written safely based on the currently available stored energy.

FIG. 1D illustrates a third example storage system 124 for data storage in accordance with some implementations. In one embodiment, storage system 124 includes storage controllers 125a, 125b. In one embodiment, storage controllers 125a, 125b are operatively coupled to Dual PCI storage devices. Storage controllers 125a, 125b may be operatively coupled (e.g., via a storage network 130) to some number of host computers 127a-n.

In one embodiment, two storage controllers (e.g., 125a and 125b) provide storage services, such as a SCS) block storage array, a file server, an object server, a database or data analytics service, etc. The storage controllers 125a, 125b may provide services through some number of network interfaces (e.g., 126a-d) to host computers 127a-n outside of the storage system 124. Storage controllers 125a, 125b may provide integrated services or an application entirely within the storage system 124, forming a converged storage and compute system. The storage controllers 125a, 125b may utilize the fast write memory within or across storage devices 119a-d to journal in progress operations to ensure the operations are not lost on a power failure, storage controller removal, storage controller or storage system shutdown, or some fault of one or more software or hardware components within the storage system 124.

In one embodiment, storage controllers 125a, 125b operate as PCI masters to one or the other PCI buses 128a, 128b. In another embodiment, 128a and 128b may be based on other communications standards (e.g., HyperTransport, InfiniBand, etc.). Other storage system embodiments may operate storage controllers 125a, 125b as multi-masters for both PCI buses 128a, 128b. Alternately, a PCI/NVMe/NVMf switching infrastructure or fabric may connect multiple storage controllers. Some storage system embodiments may allow storage devices to communicate with each other directly rather than communicating only with storage controllers. In one embodiment, a storage device controller 119a may be operable under direction from a storage controller 125a to synthesize and transfer data to be stored into Flash memory devices from data that has been stored in RAM (e.g., RAM 121 of FIG. 1C). For example, a recalculated version of RAM content may be transferred after a storage controller has determined that an operation has fully committed across the storage system, or when fast-write memory on the device has reached a certain used capacity, or after a certain amount of time, to ensure improve safety of the data or to release addressable fast-write capacity for reuse. This mechanism may be used, for example, to avoid a second transfer over a bus (e.g., 128a, 128b) from the storage controllers 125a, 125b. In one embodiment, a recalculation may include compressing data, attaching indexing or other metadata, combining multiple data segments together, performing erasure code calculations, etc.

In one embodiment, under direction from a storage controller 125a, 125b, a storage device controller 119a, 119b may be operable to calculate and transfer data to other storage devices from data stored in RAM (e.g., RAM 121 of FIG. 1C) without involvement of the storage controllers 125a, 125b. This operation may be used to mirror data stored in one storage controller 125a to another storage controller 125b, or it could be used to offload compression, data aggregation, and/or erasure coding calculations and transfers to storage devices to reduce load on storage controllers or the storage controller interface 129a, 129b to the PCI bus 128a, 128b.

A storage device controller 119A-D may include mechanisms for implementing high availability primitives for use by other parts of a storage system external to the Dual PCI storage device 118. For example, reservation or exclusion primitives may be provided so that, in a storage system with two storage controllers providing a highly available storage service, one storage controller may prevent the other storage controller from accessing or continuing to access the storage device. This could be used, for example, in cases where one controller detects that the other controller is not functioning properly or where the interconnect between the two storage controllers may itself not be functioning properly.

In one embodiment, a storage system for use with Dual PCI direct mapped storage devices with separately addressable fast write storage includes systems that manage erase blocks or groups of erase blocks as allocation units for storing data on behalf of the storage service, or for storing metadata (e.g., indexes, logs, etc.) associated with the storage service, or for proper management of the storage system itself. Flash pages, which may be a few kilobytes in size, may be written as data arrives or as the storage system is to persist data for long intervals of time (e.g., above a defined threshold of time). To commit data more quickly, or to reduce the number of writes to the Flash memory devices, the storage controllers may first write data into the separately addressable fast write storage on one more storage devices.

In one embodiment, the storage controllers 125a, 125b may initiate the use of erase blocks within and across storage devices (e.g., 118) in accordance with an age and expected remaining lifespan of the storage devices, or based on other statistics. The storage controllers 125a, 125b may initiate garbage collection and data migration data between storage devices in accordance with pages that are no longer needed as well as to manage Flash page and erase block lifespans and to manage overall system performance.

In one embodiment, the storage system 124 may utilize mirroring and/or erasure coding schemes as part of storing data into addressable fast write storage and/or as part of writing data into allocation units associated with erase blocks. Erasure codes may be used across storage devices, as well as within erase blocks or allocation units, or within and across Flash memory devices on a single storage device, to provide redundancy against single or multiple storage device failures or to protect against internal corruptions of Flash memory pages resulting from Flash memory operations or from degradation of Flash memory cells. Mirroring and erasure coding at various levels may be used to recover from multiple types of failures that occur separately or in combination.

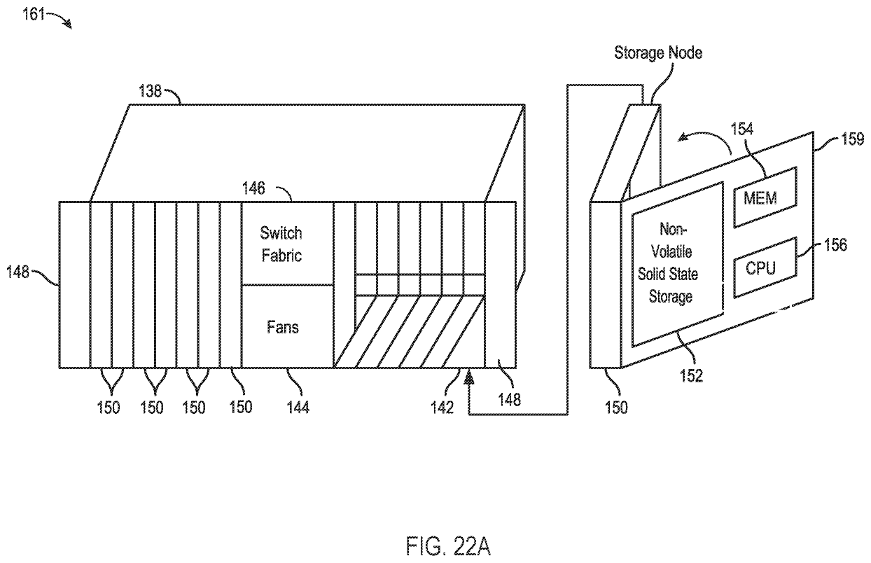

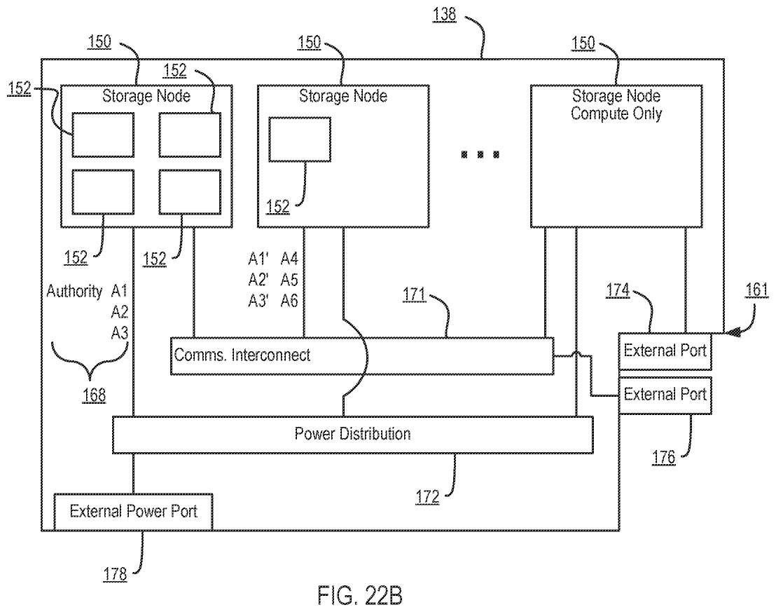

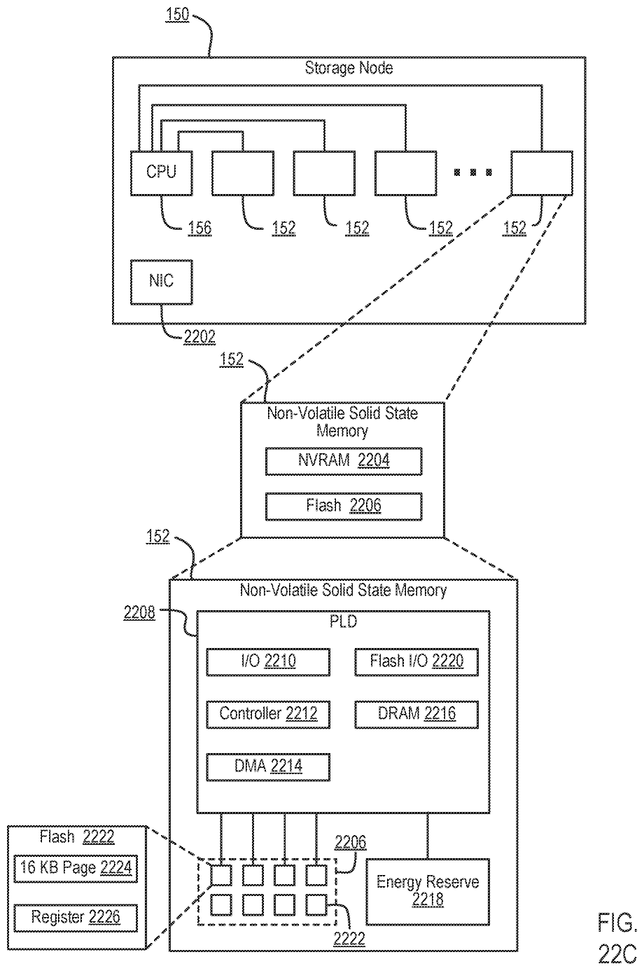

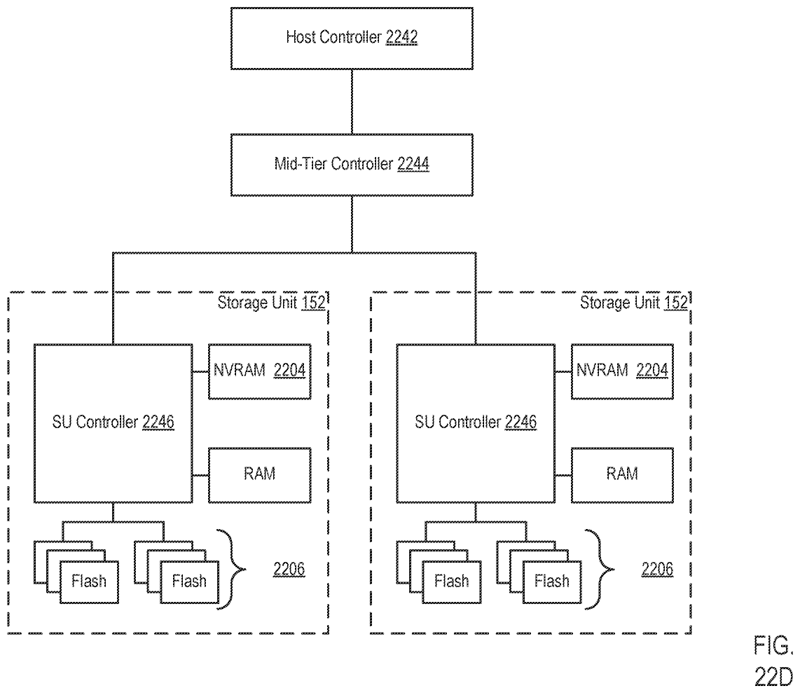

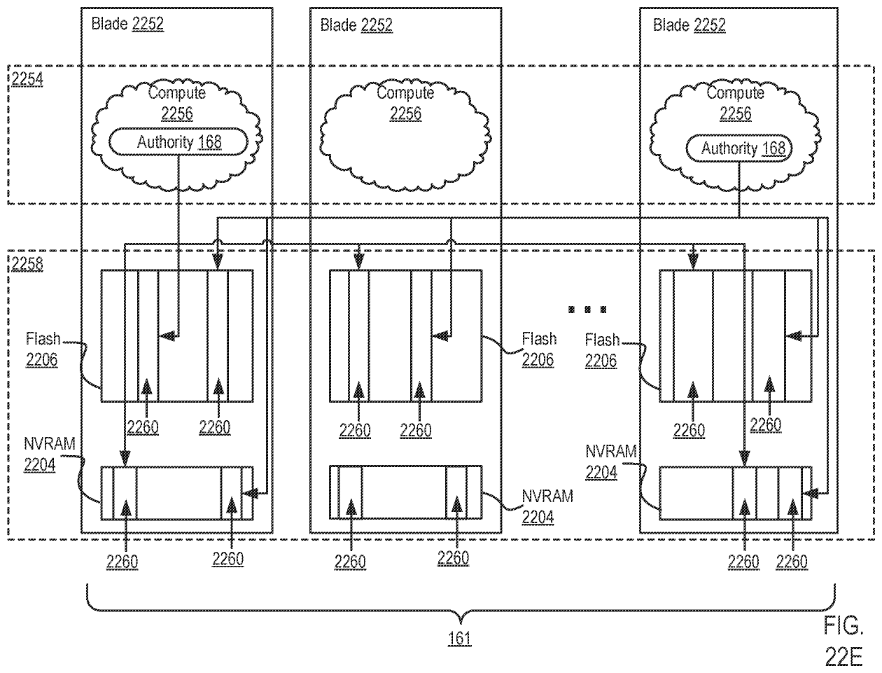

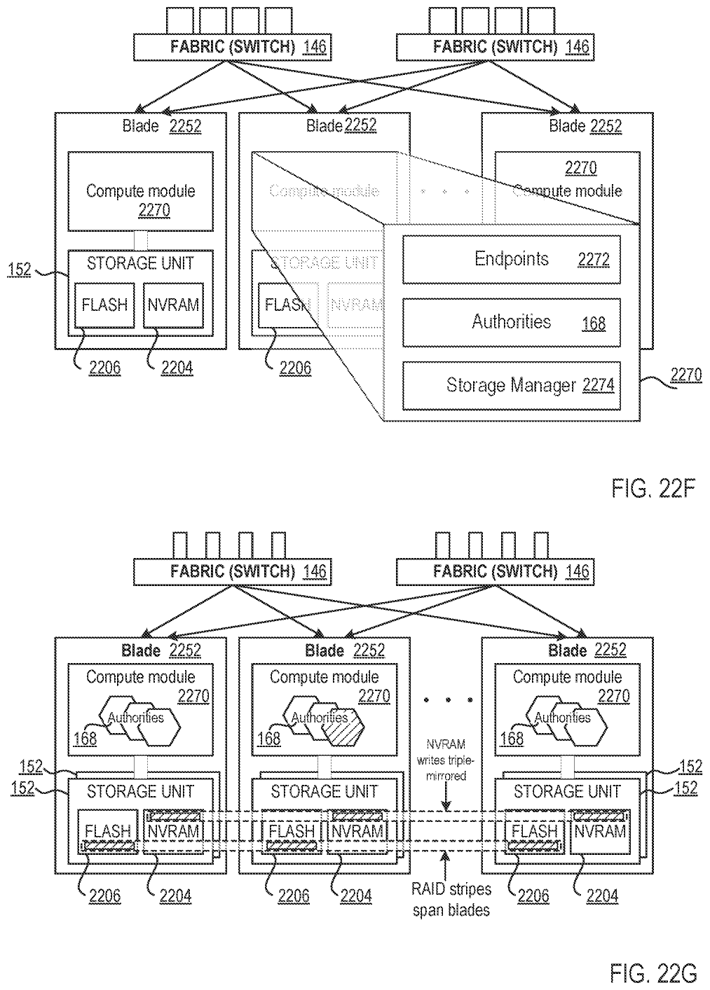

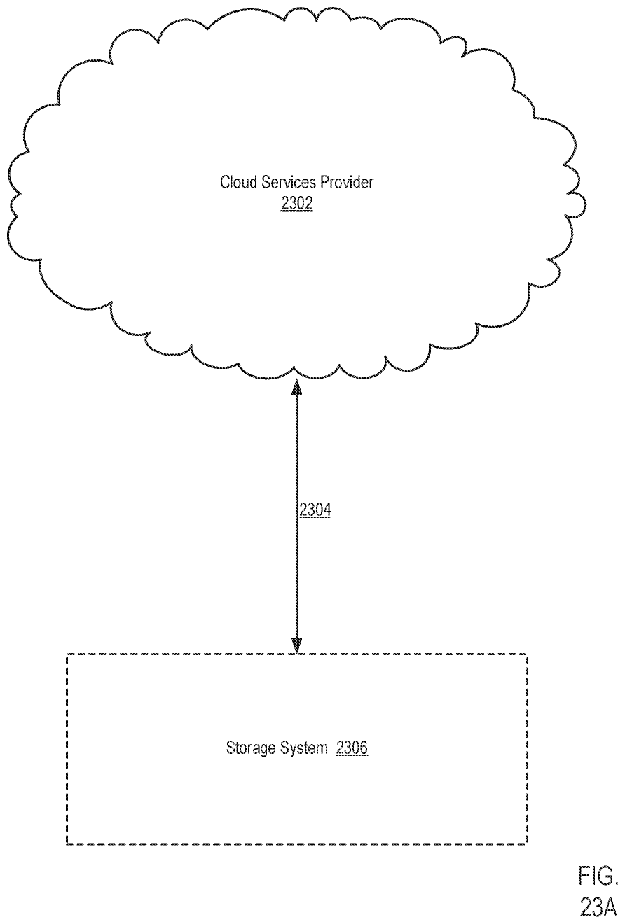

The embodiments depicted with reference to FIGS. 22A-G illustrate a storage cluster that stores user data, such as user data originating from one or more user or client systems or other sources external to the storage cluster. The storage cluster distributes user data across storage nodes housed within a chassis, or across multiple chassis, using erasure coding and redundant copies of metadata. Erasure coding refers to a method of data protection or reconstruction in which data is stored across a set of different locations, such as disks, storage nodes or geographic locations. Flash memory is one type of solid-state memory that may be integrated with the embodiments, although the embodiments may be extended to other types of solid-state memory or other storage medium, including non-solid state memory. Control of storage locations and workloads are distributed across the storage locations in a clustered peer-to-peer system. Tasks such as mediating communications between the various storage nodes, detecting when a storage node has become unavailable, and balancing I/Os (inputs and outputs) across the various storage nodes, are all handled on a distributed basis. Data is laid out or distributed across multiple storage nodes in data fragments or stripes that support data recovery in some embodiments. Ownership of data can be reassigned within a cluster, independent of input and output patterns. This architecture described in more detail below allows a storage node in the cluster to fail, with the system remaining operational, since the data can be reconstructed from other storage nodes and thus remain available for input and output operations. In various embodiments, a storage node may be referred to as a cluster node, a blade, or a server.

The storage cluster may be contained within a chassis, i.e., an enclosure housing one or more storage nodes. A mechanism to provide power to each storage node, such as a power distribution bus, and a communication mechanism, such as a communication bus that enables communication between the storage nodes are included within the chassis. The storage cluster can run as an independent system in one location according to some embodiments. In one embodiment, a chassis contains at least two instances of both the power distribution and the communication bus which may be enabled or disabled independently. The internal communication bus may be an Ethernet bus, however, other technologies such as PCIe, InfiniBand, and others, are equally suitable. The chassis provides a port for an external communication bus for enabling communication between multiple chassis, directly or through a switch, and with client systems. The external communication may use a technology such as Ethernet, InfiniBand, Fibre Channel, etc. In some embodiments, the external communication bus uses different communication bus technologies for inter-chassis and client communication. If a switch is deployed within or between chassis, the switch may act as a translation between multiple protocols or technologies. When multiple chassis are connected to define a storage cluster, the storage cluster may be accessed by a client using either proprietary interfaces or standard interfaces such as network file system (‘NFS’), common internet file system (‘CIFS’), small computer system interface (‘SCSI’) or hypertext transfer protocol (‘HTTP’). Translation from the client protocol may occur at the switch, chassis external communication bus or within each storage node. In some embodiments, multiple chassis may be coupled or connected to each other through an aggregator switch. A portion and/or all of the coupled or connected chassis may be designated as a storage cluster. As discussed above, each chassis can have multiple blades, each blade has a media access control (‘MAC’) address, but the storage cluster is presented to an external network as having a single cluster IP address and a single MAC address in some embodiments.

Each storage node may be one or more storage servers and each storage server is connected to one or more non-volatile solid state memory units, which may be referred to as storage units or storage devices. One embodiment includes a single storage server in each storage node and between one to eight non-volatile solid state memory units, however this one example is not meant to be limiting. The storage server may include a processor, DRAM and interfaces for the internal communication bus and power distribution for each of the power buses. Inside the storage node, the interfaces and storage unit share a communication bus, e.g., PCI Express, in some embodiments. The non-volatile solid state memory units may directly access the internal communication bus interface through a storage node communication bus, or request the storage node to access the bus interface. The non-volatile solid state memory unit contains an embedded CPU, solid state storage controller, and a quantity of solid state mass storage, e.g., between 2-32 terabytes (‘TB’) in some embodiments. An embedded volatile storage medium, such as DRAM, and an energy reserve apparatus are included in the non-volatile solid state memory unit. In some embodiments, the energy reserve apparatus is a capacitor, super-capacitor, or battery that enables transferring a subset of DRAM contents to a stable storage medium in the case of power loss. In some embodiments, the non-volatile solid state memory unit is constructed with a storage class memory, such as phase change or magnetoresistive random access memory (‘MRAM’) that substitutes for DRAM and enables a reduced power hold-up apparatus.

One of many features of the storage nodes and non-volatile solid state storage is the ability to proactively rebuild data in a storage cluster. The storage nodes and non-volatile solid state storage can determine when a storage node or non-volatile solid state storage in the storage cluster is unreachable, independent of whether there is an attempt to read data involving that storage node or non-volatile solid state storage. The storage nodes and non-volatile solid state storage then cooperate to recover and rebuild the data in at least partially new locations. This constitutes a proactive rebuild, in that the system rebuilds data without waiting until the data is needed for a read access initiated from a client system employing the storage cluster. These and further details of the storage memory and operation thereof are discussed below.

In various embodiments, multiple mapping tables may be maintained by a storage controller and/or a cloud service. These mapping tables may include an address translation table, a deduplication table, an overlay table, and/or other tables. The address translation table may include a plurality of entries, with each entry holding a virtual-to-physical mapping for a corresponding data component. This mapping table may be used to map logical read/write requests from each of the client computer systems and to physical locations in storage devices. A “physical” pointer value may be read from the mappings associated with a given dataset or snapshot during a lookup operation corresponding to a received read/write request. This physical pointer value may then be used to locate a storage location within the storage devices 135A-N. It is noted that the physical pointer value may not be direct. Rather, the pointer may point to another pointer, which in turn points to another pointer, and so on. For example, a pointer may be used to access another mapping table within a given storage device of the storage devices 135A-N that identifies another pointer. Consequently, one or more levels of indirection may exist between the physical pointer value and a target storage location.

In various embodiments, the address translation table may be accessed using a key comprising a volume, snapshot, or other dataset ID, a logical or virtual address, a sector number, and so forth. A received read/write storage access request may identify a particular volume, sector, and length. A sector may be a logical block of data stored in a volume or snapshot, with a sector being the smallest size of an atomic I/O request to the storage system. In one embodiment, a sector may have a fixed size (e.g., 512 bytes) and the mapping tables may deal with ranges of sectors. For example, the address translation table may map a volume or snapshot in sector-size units. The areas being mapped may be managed as ranges of sectors, with each range consisting of one or more consecutive sectors. In one embodiment, a range may be identified by <snapshot, start sector, length>, and this tuple may be recorded in the address translation table and one or more other tables. In one embodiment, the key value for accessing the address translation table may be the combination of the volume or snapshot ID and the received sector number. A key is an entity in a mapping table that distinguishes one row of data from another row. In other embodiments, other types of address translation tables may be utilized.

In one embodiment, the address translation table may map volumes or snapshots and block offsets to physical pointer values. Depending on the embodiment, a physical pointer value may be a physical address or a logical address which the storage device maps to a physical location within the device. In one embodiment, an index may be utilized to access the address translation table. The index may identify locations of mappings within the address translation table. The index may be queried with a key value generated from a volume ID and sector number, and the index may be searched for one or more entries which match, or otherwise correspond to, the key value. Information from a matching entry may then be used to locate and retrieve a mapping which identifies a storage location which is the target of a received read or write request. In one embodiment, a hit in the index provides a corresponding virtual page ID identifying a page within the storage devices of the storage system, with the page storing both the key value and a corresponding physical pointer value. The page may then be searched with the key value to find the physical pointer value.

The deduplication table may include information used to deduplicate data at a fine-grained level. The information stored in the deduplication table may include mappings between one or more calculated hash values for a given data component and a physical pointer to a physical location in one of the storage devices holding the given data component. In addition, a length of the given data component and status information for a corresponding entry may be stored in the deduplication table. It is noted that in some embodiments, one or more levels of indirection may exist between the physical pointer value and the corresponding physical storage location. Accordingly, in these embodiments, the physical pointer may be used to access another mapping table within a given storage device of the storage devices.

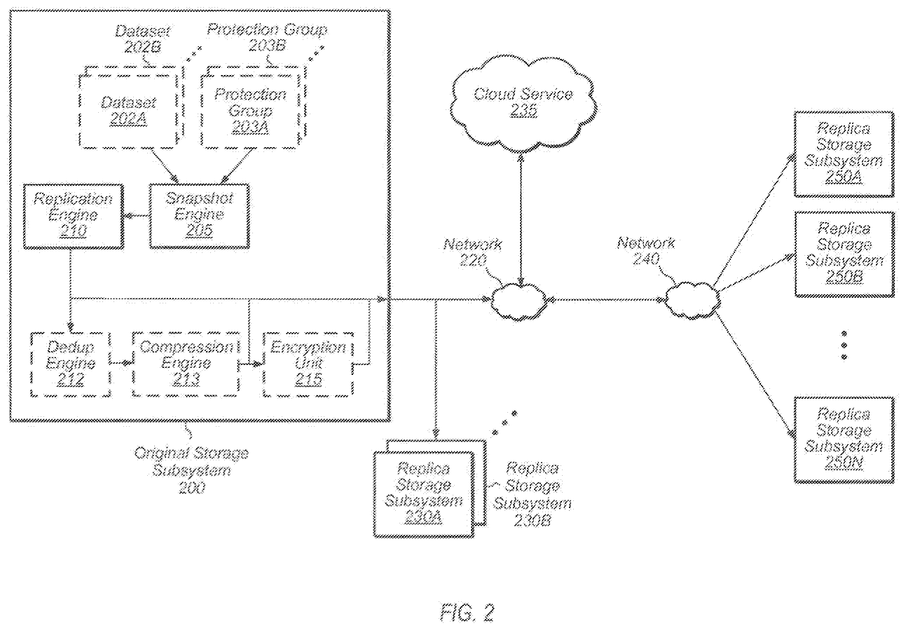

Turning now to FIG. 2, a block diagram illustrating one embodiment of a storage environment is shown. Original storage subsystem 200 includes at least snapshot engine 205, replication engine 210, deduplication (or dedup) engine 212, compression engine 213, and encryption unit 215. Snapshot engine 205, replication engine 210, deduplication engine 212, compression engine 213, and encryption unit 215 may be implemented using any combination of software and/or hardware. Snapshot engine 205 may be configured to take snapshots of dataset 202A-B and protection group 203A-B, which are representative of any number of datasets and protection groups stored on original storage subsystem 200. A snapshot may be defined as the state of a logical collection of data (e.g., volume, database) at a given point in time. In some cases, a snapshot may include only the changes that have been made to the logical collection of data since a previous snapshot was taken.

Replication engine 210 may be configured to choose data for replication from among dataset 202A-B and protection group 203A-B. Original storage subsystem 200 may replicate a dataset or protection group to any of a plurality of storage subsystems and/or cloud service 235. A protection group may be defined as a group of hosts, host groups, and volumes within a storage subsystem or storage system. A single protection group may consist of multiple hosts, host groups and volumes. Generally speaking, a protection group may include logical storage elements that are replicated together consistently in order to correctly describe a dataset.

Replica storage subsystems 230A-B are coupled to original storage subsystem 200 and may be the target of replication operations. In one embodiment, replica storage subsystems 230A-B may be at the same location and on the same network as original storage subsystem 200. Original storage subsystem 200 may also be coupled to cloud service 235 via network 220, and original storage subsystem 200 may utilize cloud service 235 as a target for replicating data. Original storage subsystem 200 may also be coupled to replica storage subsystems 250A-N via network 240, and replica storage subsystems 250A-N may be the target of replication operations.

Replication engine 210 may be configured to selectively utilize deduplication (or dedup) unit 212 and/or compression unit 213 to deduplicate and compress the data being replicated. In one embodiment, replication engine 210 may utilize deduplication unit 212 and compression unit 213 to deduplicate and compress a dataset or protection group selected for replication. Any suitable types of deduplication and compression may be utilized, depending on the embodiment.

In other embodiments, replication engine 210 may bypass deduplication unit 212 and compression unit 213 when performing replication. Replication engine 210 may also be configured to selectively utilize encryption unit 215 for encrypting data being replicated to other subsystems and/or to cloud service 235. Any suitable type of encryption may be utilized, depending on the embodiment.

In one embodiment, replication engine 210 may be configured to replicate data to replica storage subsystems 230A-B without encrypting the data being replicated. Additionally, in various embodiments, data replicated to the cloud may or may not be encrypted. In this embodiment, replication engine 210 may be configured to encrypt data being replicating using encryption unit 215 for replication events which target cloud service 235. Replication engine 210 may encrypt or not encrypt data being replicated to replica storage subsystems 250A-N, depending on the embodiment. In one embodiment, an administrator or other authorized user may be able to select when encryption is enabled depending on the type of data being replicated and/or the replication target. A user may specify that encryption should be enabled for certain replication targets regardless of the type of data being replicated.

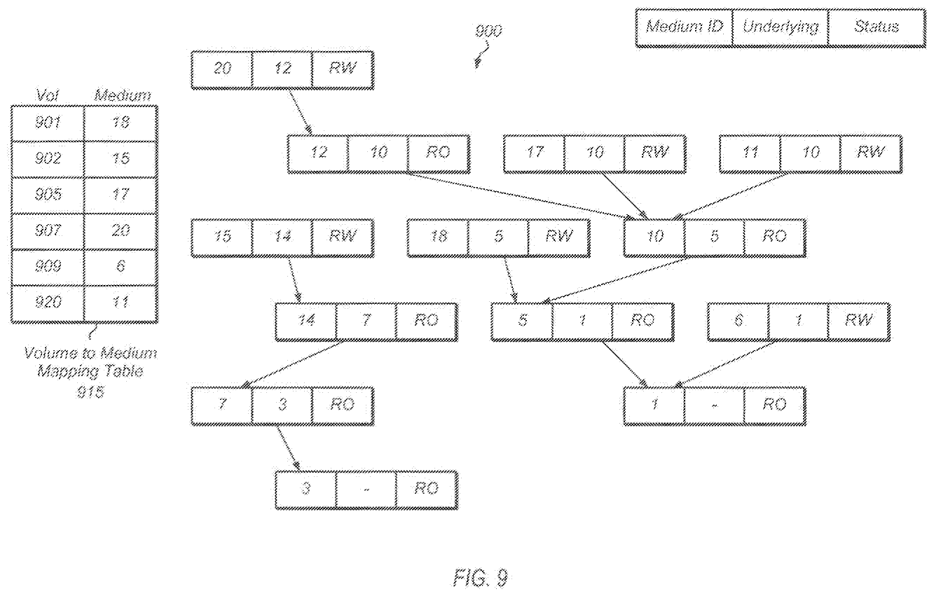

In one embodiment, original storage subsystem 200 may be configured to encrypt user data while storing one or more of the medium graph (e.g., graph 900 of FIG. 9), medium mapping table 1000, table 1300, other mapping tables, and/or other metadata in an unencrypted form. Original storage subsystem 200 may share and/or send one or more of these unencrypted graphs, tables, and/or other metadata to cloud service 235. This would enable cloud service 235 to perform medium garbage collection. This would also enable cloud service 235 to utilize the medium graph, tables, and other metadata for performing dynamic replication target selection. In some embodiments, original storage subsystem 200 may be configured to keep the secret for encrypting and decrypting data stored locally on original storage subsystem 200. If the storage device storing the secret on original storage subsystem 200 is reset to an erased state with empty blocks (even if original storage subsystem 200 is offline), then the secret for decrypting data in the cloud would be lost. This would allow for instant remote data wiping.

In another embodiment, original storage subsystem 200 may be configured to store unencrypted user data. In this embodiment, original storage subsystem 200 may offload deduplication to cloud service 235. Cloud service 235 may be configured to perform computationally expensive deduplication and then send the deduplicated data back to original storage subsystem 200. In some embodiments, cloud service 235 may be configured to deduplicate data across multiple different storage subsystems which would allow for higher levels of data reduction to be obtained.

Original storage subsystem 200 may be configured to generate and display a graphical user interface (GUI) to allow users to manage the replication environment. When a user logs into the GUI, the GUI may show which subsystems can be used as targets for replication. In one embodiment, the GUI may be populated with data stored locally on subsystem 200. In another embodiment, the GUI may be populated with data received from cloud service 235. For example, original storage subsystem 200 may be part of a first organization, and when subsystem 200 is new and first becomes operational, subsystem 200 may not include data regarding the other subsystems that exist within the first organization. Subsystem 200 may query cloud service 235 and cloud service 235 may provide data on all of the subsystems of the first organization which are available for serving as replication targets. These subsystems may then appear in the GUI used for managing the replication environment.

In one embodiment, snapshots that are replicated from original storage subsystem 200 to a target subsystem may have the same global content ID but may have separate local IDs on original storage subsystem 200 and the target subsystem. In other embodiments, global IDs may be used across multiple storage subsystems. These global IDs may be generated such that no duplicate IDs are generated. For example, in one embodiment, an ID of the device on which it (e.g., the snapshot, medium, or corresponding data) was first written may be prepended. In other embodiments, ranges of IDs may be allocated/assigned for use by different devices. These and other embodiments are possible and are contemplated. For example, the local ID of a first snapshot on original storage subsystem 200 may map to the global content ID 290 and the local ID of the first snapshot on the target subsystem may also map to the global content ID 290. In this way, a given storage subsystem may be able to identify which of its snapshots are also present on other storage subsystems. In one embodiment, cloud service 235 may maintain mappings of local content IDs to global content IDs for the storage subsystems of a given organization.

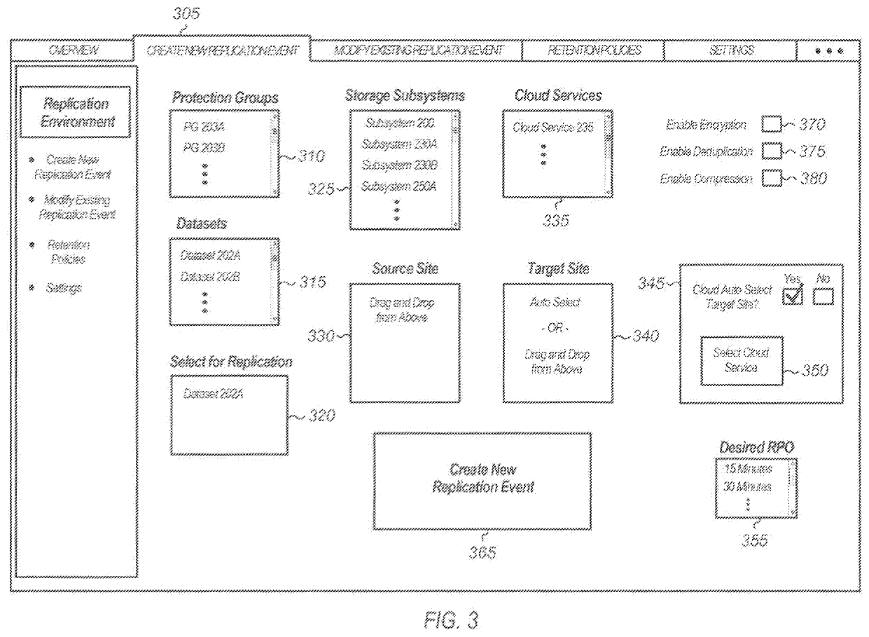

Referring now to FIG. 3, one embodiment of a graphical user interface (GUI) for managing a replication environment is shown. Depending on the embodiment, the GUI may be generated by software executing on a storage subsystem, a computing device coupled to the storage subsystem, or by a cloud service. In one embodiment, the GUI may be populated from data stored by the cloud service and from data stored on one or more storage subsystems. This data may include the available storage subsystems and available cloud services which may be utilized for replication events.

The replication GUI may have multiple tabs as shown in FIG. 3. For example, the “create new replication event” tab 305 is selected in the view shown in FIG. 3. The user may also be able to select other tabs as well, including an overview tab, modify existing replication event tab, retention policies tab, settings tab, and one or more other tabs. By selecting these tabs, the user may change the view of the GUI.

The user may select from among protection groups box 310 or datasets box 315 for data to replicate. Other embodiments may include other types of data to select for replication. The user may drag any of these items to replication box 320 to specify which data to replicate. Additionally, the user may select a storage subsystem from storage subsystems box 325 to add to source site box 330, and the user may select a storage subsystem from storage subsystems box 325 to add to target site box 340. Alternatively, the user may select a cloud service from cloud services box 335 to add to target site box 340. In some embodiments, multiple different cloud services corresponding to multiple different cloud infrastructures may be available as the replication target site. Target site box 340 may be used to identify which storage subsystem or cloud service should be used as the target for replication for replicating the data selected in box 320. In some embodiments, more than one storage subsystem or cloud service may be added to target site box 340, and then the chosen data may be replicated to more than one target.

In one embodiment, the available storage subsystems shown in box 325 may be populated with data provided by a cloud service. The cloud service may be able to populate box 325 by identifying all of the available storage subsystems for the given organization from log data generated and phoned home from the storage subsystems to the cloud service. Alternatively, an administrator or other authorized user may manually add the available storage subsystems and cloud services to boxes 325 and 335, respectively.

The user may select the “yes” option in box 345 to allow the cloud service to automatically select the target site for the replication event being created. The cloud service may select the target site based on characteristics (e.g., utilized storage capacity, health) of the potential target storage subsystems. If the user selects the “yes” option, then the user may specify which cloud service should perform the automatic selection of the replica and recovery targets. In one embodiment, the user may drag a cloud service from box 335 to box 350 to perform the selection. If the user selects the “no” option in box 345, then the user may manually select the target site in box 340.

If a cloud service is performing the automatic selection of the replica and recovery targets, then there are multiple types of auto select policies which may be utilized. In some embodiments, the cloud service may auto select replication policies based on the current state of the system. In other embodiments, the cloud service may optimize the policy dynamically over time. If the original storage system is replicating to on-premise storage subsystems and a cloud service, new mediums may be sent to a different replication host without syncing from a stable medium. This would allow the new storage subsystem to bypass the initial replication seed while recovering the missing medium extents from the cloud service. When a snapshot is restored, the cloud service may create a stable medium and sync the stable medium to the replica storage subsystem. Alternatively, the data could be requested as needed. The replica storage subsystem could function as a cache for the cloud service.

In one embodiment, encryption may be automatically enabled or disabled depending on the specified target. For example, in one embodiment, if a cloud service is selected as the target site, then encryption may be automatically enabled for the replication event. In other embodiments, the user may select to enable or disable encryption via box 370. Additionally, the user may select to enable or disable deduplication and compression via boxes 375 and 380, respectively. Alternatively, deduplication and/or compression may be automatically enabled or disabled depending on the specified target and/or specified data being replicated.

In one embodiment, the user may also select the desired recovery point objective (RPO) for the replication event in box 355. The setting selected in box 355 may determine how often the replication event is performed. When the user has made all of the selections for the replication event, the user may select the “create new replication event” box 365 to actually create the new replication event. It is noted that there may be one or more other settings not shown in the GUI of FIG. 3 which are configurable by the user to control the new replication event. For example, the user may set a retention policy which may be utilized to determine how long to retain the replicated data. It is noted that in other embodiments, the appearance of the replication environment GUI may differ from that shown in FIG. 3. Accordingly, some of the information shown in FIG. 3 may be omitted or may appear differently. Also, additional information and replication-related settings may be included in the GUI in other embodiments.

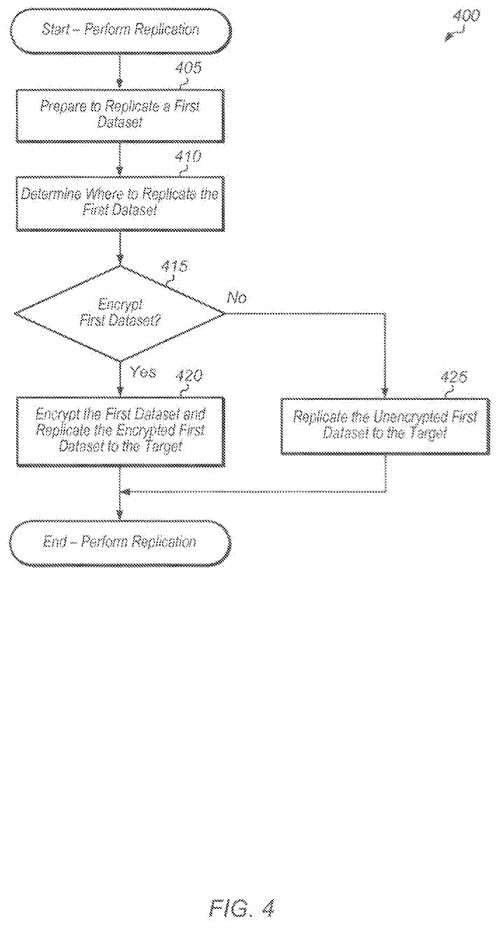

Referring now to FIG. 4, one embodiment of a method 400 for performing replication is shown. The components embodied in system 100 described above (e.g., storage controller 110) may generally operate in accordance with method 400. In addition, the steps in this embodiment are shown in sequential order. However, some steps may occur in a different order than shown, some steps may be performed concurrently, some steps may be combined with other steps, and some steps may be absent in another embodiment.

A first storage subsystem may prepare to replicate a first dataset (block 405). In one embodiment, the first storage subsystem may be a storage array. The first dataset may include one or more volumes, virtual machines, disk images, files, protection groups, and/or one or more other data objects. Next, the first storage subsystem may determine where to replicate the first dataset (block 410). In one embodiment, a second storage subsystem may have already been selected as the replication target of the first dataset. In another embodiment, a cloud service may have already been selected as the replication target of the first dataset. In a further embodiment, multiple storage subsystems may have been selected as replication targets of the first dataset.

After determining where to replicate the first dataset, the first storage subsystem may determine whether the first dataset should be encrypted prior to being replicated to the target (conditional block 415). In one embodiment, the first storage subsystem may determine whether to encrypt the first dataset based on the identity or location of the target. If the first storage subsystem determines to encrypt the first dataset (conditional block 415, “yes” leg), then the first storage subsystem may encrypt the first dataset and replicate the encrypted first dataset to the target (block 420). If the first storage subsystem determines not to encrypt the first dataset (conditional block 415, “no” leg), then the first storage subsystem may replicate the unencrypted first dataset to the target (block 425). For example, if the target is a second storage subsystem of the same organization, then the first storage subsystem may determine not to encrypt the first dataset. However, if the target is a cloud service or a storage subsystem on a potentially compromised network, then the first storage subsystem may encrypt the first dataset. After blocks 420 and 425, method 400 may end.

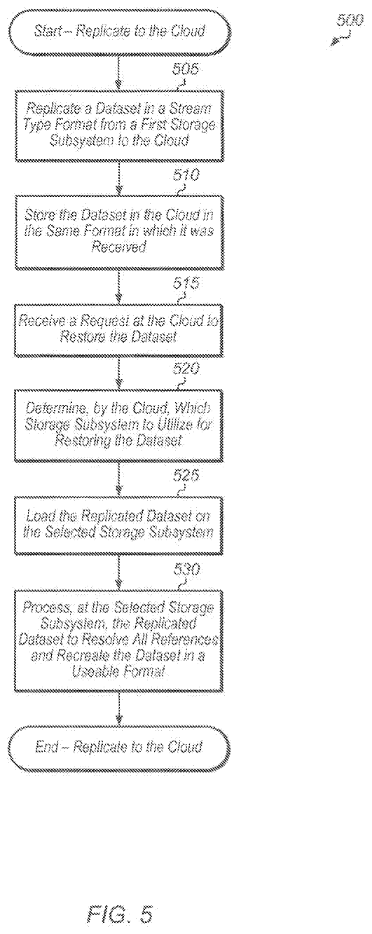

Referring now to FIG. 5, one embodiment of a method 500 for replicating to the cloud is shown. The components embodied in system 100 described above (e.g., storage controller 110, cloud service 180) may generally operate in accordance with method 500. In addition, the steps in this embodiment are shown in sequential order. However, some steps may occur in a different order than shown, some steps may be performed concurrently, some steps may be combined with other steps, and some steps may be absent in another embodiment.

A dataset may be replicated in a stream type format from a first storage subsystem to the cloud (block 505). The stream type format may not be directly usable by the cloud. In one embodiment, the dataset may be replicated as a plurality of tuples, wherein each tuple includes a key and one or more data fields including data such as a pointer used to identify or locate data components. Some tuples may refer to previous tuples within the replicated dataset, while other tuples may refer to data already stored in the cloud or on another storage subsystem. The cloud may not perform any processing of the replicated dataset to resolve these references, but instead may simply store the replicated dataset in the same format in which it was received (block 510).

Next, the cloud may receive a request to restore the dataset (block 515). In one embodiment, the request may be generated in response to detecting a failure or malfunction of the first storage subsystem. In response to receiving the request, the cloud may determine which storage subsystem to utilize for restoring the dataset (block 520). The cloud may be coupled to a plurality of storage subsystems, and the cloud may select a given storage subsystem based on information received from the plurality of storage subsystems (e.g., an analysis of log data, or otherwise), based on monitoring the plurality of storage subsystems (e.g., accessing and examining stored logs, current conditions, events, etc.). Alternatively, in some embodiments, the request may specify the storage subsystem to be used for restoring the dataset. Next, the cloud may cause data corresponding to the replicated dataset to be conveyed to the selected storage subsystem (block 525) for restoration. In various embodiments, the data may be conveyed from a cloud based source. In other embodiments, at least some portion of the data may be conveyed from one or more other storage subsystems. In such an embodiment, the other storage subsystems may first convey the data to the cloud responsive to a request. In other embodiments, the other storage subsystems may be directed to convey such data to the selected storage subsystem without being first conveyed to the cloud. Still other embodiments may include the cloud receiving and storing one or more logs of transactions on the storage subsystems. In such embodiments, the log(s) may be used to recreate and/or update data in the cloud or on one or more of the storage subsystems. Various combinations of such approaches are possible and are contemplated. Then, the selected storage subsystem may process the replicated dataset to resolve all references and recreate the dataset in a useable format (block 530). After block 530, method 500 may end.

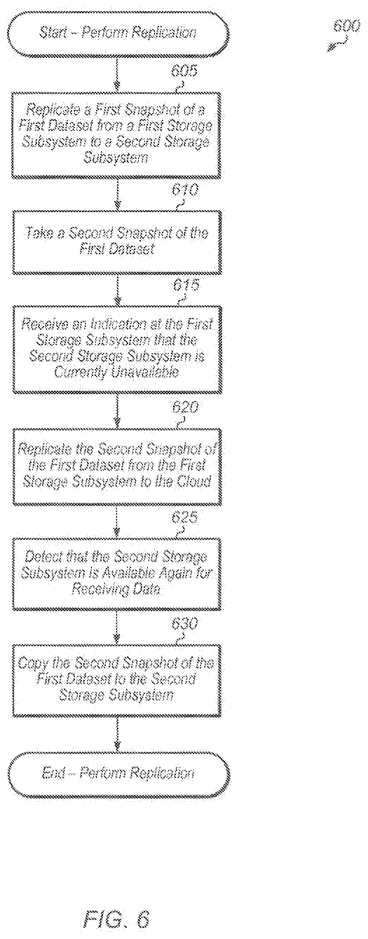

Referring now to FIG. 6, one embodiment of a method 600 for performing replication is shown. The components embodied in system 100 described above (e.g., storage controller 110, cloud service 180) may generally operate in accordance with method 600. In addition, the steps in this embodiment are shown in sequential order. However, some steps may occur in a different order than shown, some steps may be performed concurrently, some steps may be combined with other steps, and some steps may be absent in another embodiment.

A first snapshot of a first dataset may be replicated from a first storage subsystem to a second storage subsystem (block 605). The first dataset may include a collection of data, such as one or more of a volume, group of files, protection group, virtual machine, or other data. In one embodiment, the first and second storage subsystems may be storage arrays. In other embodiments, the first and second storage subsystems may be other types of storage systems.

At a later point in time, a second snapshot of the first dataset may be taken (block 610). The second snapshot may only include the changes made to the first dataset since the first snapshot was taken. In some embodiments, snapshots may be taken of the first dataset on a regularly scheduled basis. Next, the first storage subsystem may receive an indication that the second storage subsystem is currently unavailable (block 615). In response to receiving this indication, the first storage subsystem may replicate the second snapshot of the first dataset to the cloud (block 620). In various embodiments, the entire snapshot may be replicated to the cloud. In other embodiments, only the blocks that have changed since the first snapshot may be replicated to the cloud. In further embodiments, a log of transactions may be sent to the cloud. Any approach may be utilized, or any combination of the these.

At a later point in time, the cloud may detect that the second storage subsystem is available again for receiving data (block 625). Alternatively, the cloud may receive an indication that the second storage subsystem is available for receiving data. Next, the cloud may copy the second snapshot of the first dataset to the second storage subsystem (block 630). After block 630, method 600 may end. It is noted that method 600 may be repeated for each snapshot that is taken of a dataset which is scheduled for replication.

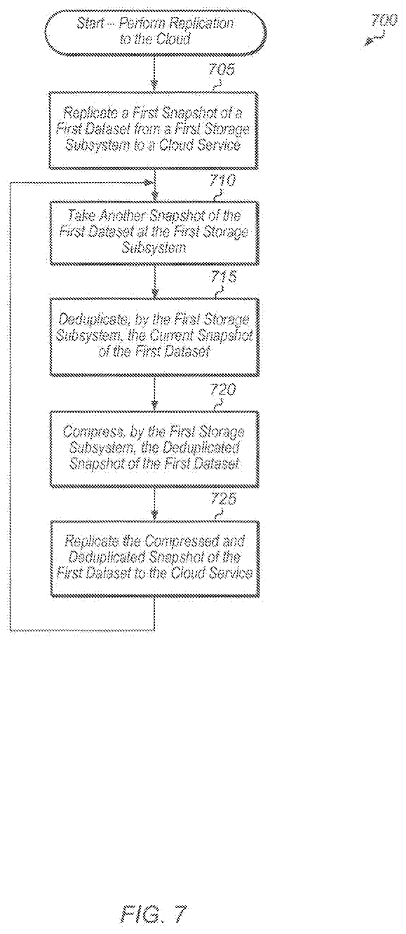

Referring now to FIG. 7, one embodiment of a method 700 for performing replication to the cloud is shown. The components embodied in system 100 described above (e.g., storage controller 110, cloud service 180) may generally operate in accordance with method 700. In addition, the steps in this embodiment are shown in sequential order. However, some steps may occur in a different order than shown, some steps may be performed concurrently, some steps may be combined with other steps, and some steps may be absent in another embodiment.

A first snapshot of a first dataset may be replicated from a first storage subsystem to a cloud service (block 705). At a later point in time, another snapshot of the first dataset may be taken by the first storage subsystem (block 710). The current snapshot may only include the changes made to the first dataset since the most recent (or previous) snapshot was taken. Next, the first storage subsystem may deduplicate the current snapshot of the first dataset (block 715). The deduplicated snapshot may include references to data included in the previous snapshot and any other snapshots which have already been replicated from the first storage subsystem to the cloud service, including snapshots of other volumes. Then, the first storage subsystem may compress the deduplicated snapshot of the first dataset (block 720). Any suitable form of compression may be utilized, depending on the embodiment. Next, the first storage subsystem may replicate the compressed and deduplicated snapshot of the first dataset to the cloud service (block 725). Since the current snapshot includes changes from the previous snapshot, and then the snapshot is deduplicated and compressed before being replicated, the amount of data which is sent from the first storage subsystem to the cloud may generally be reduced. In some embodiments, only changes from a previous snapshot are included. However, in other embodiments other data may be included as well. This approach achieves a reduction in both the amount of network traffic and the amount of time required to replicate the snapshot. After block 725, method 700 may return to block 710 to take another snapshot of the first dataset.

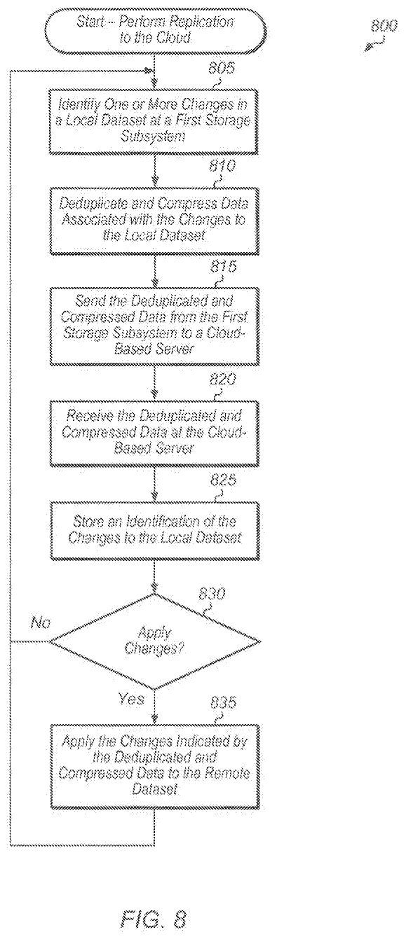

Turning now to FIG. 8, one embodiment of a method 800 for performing replication to the cloud is shown. The components embodied in system 100 described above (e.g., storage controller 110, cloud service 180) may generally operate in accordance with method 800. In addition, the steps in this embodiment are shown in sequential order. However, some steps may occur in a different order than shown, some steps may be performed concurrently, some steps may be combined with other steps, and some steps may be absent in another embodiment.

A first storage subsystem may identify one or more changes in a local dataset (block 805). The local dataset may be any of the various types of previously described datasets. In one embodiment, the first storage subsystem may identify one or more changes in the local dataset by taking a snapshot of the local dataset, wherein the snapshot includes only changes made to the local dataset since a previous snapshot was taken.

Next, the first storage subsystem may deduplicate and compress data associated with the changes to the local dataset (block 810). In one embodiment, the data associated with the changes may be the snapshot. In another embodiment, the data associated with the changes may be one or more transactions which were applied to the local dataset. In other embodiments, other data may be generated which is associated with the changes to the local dataset. Then, the first storage subsystem may send the deduplicated and compressed data to a cloud-based server (block 815). The cloud-based server may include or be coupled to a remote dataset which is a replicated version of the local dataset. In some embodiments, the first storage subsystem may also send one or more medium identifiers (IDs) to the cloud-based server, wherein the medium IDs are associated with the snapshot of the local dataset. Mediums and medium IDs are described in more detail below in the discussion regarding FIGS. 9-21.

The cloud-based server may receive the deduplicated and compressed data sent by the first storage subsystem (block 820). Next, the cloud-based server may store an identification of the changes to the local dataset (block 825). In one embodiment, the cloud-based server may store a log of transactions that have been applied to the local dataset. Then, the cloud-based server may determine whether to apply the changes indicated by the deduplicated and compressed data to the remote dataset (conditional block 830). If the cloud-based server determines to apply the changes (conditional block 830, “yes” leg), then the cloud-based server may apply the changes indicated by the deduplicated and compressed data to the remote dataset (block 835). If the cloud-based server determines not to apply the changes (conditional block 830, “no” leg), then method 800 may return to block 805 with the first storage subsystem identifying additional change(s) to the local dataset. For example, in various embodiments multiple changes may be identified before making the changes. In other embodiment, identified changes may be made one at a time. In some embodiment, determining whether to make currently identified changes before identifying further changes may be based on current system condition, network conditions, time of day, or any other condition. In one embodiment, the cloud-based server may periodically consume transactions, while in other embodiments, the cloud-based server may wait until the number of transactions has reached a given threshold before applying the transactions to the remote dataset. In a further embodiment, the cloud-based server may apply the changes responsive to detecting a failure of the first storage subsystem. After block 835, method 800 may return to block 805 with the first storage subsystem identifying additional change(s) to the local dataset.

Referring now to FIG. 9, a block diagram illustrating a directed acyclic graph (DAG) 900 of mediums is shown. Also shown is a volume to medium mapping table 915 that shows which medium a volume maps to for each volume in use by a storage system. Volumes 901, 902, 905, 907, 909, and 920 may be considered pointers into graph 900.

The term “medium” as is used herein is defined as a logical grouping of data. A medium may have a corresponding identifier (ID) with which to identify the logical grouping of data. Each medium may have a unique ID that is never reused in the system or subsystem. In other words, the medium ID is non-repeating. In one embodiment, the medium ID may be a monotonically increasing number. In some embodiments, the medium ID may be incremented for each snapshot taken of the corresponding dataset, volume, or logical grouping of data. In these embodiments, the medium ID may be a sequential, non-repeating ID. Each medium may also include or be associated with mappings of logical block numbers to content location, deduplication entries, and other information. In one embodiment, medium identifiers may be used by the storage controller but medium identifiers may not be user-visible. A user (or client) may send a data request accompanied by a volume ID to specify which data is targeted by the request, and the storage controller may map the volume ID to a medium ID and then use the medium ID when processing the request.

The term “medium” is not to be confused with the terms “storage medium” or “computer readable storage medium”. A storage medium is defined as an actual physical device (e.g., SSD, HDD) that is utilized to store data. A computer readable storage medium (or non-transitory computer readable storage medium) is defined as a physical storage medium configured to store program instructions which are executable by a processor or other hardware device. Various types of program instructions that implement the methods and/or mechanisms described herein may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

It is also noted that the term “volume to medium mapping table” may refer to multiple tables rather than just a single table. Similarly, the term “medium mapping table” may also refer to multiple tables rather than just a single table. It is further noted that volume to medium mapping table 915 is only one example of a volume to medium mapping table. Other volume to medium mapping tables may have other numbers of entries for other numbers of volumes.

Each medium is depicted in graph 900 as three conjoined boxes, with the leftmost box showing the medium ID, the middle box showing the underlying medium, and the rightmost box displaying the status of the medium (RO—read-only) or (RW—read-write). Read-write mediums may be referred to as active mediums, while read-only mediums may represent previously taken snapshots. Within graph 900, a medium points to its underlying medium. For example, medium 20 points to medium 12 to depict that medium 12 is the underlying medium of medium 20. Medium 12 also points to medium 10, which in turn points to medium 5, which in turn points to medium 1. Some mediums are the underlying medium for more than one higher-level medium. For example, three separate mediums (12, 17, 11) point to medium 10, two separate mediums (18, 10) point to medium 5, and two separate mediums (6, 5) point to medium 1. Each of the mediums which is an underlying medium to at least one higher-level medium has a status of read-only.

It is noted that the term “ancestor” may be used to refer to underlying mediums of a given medium. In other words, an ancestor refers to a medium which is pointed to by a first medium or which is pointed to by another ancestor of the first medium. For example, as described above and shown in FIG. 9, medium 20 points to medium 12, medium 12 points to medium 10, medium 10 points to medium 5, and medium 5 points to medium 1. Therefore, mediums 12, 10, 5, and 1 are ancestors of medium 20. Similarly, mediums 10, 5, and 1 are ancestors of medium 12.

The set of mediums on the bottom left of graph 900 is an example of a linear set. As depicted in graph 900, medium 3 was created first and then a snapshot was taken resulting in medium 3 becoming stable (i.e., the result of a lookup for a given block in medium 3 will always return the same value after this point). Medium 7 was created with medium 3 as its underlying medium. Any blocks written after medium 3 became stable were labeled as being in medium 7. Lookups to medium 7 return the value from medium 7 if one is found, but will look in medium 3 if a block is not found in medium 7. At a later time, a snapshot of medium 7 is taken, medium 7 becomes stable, and medium 14 is created. Lookups for blocks in medium 14 would check medium 7 and then medium 3 to find the targeted logical block. Eventually, a snapshot of medium 14 is taken and medium 14 becomes stable while medium 15 is created. At this point in graph 900, medium 14 is stable with writes to volume 102 going to medium 15.

Volume to medium mapping table 915 maps user-visible volumes to mediums. Each volume may be mapped to a single medium, also known as the anchor medium. This anchor medium, as with all other mediums, may take care of its own lookups. A medium on which multiple volumes depend (such as medium 10) tracks its own blocks independently of the volumes which depend on it. Each medium may also be broken up into ranges of blocks, and each range may be treated separately in medium DAG 900.

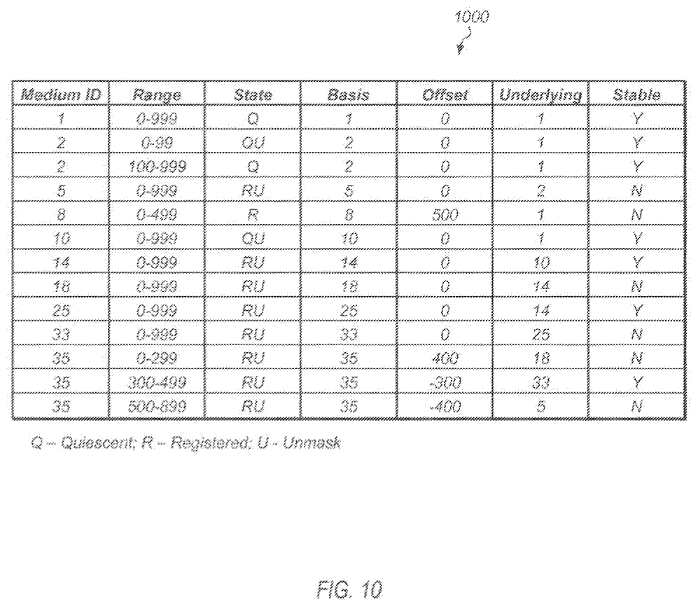

Turning now to FIG. 10, one embodiment of a medium mapping table 1000 is shown. Any portion of or the entirety of medium mapping table 1000 may be stored in storage controller 110 (of FIG. 1) and/or in one or more of storage devices 135A-N (of FIG. 1). A volume identifier (ID) may be used to access volume to medium mapping table 915 to determine a medium ID corresponding to the volume ID. This medium ID may then be used to access medium mapping table 1000. It is noted that table 1000 is merely one example of a medium mapping table, and that in other embodiments, other medium mapping tables, with other numbers of entries, may be utilized. In addition, in other embodiments, a medium mapping table may include other attributes and be organized in a different manner than that shown in FIG. 10.

It is also noted that any suitable data structure may be used to store the mapping table information in order to provide for efficient searches (e.g., b-trees, binary trees, hash tables, etc.). All such data structures are contemplated.

Each medium may be identified by a medium ID, as shown in the leftmost column of table 1000. A range attribute may also be included in each entry of table 1000, and the range may be in terms of data blocks. The size of a block of data (e.g., 4 KB, 8 KB) may vary depending on the embodiment. It is noted that the terms “range” and “extent” may be used interchangeably herein. A medium may be broken up into multiple ranges, and each range of a medium may be treated as if it is an independent medium with its own attributes and mappings. For example, medium ID 2 has two separate ranges. Range 0-99 of medium ID 2 has a separate entry in table 1000 from the entry for range 100-999 of medium ID 2.

Although both of these ranges of medium ID 2 map to underlying medium ID 1, it is possible for separate ranges of the same source medium to map to different underlying mediums. For example, separate ranges from medium ID 35 map to separate underlying mediums. For example, range 0-299 of medium ID 35 maps to underlying medium ID 18 with an offset of 400. This indicates that blocks 0-299 of medium ID 35 map to blocks 400-699 of medium ID 18. Additionally, range 300-499 of medium ID 35 maps to underlying medium ID 33 with an offset of −300 and range 500-899 of medium ID 35 maps to underlying medium ID 5 with an offset of −400. These entries indicate that blocks 300-499 of medium ID 35 map to blocks 0-199 of medium ID 33, while blocks 500-899 of medium ID 35 map to blocks 100-499 of medium ID 5. It is noted that in other embodiments, mediums may be broken up into more than three ranges.

The state column of table 1000 records information that allows lookups for blocks to be performed more efficiently. A state of “Q” indicates the medium is quiescent, “R” indicates the medium is registered, and “U” indicates the medium is unmasked. In the quiescent state, a lookup is performed on exactly one or two mediums specified in table 1000. In the registered state, a lookup is performed recursively. The unmasked state determines whether a lookup should be performed in the basis medium, or whether the lookup should only be performed in the underlying medium. Although not shown in table 1000 for any of the entries, another state “X” may be used to specify that the source medium is unmapped. The unmapped state indicates that the source medium contains no reachable data and can be discarded. This unmapped state may apply to a range of a source medium. If an entire medium is unmapped, then the medium ID may be entered into a sequence invalidation table and eventually discarded.

In one embodiment, when a medium is created, the medium is in the registered state if it has an underlying medium, or the medium is in the quiescent state if it is a brand-new volume with no pre-existing state. As the medium is written to, parts of it can become unmasked, with mappings existing both in the medium itself and the underlying medium. This may be done by splitting a single range into multiple range entries, some of which retain the original masked status, and others of which are marked as unmasked.

In addition, each entry in table 1000 may include a basis attribute, which indicates the basis of the medium, which in this case points to the source medium itself. Each entry may also include an offset field, which specifies the offset that should be applied to the block address when mapping the source medium to an underlying medium. This allows mediums to map to other locations within an underlying medium rather than only being built on top of an underlying medium from the beginning block of the underlying medium. As shown in table 1000, medium 8 has an offset of 500, which indicates that block 0 of medium 8 will map to block 500 of its underlying medium (medium 1). Therefore, a lookup of medium 1 via medium 8 will add an offset of 500 to the original block number of the request. The offset column allows a medium to be composed of multiple mediums. For example, in one embodiment, a medium may be composed of a “gold master” operating system image and per-VM (virtual machine) scratch space. Other flexible mappings are also possible and contemplated.

Each entry also includes an underlying medium attribute, which indicates the underlying medium of the source medium. If the underlying medium points to the source medium (as with medium 1), then this indicates that the source medium does not have an underlying medium, and all lookups will only be performed in the source medium. Each entry may also include a stable attribute, with “Y” (yes) indicating the medium is stable (or read-only), and with “N” (no) indicating the medium is read-write. In a stable medium, the data corresponding to a given block in the medium never changes, though the mapping that produces this data may change. For example, medium 2 is stable, but block 50 in medium 2 might be recorded in medium 2 or in medium 1, which may be searched logically in that order, though the searches may be done in parallel if desired. In one embodiment, a medium will be stable if the medium is used as an underlying medium by any medium other than itself.

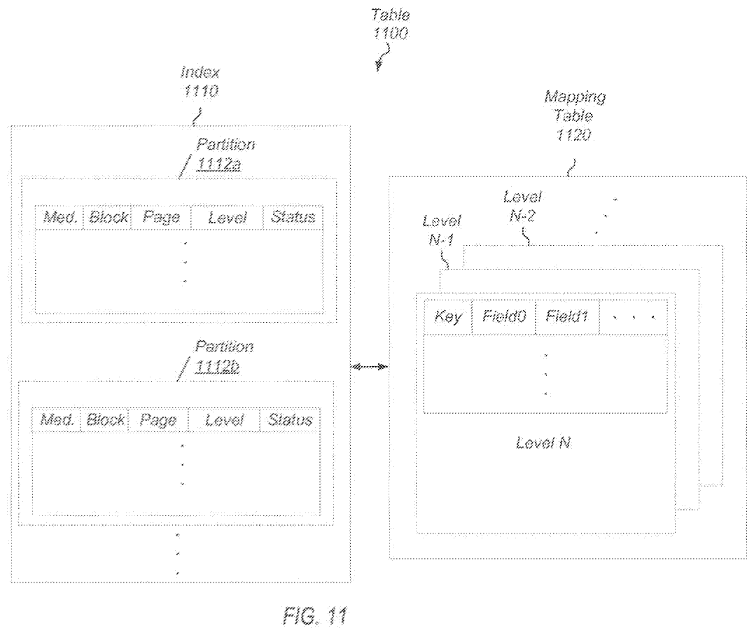

Turning now to FIG. 11, a block diagram of one embodiment of a table 1100 is shown. In various embodiments, table 1100 may be an address translation table, a deduplication table, an overlay table, or any other type of table utilized by a storage controller. In an embodiment with table 1100 utilized as an address translation table, a given received read/write request received by a storage controller may identify a particular volume, sector (or block number), and length. The volume may be translated into a medium ID using the volume-to-medium mapping table. The medium ID and block number may then be used to access index 1110 to locate an index entry corresponding to the specific medium ID and block number. The index entry may store at least one tuple including a key. Each index entry may also include a level ID and page ID of a corresponding entry in mapping table 1120.

Using the level ID, page ID, and a key value generated from the medium ID and block number, the corresponding mapping table entry may be located and a pointer to the storage location may be returned from this entry. The pointer may be used to identify or locate data stored in the storage devices of the storage system. In addition to the pointer value, status information, such as a valid indicator, a data age, a data size, and so forth, may be stored in Field0 to FieldN shown in Level N of mapping table 1120. It is noted that in various embodiments, the storage system may include storage devices (e.g., SSDs) which have internal mapping mechanisms. In such embodiments, the pointer in the mapping table entry may not be an actual physical address per se. Rather, the pointer may be a logical address which the storage device maps to a physical location within the device.

For the purposes of this discussion, the key value used to access entries in index 1110 is the medium ID and block number corresponding to the data request. However, in other embodiments, other types of key values may be utilized. In these embodiments, a key generator may generate a key from the medium ID, block number, and/or one or more other requester data inputs, and the key may be used to access index 1110 and locate a corresponding entry.

In one embodiment, index 1110 may be divided into partitions, such as partitions 1112a-1112b. In one embodiment, the size of the partitions may range from a 4 kilobyte (KB) page to 256 KB, though other sizes are possible and are contemplated. Each entry of index 1110 may store a key value, and the key value may be based on the medium ID, block number, and other values. For the purposes of this discussion, the key value in each entry is represented by the medium ID and block number. This is shown merely to aid in the discussion of mapping between mediums and entries in index 1110. In other embodiments, the key values of entries in index 1110 may vary in how they are generated.

In various embodiments, portions of index 1110 may be cached, or otherwise stored in a relatively fast access memory. In various embodiments, the entire index 1110 may be cached. In some embodiments, where the primary index has become too large to cache in its entirety, or is otherwise larger than desired, secondary, tertiary, or other index portions may be used in the cache to reduce its size. In addition to the above, in various embodiments mapping pages corresponding to recent hits may be cached for at least some period of time. In this manner, processes which exhibit accesses with temporal locality can be serviced more rapidly (i.e., recently accessed locations will have their mappings cached and readily available).

In some embodiments, index 1110 may be a secondary index which may be used to find a key value for accessing a primary index. The primary index may then be used for locating corresponding entries in address translation table 1100. It is to be understood that any number of levels of indexes may be utilized in various embodiments. In addition, any number of levels of redirection may be utilized for performing the address translation of received data requests, depending on the embodiment. In some embodiments, a corresponding index may be included in each level of mapping table 1120 for mappings which are part of the level. Such an index may include an identification of mapping table entries and where they are stored (e.g., an identification of the page) within the level. In other embodiments, the index associated with mapping table entries may be a distinct entity, or entities, which are not logically part of the levels themselves. It is noted that in other embodiments, other types of indexes and mapping tables may be utilized to map medium IDs and block numbers to physical storage locations.

Mapping table 1120 may comprise one or more levels. For example, in various embodiments, table 1120 may comprise 16 to 64 levels, although other numbers of levels supported within a mapping table are possible and contemplated. Three levels labeled Level “N”, Level “N−1” and Level “N−2” are shown for ease of illustration. Each level within table 1120 may include one or more partitions. In one embodiment, each partition is a 4 kilo-byte (KB) page. In one embodiment, a corresponding index 1110 may be included in each level of mapping table 1120. In this embodiment, each level and each corresponding index 1110 may be physically stored in a random-access manner within the storage devices.

In another embodiment, table 1100 may be a deduplication table. A deduplication table may utilize a key comprising a hash value determined from a data component associated with a storage access request. For each data component, a deduplication application may be used to calculate a corresponding hash value. In order to know if a given data component corresponding to a received write request is already stored in one of the storage devices, bits of the calculated hash value (or a subset of bits of the hash value) for the given data component may be compared to bits in the hash values of data components stored in one or more of the storage devices.

In a further embodiment, table 1100 may be an overlay table. One or more overlay tables may be used to modify or elide tuples corresponding to key values in the underlying mapping table and provided by other tables in response to a query. The overlay table(s) may be used to apply filtering conditions for use in responding to accesses to the mapping table or during flattening operations when a new level is created. Keys for the overlay table need not match the keys for the underlying mapping table. For example, an overlay table may contain a single entry stating that a particular range of data has been deleted or is otherwise inaccessible and that a response to a query corresponding to a tuple that refers to that range is invalid. In another example, an entry in the overlay table may indicate that a storage location has been freed, and that any tuple that refers to that storage location is invalid, thus invalidating the result of the lookup rather than the key used by the mapping table. In some embodiments, the overlay table may modify fields in responses to queries to the underlying mapping table. In some embodiments, a range of key values may be used to efficiently identify multiple values to which the same operation is applied. In this manner, tuples may effectively be “deleted” from the mapping table by creating an “elide” entry in the overlay table and without modifying the mapping table. The overlay table may be used to identify tuples that may be dropped from the mapping table in a relatively efficient manner. It is noted that in other embodiments, other types of mapping tables may be utilized with the replication techniques disclosed herein. For example, in another embodiment, a single log file may be utilized to map logical addresses to physical addresses. In a further embodiment, a key-value store may be utilized. Other structures of mapping tables are possible and are contemplated.

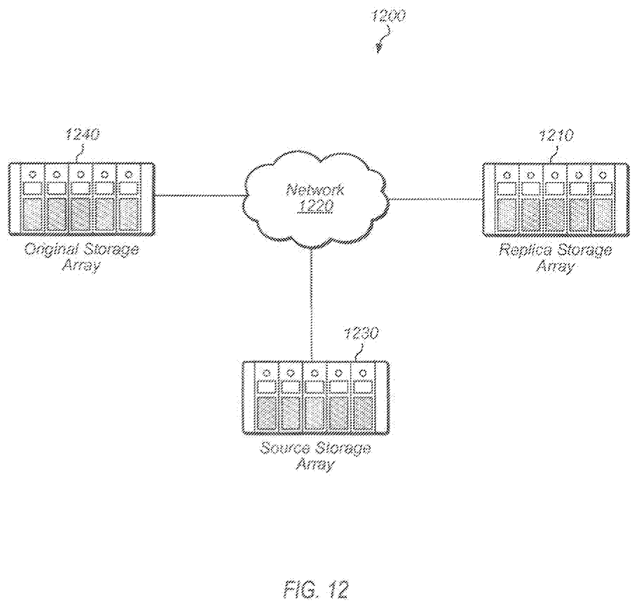

Turning now to FIG. 12, a block diagram of one embodiment of a system 1200 with multiple storage arrays is shown. System 1200 may include original storage array 1240, replica storage array 1210, and source storage array 1230. In one embodiment, these arrays may be coupled together via network 1220, which is representative of any number and type of networks. System 1200 may also include any number of other storage arrays in addition to those shown. It is noted that storage arrays 1210, 1230, and 1240 may also be referred to as storage systems.

In one embodiment, each of storage arrays 1210, 1230, and 1240 may include the components (e.g., storage controller, device groups) shown in storage array 105 (of FIG. 1). Additionally, each storage array may utilize volume to medium mapping tables similar to volume to medium mapping table 915 (of FIG. 9) and medium mapping tables similar to medium mapping table 1000 (of FIG. 10) to track the various volumes and mediums which are utilized by the storage array.

For the purposes of this discussion, original storage array 1240 represents the array on which a given volume and snapshot were first created. Replica storage array 1210 may represent the array to which the given snapshot is being replicated. Source storage array 1230 may represent an array containing the medium to be replicated from which replica storage array 1210 is pulling missing data necessary for the given snapshot. It is noted that these designations of the various storage arrays are used in the context of a given replication operation. For subsequent replication operations, these designations may change. For example, a first snapshot may be replicated from original storage array 1240 to replica storage array 1210 at a particular point in time. At a later point in time, a second snapshot may be replicated from replica storage array 1210 to original storage array 1240. For the replication of the second snapshot, storage array 1210 may be referred to as an “original” storage array while storage array 1240 may be referred to as a “replica” storage array. Also, the source storage system and the original storage system may be the same for a given replication event. In other words, system 1210 could pull data to replicate a medium from array 1240 directly if it chooses.

In system 1200, snapshots may be taken independently by original storage array 1240. Then, replica storage array 1210 may decide which particular snapshots to replicate when replica storage array 1210 connects to original storage array 1240. In this way, replica storage array 1210 does not need to copy a large number of snapshots if it has not connected to original storage array 1240 for a long period of time. Instead, replica storage array 1210 may only choose to replicate the most recent snapshot. Alternatively, original storage array 1240 may make a policy decision and notify replica storage array 1210 to pull a given snapshot as embodied in a given medium. Replica storage array 1210 may then choose to pull extents of the given medium from any storage array to which it has access.

In one embodiment, system 1200 may implement a replication mechanism using mediums to avoid copying data. For example, suppose that M is a medium comprising a snapshot S of volume V, and that M′ is a medium comprising a later snapshot S′ of V. If replica storage array 1210 already contains M, source storage array 1230 may transfer data in M′ but not in M to replica storage array 1210 so as to perform the replication process of medium M′ Source storage array 1230 may determine which regions fall through and which regions are actually in M′ by reading the medium map that it maintains.

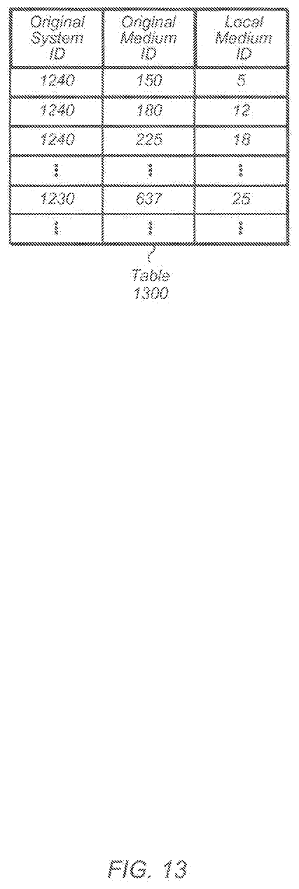

In one embodiment, each storage array may utilize a local name for every medium maintained by the storage array, including mediums that originated locally and mediums that were replicated from other storage arrays. For mediums originating from other storage arrays, the local storage array may keep a table mapping original array ID and original medium ID to local medium ID. An example table for mapping original array ID and original medium ID to local medium ID is shown in FIG. 13. Thus, a storage array may look up mediums by original array ID, which is a partial key, and find both the original medium ID and the local medium ID. A storage array may also perform a lookup to the table using both original array ID and original medium ID to get the local medium ID. In another embodiment, each medium in system 1200 could be assigned a globally-unique ID which is the same ID on all storage arrays which utilize or store the medium. This globally-unique ID may then be used as the sole identifier on any storage array of system 1200.

In one embodiment, to replicate a snapshot from original storage array 1240 to replica storage array 1210, the following steps may be taken: First, the anchor medium corresponding to the snapshot on original storage array 1240 may be made stable by taking a snapshot of the volume if necessary. If this anchor medium is already stable, then there is no need to take the snapshot. Next, replica storage array 1210 may initiate the replication process by querying original storage array 1240 for a list of snapshots of the volume that could be replicated. Original storage array 1240 may respond with a list of possible snapshots and corresponding mediums for each snapshot. Then, the medium corresponding to the desired snapshot may be replicated to storage array 1210. This medium may be called ‘M’. Replica storage array 1210 may then contact any source storage array 1230 in system 1200 with the medium M that it wants to replicate. Replica storage array 1210 may utilize its mapping table to identify all of the medium extents that are available for use as sources for deduplicated data, and may also optionally supply this list of medium extents that it maintains locally to source storage array 1230. Again, it is noted that source storage array 1230 may be original storage array 1240, or it may be another storage system to which original storage array 1240 has, directly or indirectly, previously replicated medium M.

Source storage array 1230 may use the list of medium extents and the medium ‘M’ selected for replication to build a list of information that needs to be sent to replica storage array 1210 to replicate medium M. Each packet of information may be referred to as a “quantum” or an “rblock”. An rblock can specify the content of a particular region of M as either medium extents that already exist on replica storage array 1210 or as data that has previously been sent from source storage array 1230 to replica storage array 1210 for M. An rblock can also contain a list of data tuples for M. A tuple may be a combination of block ID and data for the particular region of M. An rblock may also contain a combination of references and data tuples.

Replica storage array 1210 may acknowledge rblocks sent by source storage array 1230. Replica storage array 1210 may batch acknowledgements and send several at once rather than sending an acknowledgement after receiving each rblock. Acknowledgements may be sent using any suitable technique, including explicit acknowledgement by serial number of each rblock or acknowledging the latest serial number received with no gaps in serial number.

Source storage array 1230 may keep track of the latest rblock that replica storage array 1210 has acknowledged. Source storage array 1230 may discard rblocks that replica storage array 1210 has acknowledged since these will not need to be resent. Source storage array 1230 may add the extents that replica storage array 1210 acknowledges to the list of medium extents that replica storage array 1210 knows about. This list may help reduce the amount of actual data that source storage array 1230 sends to replica storage array 1210 as part of the replication process.

The above-described techniques for performing replication offer a variety of advantages. First, data that source storage array 1230 can determine already exists in a medium extent present on replica storage array 1210 is not sent; instead, source storage array 1230 sends a reference to the already-present data. Second, streamed rblocks do not overlap. Rather, each rblock specifies a disjoint range of content in M. Third, an rblock may only refer to a medium extent that source storage array 1230 knows is on replica storage array 1210, either because it was in the original list of extents sent by replica storage array 1210 to source storage array 1230, or because replica storage array 1210 has acknowledged the extent to source storage array 1230. In some embodiments, replica storage array 1210 may respond that it does not have the referenced extents. In such a case, source storage array 1230 may be requested to resend the extents.

The above-described techniques allow system 1200 to efficiently discover duplicate blocks on source storage array 1230 to produce a correct duplicate. One approach which may be used involves running a differencing algorithm on source storage array 1230 to determine which data blocks must be sent in full and which regions of M can be sent as references to already-extant extents. In one embodiment, for a given extent ‘E’, an optionally discontiguous set of rblocks with patterns may be sent first, and then a reference rblock may be sent that fully covers the extent E.

A typical medium mapping table may map extents such that <M1,offset1,length> maps to <M2,offset2>, wherein M1,and M2 are two separate mediums and offset1 and offset2 are the offsets within those mediums. It may be challenging to determine whether a particular medium is reachable multiple ways using the individual medium extent map that maps <M1,offset1,length>→<M2,offset2>. In other words, it may be challenging to determine if other medium extents also point to <M2,offset2>. To address this problem, a set D1 of medium extents that are mapped to one another may be built. Thus, this set would include all instances of <MD,offsetD> that are pointed to by more than one <M,offset>. This set may allow a merge of all references to the duplicated medium extent <MD,offsetD> by ensuring that all references to blocks in the region refer to the canonical extent MD, rather than to whatever medium they were in that points to MD.

It may also be challenging to determine whether a particular block is a duplicate by resolving it through the medium maps, since translating a given <medium, block> results in a physical address. If blocks <M1, s1> and <M2, s2> both correspond to physical address X, it may be difficult to know when we resolve <M1, s1> that there are other blocks with address X. In other words, working backwards from X to the <medium, block> addresses that refer to it may be problematic. To mitigate these challenges, a set D2 of medium extents may be built that are duplicates of other medium extents. This set may indicate what ranges in different mediums actually correspond to the same blocks, whether by entries in the medium table or by fully resolving the addresses. Any suitable method for building this set D2 of medium extents may be utilized, depending on the embodiment. The two sets of D1 and D2 may be combined into a combined set D of duplicate medium extents.

Once a set of duplicate references has been built, source storage array 1230 may determine which blocks need to be sent to replica storage array 1210. Source storage array 1230 may determine which blocks need to be sent by performing the following steps: First, the set of duplicate extents D may be provided as previously described. Next, a set of sectors Z that replica storage array 1210 already knows about are initialized by inserting all of the sector ranges covered by the medium extents that replica storage array 1210 sent to source storage array 1230.

Next, a set of mappings P from physical addresses (X) to logical addresses (<M,s>) may be initialized to be empty. Each time actual data is sent to replica storage array 1210, the corresponding mapping may be added to set P. Then, for each sector ‘s’ in M, call a function emit_sector (M,s). Once sufficient information has been emitted, the information may be packaged into an rblock and sent to replica storage array 1210. In one embodiment, the function emit_sector (M,s) may traverse the medium extent table until one of the following three cases (a, b, c) happens. Checking for these three cases may be performed in logical order. For example, the checks may be run in parallel, but case a takes precedence over case b, and case b takes precedence over case c.

The three cases (a, b, c) mentioned above are as follows: First, case a is the following: <M,s> maps to a sector in Z called <Q,t>. In this case, emit a reference <M,s>→<Q,t>. Second, case b is the following: A sector <F,t> is hit that's in D, where F≠M. This means that a medium extent map in the medium mapping table has been traversed to a different medium, and an entry has been hit which allows the medium map to be “flattened” to optimize transmission. Flattening the medium map means that a duplicate entry is being deleted and both entries may now point to the same extent. In this case, emit_sector(F,t) may be called, and then a reference <M,s>→<F,t> may be emitted.

Third, case c is the following: An actual physical mapping X is hit that contains the data for the sector. There are two options when this occurs. If P already contains a mapping from X→<O,t>, then emit a reference from <M,s>→<O,t>. Otherwise, emit the logical address of the sector-<M,s>—followed by the data for the sector. Also, add the mapping from X to <M,s> to P to allow for deduplicating on the fly to save bandwidth on the network.

In one embodiment, an optimization may be utilized. This optimization includes maintaining a list of recently sent physical addresses that map physical location X to <M,s>. This list may be used to do fine-grained deduplication on the fly. In option c above, first the list of recently-sent physical addresses may be checked. If it is discovered that <M2,s2> corresponds to physical address Y, and Y was recently sent as <M1,s1>, a reference may be sent from <M2,s2> to <M1,s1>. This step is purely optional, and the size of the list of recently-sent physical addresses can be as large or as small (including zero) as desired, with larger lists resulting in potentially less data being sent. The list of recently-sent addresses may be trimmed at any time, and any mappings may be removed. The use of table P may be omitted entirely if desired, with the only drawback being that fine grained duplicates might be sent multiple times over the network.

Another optimization is that adjacent references may be merged to save space. For example, if the references <M,s>→<O,t> and <M,s+1>→<O,t+1> were going to be sent, <M,s,2>→<O,t> could be sent instead, where the number 2 indicates the number of sectors covered by this mapping. This optimization may be used at any time. For example, if the mapping table indicates that a mapping applies for the next 16 sectors, a single mapping may be emitted that covers the next 16 sectors. This avoids having to emit 16 individual mappings and then merge them later.

It is noted that the transmission of data and mappings from source storage array 1230 to replica storage array 1210 may be performed using any suitable network mechanism. Similarly, acknowledgments may be sent using any suitable mechanism for acknowledgment, including the use of sequence numbers or implicit acknowledgment built into network protocols.

The above-described mechanisms may be used to back up data to a “slower” storage device such as disk or tape. This backup can proceed at full sequential write speeds, since all of the network traffic on the backup destination (replica storage array 1210) may be recorded to keep track of the medium extents that are stored there. Resolving references to data stored on disk or tape could be slow using this approach. However, since network traffic is being recorded, data does not need to be processed on replica storage array 1210. Instead, all of the packets that source storage array 1230 sends to replica storage array 1210 may be sequentially recorded, and minimal processing of metadata from the rblocks may be performed. Then, if a restore is needed, all of the replication sessions may be replayed to original storage array 1240 or to another storage array.

Restoring data to another storage array could be achieved by replaying all of the desired replication streams from backup storage, in order. For example, suppose that daily replication of data was performed for every day of the month of August, with the initial replication of the volume being sent on August 1st. If a user wanted to restore the system as it looked on August 15, all of the stored streams for August 1-15 may be replayed.

The above-described mechanisms may be used to back up data to the cloud. Cloud storage may be used to preserve copies of all of the rblocks that would have been sent from source storage array 1230 to replica storage array 1210, and the cloud-based system may acknowledge medium extents as it receives the rblocks that contain them. A unique identifier may be assigned to each rblock, allowing a cloud-based system to efficiently store all of the rblocks, retrieving them as necessary to perform a restore from backup.

The mechanisms described herein deal may easily handle complex replication topologies. For example, suppose an original storage site is in London, with replicas in New York and Boston. The original pushes its data out to New York first. When Boston decides to replicate a snapshot, it can contact either London or New York to discover what snapshots are available for replication. Boston can then retrieve data from either London, New York, or parts from both, making the choice based on factors such as available network capacity and available system capacity (how busy the systems are). In other words, a replica storage array can pull from any source storage array that has the desired medium extents, not just the original storage array.

For example, Boston could decide to start retrieving data for snapshot S from London, but stop in the middle and switch to New York if the network connection to London became slow or the system in London became more heavily loaded. The system in New York can associate the London medium identifiers with data it has stored locally, and resume the transfer. Similarly, the system in Boston might identify the snapshot at New York initially, perhaps picking the latest snapshot stored in New York, bypassing London entirely. Boston may also contact London to identify the latest snapshot, but conduct the entire transfer with the New York replica.

Additionally, replication may also be used to preload a system with various mediums. This can be done even if it is never intended to replicate the volumes that currently use the mediums that are being preloaded. For example, mediums could be preloaded that correspond to “gold master” images of virtual machines that are commonly cloned. Then, when a new clone of the gold master is created, future replications would go very quickly because they can refer to the mediums that the replica was preloaded with. This preloading could be done with the storage arrays in close proximity, with the replica storage array then moved to a remote location. Also, coarse-grained deduplication may be performed after the fact on the preloaded data, further optimizing replication to a preloaded replica.

Turning now to FIG. 13, one embodiment of a table 1300 for mapping original system ID to local medium ID. Table 1300 is an example of a table which may be utilized by replica storage array 1210 (of FIG. 12). Table 1300 includes mediums that originated on storage arrays 1230 and 1240 and which are also stored on replica storage array 1210. The IDs of these mediums may be different on replica storage array 1210 than the IDs of these mediums on their original storage arrays, and so replica storage array 1210 may utilize table 1300 to map IDs from the host storage array to its own IDs. It is noted that table 1300 is merely one example of a table which may be utilized to map medium IDs from an original storage array to a local storage array. In other embodiments, table 1300 may be organized differently. It is also noted that other systems may have other numbers of storage arrays, and in these embodiments, table 1300 may have other numbers of IDs of storage arrays which are mapped to the local storage array. It is further noted that table 1300 would be unnecessary if mediums have globally unique identifiers (GUIDs). In one embodiment, a GUID may include an indication of the system that originally generated the medium (e.g., the system ID may be the upper 32 bits of the medium ID).

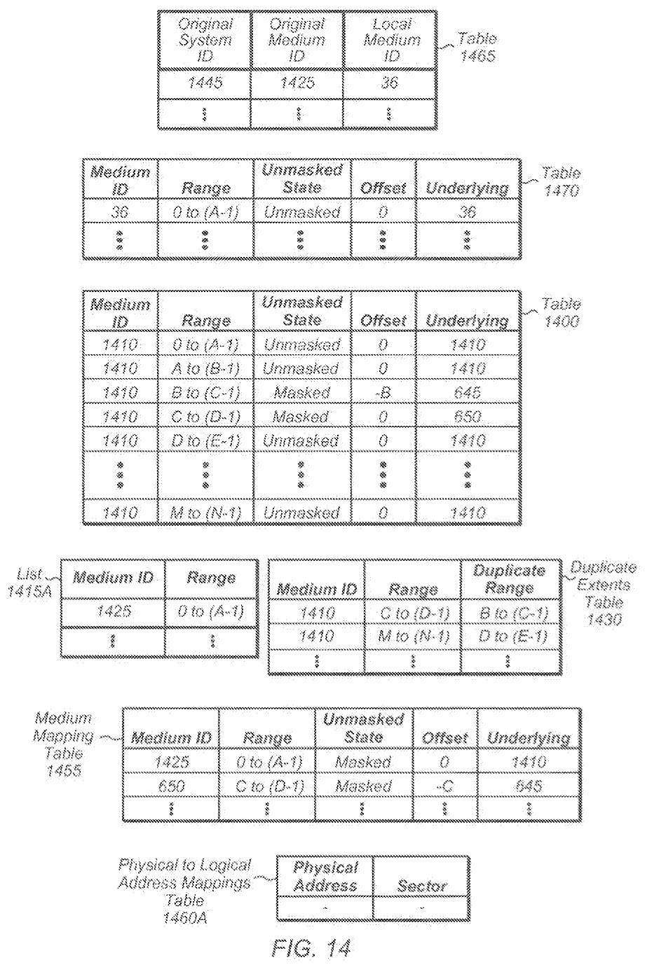

Referring now to FIG. 14, one embodiment of a set of tables and lists utilized during a replication process is shown. It may be assumed for the purposes of this discussion that medium 1410 has been selected for replication from an original storage array to a replica storage array. Table 1400 includes medium mapping table entries for medium 1410, and the entries in table 1400 for medium 1410 are intended to represent all of the entries corresponding to medium 1410 in the overall medium mapping table (not shown) of the original storage array. The original storage array may build table 1400 by traversing the overall medium mapping table for all entries assigned to medium 1410. Alternatively, the original storage array may not build table 1400 but may access the entries corresponding to medium 1410 from the overall medium mapping table. In that case, table 1400 is intended to illustrate the relevant medium mapping table entries for a medium 1410 selected for replication. The total range of medium 1410 is from 0 to (N−1), and medium 1410 may include any number of entries, depending on the embodiment.

Once medium 1410 has been selected for replication, the replica storage array may generate a list of medium extents stored on the replica storage array that originated from the original storage array. Table 1465 is intended to represent the mapping of external storage array medium IDs to local medium IDs on the replica storage array. For the purposes of this discussion, it may be assumed that the original storage array has an ID of 1445. As shown, there is a single entry for storage array 1445 in table 1465. This entry maps original medium ID 1425 from the original storage array to local medium ID 36 on the replica storage array. It is noted that a typical table may have a large number of entries corresponding to the original storage array. However, a single entry is shown in table 1465 for ease of illustration. The medium mapping table entry for medium ID 36 is shown in table 1470, which is intended to represent the medium mapping table of the replica storage array. Alternatively, in another embodiment, each medium may have a globally unique ID, and mediums may be identified by the same globally unique ID on different storage arrays. In this embodiment, the replica storage array may simply look for entries assigned to medium ID 1410 in its medium mapping table.

List 1415A is intended to represent an example of a list which may be sent from the replica storage array to the original storage array. The replica storage array may generate list 1415A by querying table 1465 which maps external storage array medium IDs to local medium IDs and compiling a list of medium extents corresponding to snapshots that originated on the original storage array. The replica storage array may send list 1415A to the original storage array, and then the original storage array may filter out all medium extents that do not correspond to medium 1410 and keep only the medium extents which map to extents within medium 1410. Any number of entries may be included in list 1415A, depending on the embodiment.

As part of the replication process, the original storage array may determine which extents of medium ID 1410 need to be sent to the replica storage array and which extents can be sent as references to extents already stored on the replica storage array. Extents which can be sent as references to already-existent extents may be identified using any of a variety of techniques. For instance, if a first extent in table 1400 corresponds to an extent stored in list 1415A, then a reference to the extent of list 1415A may be sent to the replica storage array rather than sending the first extent. Also, if duplicate extents are discovered in table 1400, then a reference from a second extent to a third extent may be sent to replica storage array rather than sending the second extent. The original storage array may utilize any of a variety of techniques for determining if there are duplicate extents in list 1425. Additionally, if duplicate extents are discovered in table 1400, then these duplicate extents may be deduplicated as a side benefit of the replication process.

For example, in one embodiment, the original storage array may build up a list of duplicate extents that have been detected within medium 1410. In order to build list 1430 of duplicate extents, the original storage array may traverse table 1400 entry by entry to determine the underlying mappings which exist for each extent. For example, the fourth entry of table 1400 may be traversed down to its underlying medium of 650. Then, a lookup of the overall medium mapping table 1455 may be performed for the specified range of medium ID 650 to determine if medium ID 650 has an underlying medium. The second entry of medium mapping table 1455 shows the corresponding entry for this specific range of medium ID 650. In this case, the range of C to (D−1) of medium ID 650 has an underlying medium of 645 at an offset of 0 after applying the offset of −C from the entry in table 1455. Therefore, the extent corresponding to the fourth entry of table 1400 is a duplicate extent since it maps to the same extent as the third entry of table 1400. Accordingly, an entry may be recorded in duplicate extents table 1430 corresponding to the fourth and third entries of table 1400. Additionally, after detecting these duplicate extents, the medium mapping table entry for range C to (D−1) of medium ID 1410 may be collapsed. Although not shown in FIG. 14, the corresponding entry of the medium mapping table may be modified to point to range 0 to (A−1) of medium ID 645 rather than having it point to range C to (D−1) of medium ID 650. This helps create a shortcut for the medium mapping table, which is an additional side benefit of performing the replication process for medium ID 1410.

Additionally, duplicate extents table 1430 may keep track of duplicate blocks within medium ID 1410 that map to the same physical address. When separate blocks that point to the same physical address are detected, an entry may be stored in duplicate extents table 1430 for the duplicate pair of blocks. Duplicate blocks may be detected by performing a lookup of the address translation table (not shown) for each block within medium 1410 and compiling a list of the physical pointer values returned from each of the lookups. For each pair of matching physical pointer values which are found, an entry may be recorded in duplicate extents table 1430. It may be assumed for the purposes of this discussion that the block corresponding to medium ID 1410 for range D to (E−1) is a duplicate block which has the same physical pointer value as the block corresponding to medium 1410 for range M to (N−1). Therefore, the second entry of duplicate extents table 1430 stores the mapping of these duplicate blocks.

Also, a physical to logical address mappings table 1460A may be created to store physical to logical mappings of data that is sent to the replica storage array. The physical to logical address mappings table 1460A may be initialized to be empty and mappings may be added after the actual data is sent to the replica storage array. Once duplicate extents table 1430 and physical to logical address mappings table 1460A have been created, the original storage array may traverse table 1400 entry by entry and determine for each entry if the actual data needs to be sent or if a reference to an already-existent extent on the replica storage array may be sent.

While traversing table 1400 for each sector of medium ID 1410, multiple conditions may be checked for each sector. First, it may be determined if the sector of medium ID 1410 maps to a sector in list 1415A. If the sector maps to one of the sectors indicated by list 1415A, then a reference to this sector from list 1415A may be sent to the replica storage array. For example, for the first entry of table 1400, a lookup of list 1415A will hit for this sector of medium ID 1425 corresponding to range 0-(A−1). As can be seen from the first entry of medium mapping table 1455, range 0 to (A−1) of medium ID 1425 maps to range 0 to (A−1) of medium ID 1410. Therefore, rather than sending the data for this sector to the replica storage array, a reference to the sector which already exists on the replica storage array may be sent.

After checking for the first condition and determining the first condition is not met, a second condition may be checked for a given sector of medium ID 1410. The second condition includes checking if the sector of medium ID 1410 maps to a sector in duplicate extents table 1430. If the sector of medium ID 1410 already maps to a sector in duplicate extents table 1430 which has already been sent to and acknowledged by the replica storage array, then a reference to the duplicate sector may be sent to the replica storage array. For example, for the fourth entry of table 1400 corresponding to range C to (D−1) of medium 1410, an entry exists in duplicate extents table 1430 for this range of medium 1410. Therefore, a reference to the range listed in the duplicate range column of table 1430, or range B-(C−1), may be sent to the replica storage array rather than sending the actual data. Similarly, for the last entry in table 1400 corresponding to range M-(N−1), a reference to range D-(E−1) (as indicated by the second entry in table 1430) may be sent to the replica storage array rather than sending the actual data of range M-(N−1).

If the second condition is not met, then the actual physical mapping that contains the data for the sector may be located by performing a lookup of the address translation table. Once the specific physical mapping has been located, then a lookup of physical to logical address mappings table 1460A may be performed to determine if the physical mapping is already stored in table 1460A. If the physical mapping is already stored in table 1460A, then a reference to the sector indicated by the corresponding entry of table 1460A may be sent to the replica storage array. In one embodiment, the reference may be in the form of <medium ID, range>. If the physical mapping is not already stored in table 1460A, then the actual data for the sector may be sent to the replica storage array and then this physical mapping may be added to table 1460A.

After the replica storage array receives a reference or data from the original storage array, the replica storage array may send an acknowledgement to the original storage array. In some cases, the replica storage array may batch acknowledgements and send multiple acknowledgements at a time rather than sending each acknowledgement individually.

Alternatively, the replica storage array may send an acknowledgement in the form of “received all data up to medium X, offset Y”. When the original storage array receives an acknowledgment for a given extent, the original storage array may then add the given extent to list 1415A.

It is to be understood that only a portion of each of tables and lists 1400, 1415, 1430, and 1455 are shown, with the portion being relevant to the above discussion. It is noted that each of the tables and lists of FIG. 14 may be implemented in a variety of ways with additional information than what is shown and/or with more entries than are shown. It is also noted that any suitable data structure may be used to store the data shown in the tables and lists of FIG. 14.

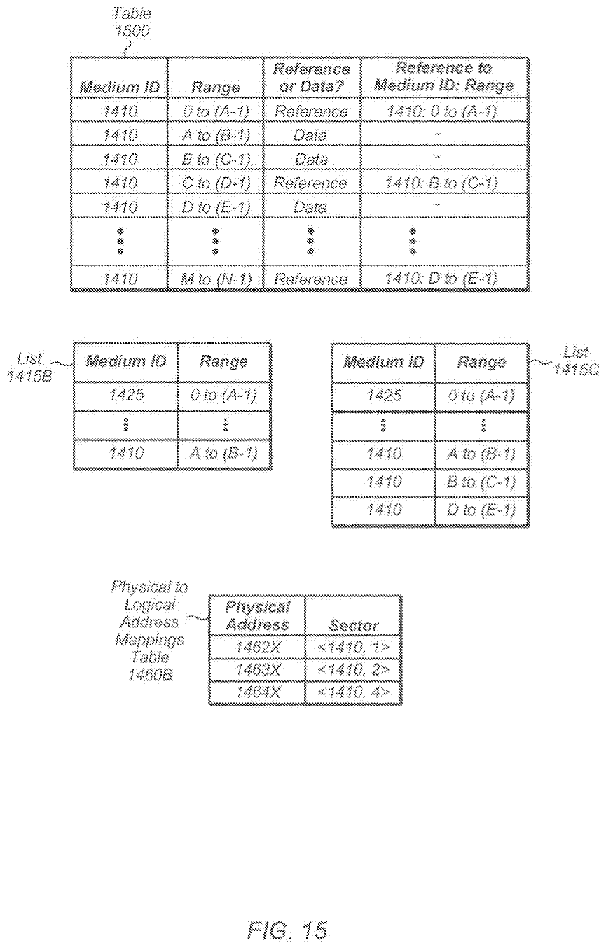

Turning now to FIG. 15, one embodiment of a set of tables and lists for use in the replication process is shown. The tables and lists shown in FIG. 15 and the following discussion is a continuation of the replication example described in FIG. 14. In one embodiment, the original storage array may generate table 1500 prior to replicating medium ID 1410 to keep track of which extents need to be sent as data and which extents should be sent as references to other extents. Alternatively, the original storage array may generate table 1500 incrementally as replication proceeds. As shown in FIG. 15, table 1500 is generated based on the information contained in the tables shown in FIG. 14 for medium ID 1410. Using the information stored in table 1400, list 1415A, and duplicate extents table 1430, the original storage array may generate table 1500 and store an indication for each extent as to whether it should be sent as a reference or as data.

For example, the first extent of medium ID 1410 for range 0 to (A−1), corresponding to the first entry in table 1500, may be sent as a reference since this extent is already stored (as range 0 to (A−1) of medium ID 1425) on the replica storage array as indicated by the first entry of list 1415A. The second extent of medium ID 1410 may be sent as data since this extent does not map to an entry in list 1415A or duplicate extents table 1430. After the original storage array receives an acknowledgement from the replica storage array that is has received the data corresponding to the second extent of medium ID 1410, the original storage array may add this extent to list 1415 since this extent is now stored on the replica storage array. List 1415B represents list 1415 at the point in time after the original storage array receives the acknowledgement from the replica storage array regarding the second extent of medium ID 1410. Similarly, anytime an acknowledgement is sent by the replica storage array and received by the original storage array regarding a given extent, the given extent may be added to list 1415 at that time.

The third extent of medium ID 1410 may be sent as data since this extent does not map to an entry in list 1415B or duplicate extents table 1430. The fourth extent of medium ID 1410 may be sent as a reference to the third extent of medium ID 1410 since the fourth extent is the same as third extent as indicated by duplicate extents table 1430. The fifth extent of medium ID 1410 may be sent as data since this extent does not map to an entry in list 1415B or duplicate extents table 1430. Any number of extents after the fifth extent may be sent in a similar manner. Finally, the last extent of medium ID 1410 may be sent as a reference since this extent is the same as fifth extent as indicated by duplicate extents table 1430. After acknowledgements are received by the original storage array for the third and fifth extents of medium ID 1410, these extents may be added to list 1415. List 1415C represents list 1415 after these acknowledgements have been received by the original storage array.

Additionally, physical to logical address mappings table 1460 may be updated after the data for the extents of the second, third, and fourth entries is sent to the replica storage array. As shown in table 1460B, the physical address of the second entry (sector <1410, 1>) is represented as 1462X, the physical address of the third entry (sector <1410, 2>) is represented as 1463X, and the physical address of the fourth entry (sector <1410, 3>) is represented as 1464X.

A lookup of physical to logical address mappings table 1460B may be performed for subsequent entries of table 1500 prior to sending data to the replica storage array. Alternatively, in another embodiment, a list of recently sent physical addresses may be maintained. The size of the list of recently sent physical addresses may be as large or as small as desired, depending on the embodiment. If it is discovered that the address for a sector is located in table 1460B (or the list of recently sent physical addresses), then a reference to the previously sent sector may be sent to the replica storage array rather than the corresponding data. Also, if an address for a sector is already stored in table 1460B, fine-grained deduplication may be performed on these two sectors since they both point to the same physical address. This allows for an additional side benefit of the replication process of enabling fine-grained deduplication to be performed on the fly.

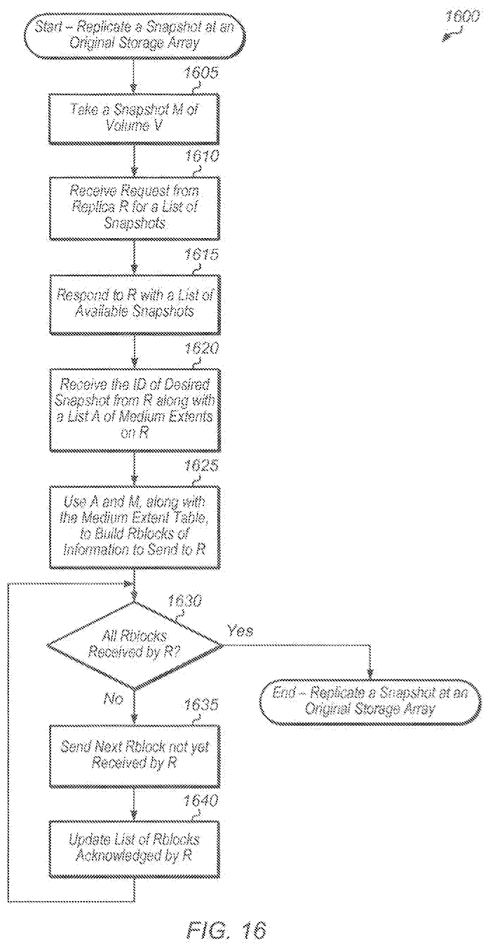

Referring now to FIG. 16, one embodiment of a method 1600 for replicating a snapshot at an original storage array is shown. The components embodied in system 100 described above (e.g., storage controller 110) may generally operate in accordance with method 1600. In addition, the steps in this embodiment are shown in sequential order. However, some steps may occur in a different order than shown, some steps may be performed concurrently, some steps may be combined with other steps, and some steps may be absent in another embodiment.

An original storage array may take a snapshot ‘M’ of a volume ‘V’ (block 1605). It is noted that block 1605 may only be performed if needed. For example, if M is already stable, then a snapshot does not need to be taken. Next, the original storage array may receive a request from a replica storage array ‘R’ for a list of snapshots (block 1610). The original storage array may respond to R with a list of available snapshots including M (block 1615). The original storage array may then receive an ID of a desired snapshot from R along with a list ‘A’ of medium extents that are already stored on R (block 1620). The original storage array may then use A and M, along with the medium extent table, to build rblocks of information to send to R (block 1625).

The original storage array may check to determine if all rblocks have been received by R (conditional block 1630). If all rblocks have been received by R (conditional block 1630, “yes” leg), then method 1600 is finished. If not all of the rblocks have been received by R (conditional block 1630, “no” leg), then the original storage array may send the next rblock not yet received by R (block 1635). Then, the original storage array may update the list of rblocks acknowledged by R (block 1640). After block 1645, method 1600 may return to block 1630. It is noted that replica storage array ‘R’ may also receive rblocks from one or more source storage arrays other than the original storage array. It is noted that the original storage array may retransmit rblocks which are not acknowledged.

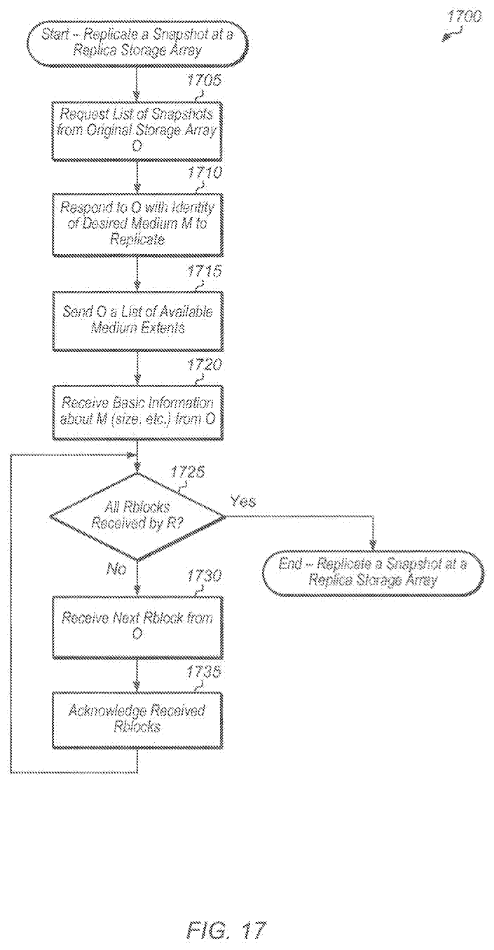

Turning now to FIG. 17, one embodiment of a method 1700 for replicating a snapshot at a replica storage array is shown. The components embodied in system 100 described above (e.g., replica storage array 160) may generally operate in accordance with method 1700. In addition, the steps in this embodiment are shown in sequential order. However, some steps may occur in a different order than shown, some steps may be performed concurrently, some steps may be combined with other steps, and some steps may be absent in another embodiment.

The replica storage array ‘R’ may request a list of snapshots from the original storage array ‘O’ (block 1705). After receiving the list of snapshots, R may respond to O with the identity of the desired medium ‘M’ to replicate (block 1710). R may also send O a list of available medium extents which are already stored on R (block 1715). R may receive basic information (e.g., size) about the desired medium ‘M’ from O (block 1720).

R may determine if it has received all rblocks of M (conditional block 1725). If R has received all rblocks of M (conditional block 1725, “yes” leg), then method 1700 may be finished (block 1720). If R has not received all rblocks of M (conditional block 1725, “no” leg), then R may receive the next rblock from O or from another source storage array (block 1730). Then, R may acknowledge the received rblock (block 1735). Alternatively, R may perform bulk acknowledgements. After block 1735, method 1700 may return to block 1725.

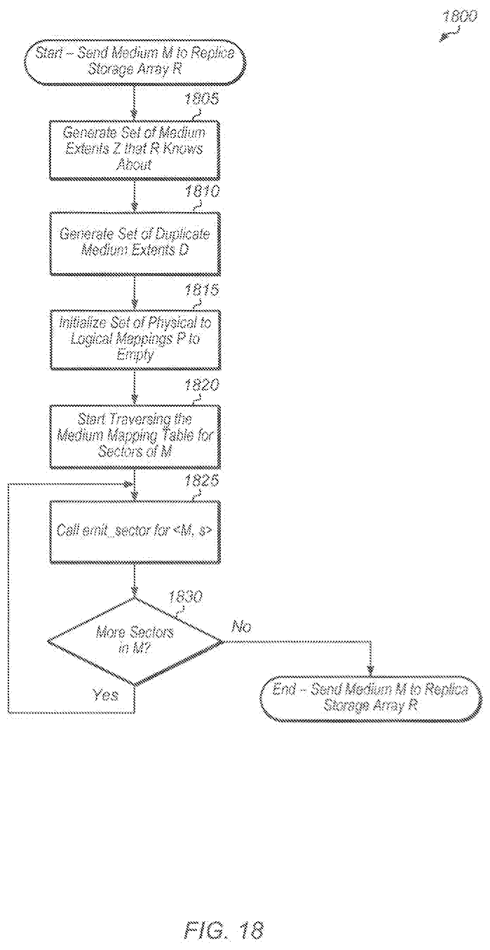

Referring now to FIG. 18, one embodiment of a method 1800 for sending a medium ‘M’ to a replica storage array ‘R’ is shown. The components embodied in system 100 described above (e.g., storage controller 110) may generally operate in accordance with method 1800. In addition, the steps in this embodiment are shown in sequential order. However, some steps may occur in a different order than shown, some steps may be performed concurrently, some steps may be combined with other steps, and some steps may be absent in another embodiment.

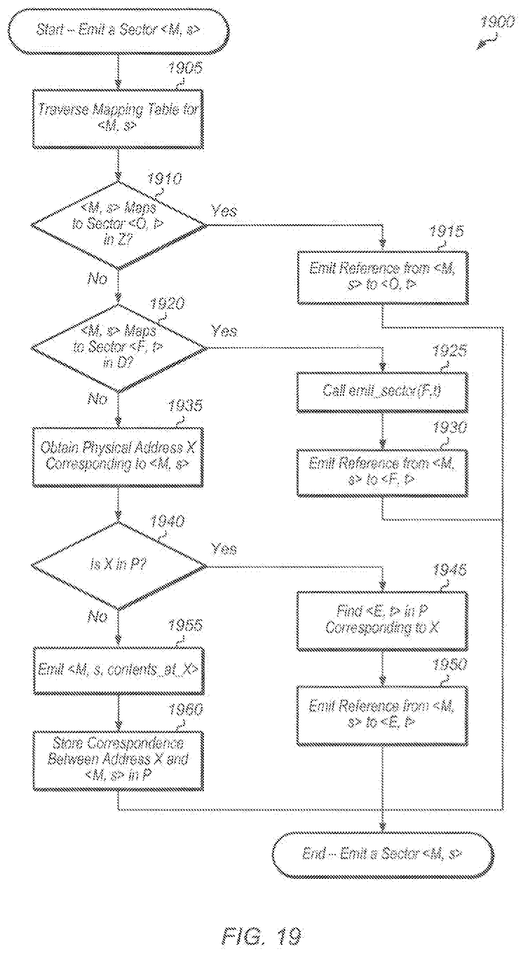

The original storage array ‘O’ may generate a set of extents ‘Z’ that the replica storage array ‘R’ knows about (block 1805). A set of duplicate medium extents ‘D’ of the desired medium ‘M’ may also be generated (block 1810). This set D may include pairs of extents which map to the same underlying extent as well as pairs of extents that map to the same physical pointer value. Also, a set of physical to logical mappings ‘P’ may be initialized to empty (block 1815). Next, O may start traversing the medium mapping table for sectors of M (block 1820). When selecting a sector 's′ of the medium mapping table for medium ‘M’, O may generate a call to emit_sector for <M, s> (block 1825). The implementation of emit_sector is described below in method 1900 (of FIG. 19) in accordance with one embodiment. In one embodiment, emit_sector may be implemented using a software routine. In another embodiment, emit_sector may be implemented in logic. In a further embodiment, any combination of software and/or hardware may be utilized to implement emit_sector.

After block 1825, O may determine if there are more sectors in ‘M’ (conditional block 1830). If there are more sectors in ‘M’ (conditional block 1830, “yes” leg), then a call to emit_sector for <M, s> may be generated for the next sector (block 1825). If there are no more sectors in ‘M’ (conditional block 1830, “no” leg), then method 1800 may end.

Referring now to FIG. 19, one embodiment of a method 1900 for emitting a sector <M, s> is shown. The components embodied in system 100 described above (e.g., storage controller 110) may generally operate in accordance with method 1900. In addition, the steps in this embodiment are shown in sequential order. However, some steps may occur in a different order than shown, some steps may be performed concurrently, some steps may be combined with other steps, and some steps may be absent in another embodiment.

The original storage array ‘O’ may traverse the mapping table for <M, s> (block 1905). If <M, s> maps to sector <O, t> in Z (conditional block 1910, “yes” leg), then the reference from <M, s> to <O, t> may be emitted (block 1915). It is noted that ‘Z’ is the set of extents that the replica storage array ‘R’ already stores and which originated from O, and R may send a list of the set of extents Z to O. After block 1915, method 1900 may end.

If <M, s> does not map to sector <O, t> in Z (conditional block 1910, “no” leg), then it may be determined if <M, s> maps to sector <F, t> in duplicate medium extents ‘D’ (conditional block 1920). If <M, s> maps to sector <F, t> in D (conditional block 1920, “yes” leg), then a call to emit_sector for <F, t> may be generated (block 1925). After block 1925, the reference from <M, s> to <F, t> may be emitted (block 1930). After block 1930, method 1900 may end.

If <M, s> does not map to a sector <F, t> in D (conditional block 1920, “no” leg), then the physical address ‘X’ corresponding to <M, s> may be obtained from the address translation table (block 1935). Next, it may be determined if X is in the physical to logical mappings ‘P’ (conditional block 1940). The physical to logical mappings list ‘P’ is a list of physical to logical mappings corresponding to data that has already been sent to R. If X is in the physical to logical mappings ‘P’ (conditional block 1940, “yes” leg), then the sector <E, t> in P corresponding to X may be found (block 1945). Next, the reference from <M, s> to <E, t> may be emitted (block 1950). After block 1950, method 1900 may end.

If X is not in the physical to logical mappings ‘P’ (conditional block 1940, “no” leg), then the sector data corresponding to <M, s, contents_at_X> may be emitted (block 1955). After block 1955, the correspondence between address X and <M, s> may be stored in P (block 1960). After block 1960, method 1900 may end.

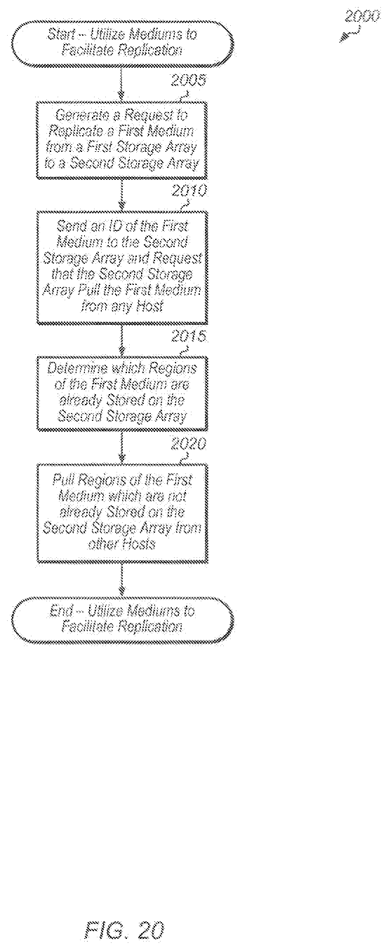

Referring now to FIG. 20, one embodiment of a method 2000 for utilizing mediums to facilitate replication is shown. The components embodied in system 100 described above (e.g., storage controller 110) may generally operate in accordance with method 2000. In addition, the steps in this embodiment are shown in sequential order. However, some steps may occur in a different order than shown, some steps may be performed concurrently, some steps may be combined with other steps, and some steps may be absent in another embodiment.

In one embodiment, a request to replicate a first medium from a first storage array to a second storage array may be generated (block 2005). The request may be generated by the first storage array or the second storage array, depending on the embodiment. It may be assumed for the purposes of this discussion that the first medium is already read-only. If the first medium is not read-only, then a snapshot of the first medium may be taken to make the first medium stable.

Next, in response to detecting this request, the first storage array may send an identifier (ID) of the first medium to the second storage array and request that the second storage array pull the first medium (or portions thereof) from any host to which it has access (block 2010). Alternatively, the first storage array may notify the second storage array that the first storage array will push the first medium to the second storage array. In one embodiment, the first medium may be identified based only by this medium ID. In one embodiment, the ID of the first medium may be a numeric value such as an integer, although the ID may be stored as a binary number. Also, in some embodiments, the age of a given medium relative to another medium may be determined based on a comparison of the IDs of these mediums. For example, for two mediums with IDs 2017 and 2019, medium ID 2017 has a lower ID than medium ID 2019, so therefore, it may be recognized that medium ID 2017 is older (i.e., was created prior to) than medium ID 2019.

After receiving the ID of the first medium and the request to pull the first medium from any host, it may be determined which regions of the first medium are already stored on the second storage array (block 2015). In one embodiment, the second storage array may identify regions which originated from the first storage array and which are already stored on the second storage array, and then the second storage array may send a list of these regions to the first storage array. The first storage array may then use this list to determine which regions of the first medium are not already stored on the second storage array. Then, the first storage array may send a list of these regions to the second storage array. In other embodiments, other techniques for determining which regions of the first medium are not already stored on the second storage array may be utilized.

After block 2015, the second storage array may pull regions of the first medium which are not already stored on the second storage array from other hosts (block 2020). For example, the second storage array may be connected to a third storage array, and the second storage array may send a list of regions it needs to the third storage array and request that the third storage array send any regions from the list which are stored on the third storage array. It is noted that in another embodiment, the above-described steps of method 2000 may be utilized for replicating the first medium from the first storage array to a cloud service rather than to the second storage array.

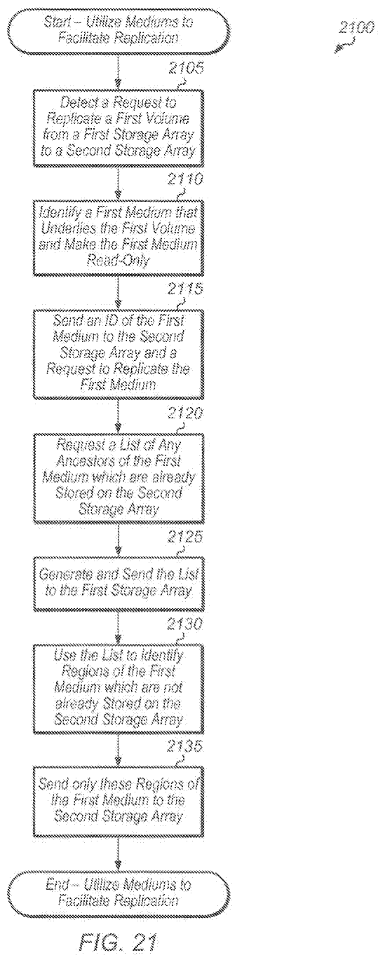

Referring now to FIG. 21, another embodiment of a method 2100 for utilizing mediums to facilitate replication is shown. The components embodied in system 100 described above (e.g., storage controller 110) may generally operate in accordance with method 2100. In addition, the steps in this embodiment are shown in sequential order. However, some steps may occur in a different order than shown, some steps may be performed concurrently, some steps may be combined with other steps, and some steps may be absent in another embodiment.

A request to replicate a first volume from a first storage array to a second storage array may be detected (block 2105). In one embodiment, the first storage array may decide to replicate the first volume to the second storage array. Alternatively, in another embodiment, the second storage array may request for the first volume to be replicated. In response to detecting the request to replicate the first volume, the first storage array may identify a first medium that underlies the first volume and make the first medium read-only (block 2110). In one embodiment, the first medium may be made read-only by taking a snapshot of the first volume. Next, the first storage array may send an identifier (ID) of the first medium to the second storage array along with a request to replicate the first medium (block 2115). In various embodiments, the request to replicate the first medium may be implicit or it may be an actual command. In some cases, the request to replicate the first medium may indicate if the first storage array will be pushing data to the second storage array, or if the second storage array will be pulling data from the first storage array and any other storage arrays. It may be assumed for the purposes of this discussion that the first storage array will be pushing data to the second storage array during the replication process. However, in other embodiments, the second storage array may pull data from the first storage array and other storage arrays.

The first storage array may request a list of any ancestors of the first medium which are already stored on the second storage array (block 2120). Alternatively, the first storage array may request a list of any read-only mediums which are older than the first medium. In one embodiment, the second storage array may identify mediums older than the first medium by selecting medium IDs which are lower than the first medium ID. For example, if the first medium ID is 1520, then the second storage array may identify all read-only mediums with IDs lower than 1520 which are stored on the second storage array. In a further embodiment, the first storage array may request an ID of the youngest read-only medium stored on the second storage array which is older than the first medium. If the first medium ID is 1520, then the second storage array would search for the highest medium ID which is less than 1520 and then send this ID to the first storage array. This ID may be 1519, 1518, 1517, or whichever medium ID is below and closest to 1520 and is stored in a read-only state on the second storage array.

In a further embodiment, the first storage array may request for the second storage array to identify the youngest ancestor of the first medium which is stored on the second storage array. For example, if the first medium ID is 2260, and if there are four ancestors of the first medium stored on the second storage array which are medium IDs 2255, 2240, 2230, and 2225, then the second storage array may identify medium ID 2255 as the youngest ancestor of medium ID 2260. It may be assumed for the purposes of this discussion that all ancestors of the first medium are read-only. In a still further embodiment, the first storage array may request for the second storage array to identify the youngest medium stored on the second storage array. For example, in one scenario, the second storage array may only store snapshots from a single volume, and so in that scenario, the most recent snapshot stored on the second storage array will be the youngest ancestor of the first medium.

Next, in response to receiving the request for a list of ancestors of the first medium which are already stored on the second storage array, the second storage array may generate and send the list to the first storage array (block 2125). In one embodiment, the second storage array may be able to determine the ancestors of the first medium after receiving only the ID of the first medium. For example, the second storage array may already know which volume is associated with the first medium (e.g., if the second storage array generated the replication request for the first volume), and the second storage array may have received previous snapshots associated with the first volume. Therefore, the second storage array may identify all previous snapshots associated with the first volume as ancestors of the first medium. In another embodiment, the first storage array may send an ID of each ancestor of the first medium to the second storage array along with the request in block 2120. Alternatively, in a further embodiment, rather than requesting a list of ancestors, the first storage array may request a list of any read-only mediums stored on the second storage array which are older (i.e., have lower ID numbers) than the first medium. It is noted that block 2120 may be omitted in some embodiments, such that the second storage array may generate and send a list of first medium ancestors (or the other lists described above) to the first storage array automatically in response to receiving a request to replicate the first medium.

In response to receiving the list of ancestors of the first medium which are already stored on the second storage array, the first storage array may use the list to identify regions of the first medium which are not already stored on the second storage array (block 2130). Then, the first storage array may send only these regions of the first medium to the second storage array (block 2135). It is noted that in another embodiment, the above-described steps of method 2100 may be utilized for replicating the first volume from the first storage array to a cloud service rather than to the second storage array.

It is noted that in the above description, it is assumed that when a medium ID is generated for a new medium, the most recently generated medium ID is incremented by one to generate the new medium ID. For example, medium ID 2310 will be followed by 2311, 2312, and so on for new mediums which are created. Alternatively, the medium ID may be incremented by two (or other numbers), such that medium ID 2310 will be followed by 2312, 2314, and so on. However, it is noted that in other embodiments, medium IDs may be decremented when new mediums are created. For example, the first medium which is created may get the maximum possible ID, and then for subsequent mediums, the ID may be decremented. In these other embodiments, the above described techniques may be modified to account for this by recognizing that lower IDs represent younger mediums and higher IDs represent older mediums.

FIG. 22A is a perspective view of a storage cluster 161, with multiple storage nodes 150 and internal solid-state memory coupled to each storage node to provide network attached storage or storage area network, in accordance with some embodiments. A network attached storage, storage area network, or a storage cluster, or other storage memory, could include one or more storage clusters 161, each having one or more storage nodes 150, in a flexible and reconfigurable arrangement of both the physical components and the amount of storage memory provided thereby. The storage cluster 161 is designed to fit in a rack, and one or more racks can be set up and populated as desired for the storage memory. The storage cluster 161 has a chassis 138 having multiple slots 142. It should be appreciated that chassis 138 may be referred to as a housing, enclosure, or rack unit. In one embodiment, the chassis 138 has fourteen slots 142, although other numbers of slots are readily devised. For example, some embodiments have four slots, eight slots, sixteen slots, thirty-two slots, or other suitable number of slots. Each slot 142 can accommodate one storage node 150 in some embodiments. Chassis 138 includes flaps 148 that can be utilized to mount the chassis 138 on a rack. Fans 144 provide air circulation for cooling of the storage nodes 150 and components thereof, although other cooling components could be used, or an embodiment could be devised without cooling components. A switch fabric 146 couples storage nodes 150 within chassis 138 together and to a network for communication to the memory. In an embodiment depicted in herein, the slots 142 to the left of the switch fabric 146 and fans 144 are shown occupied by storage nodes 150, while the slots 142 to the right of the switch fabric 146 and fans 144 are empty and available for insertion of storage node 150 for illustrative purposes. This configuration is one example, and one or more storage nodes 150 could occupy the slots 142 in various further arrangements. The storage node arrangements need not be sequential or adjacent in some embodiments. Storage nodes 150 are hot pluggable, meaning that a storage node 150 can be inserted into a slot 142 in the chassis 138, or removed from a slot 142, without stopping or powering down the system. Upon insertion or removal of storage node 150 from slot 142, the system automatically reconfigures in order to recognize and adapt to the change. Reconfiguration, in some embodiments, includes restoring redundancy and/or rebalancing data or load.

Each storage node 150 can have multiple components. In the embodiment shown here, the storage node 150 includes a printed circuit board 159 populated by a CPU 156, i.e., processor, a memory 154 coupled to the CPU 156, and a non-volatile solid state storage 152 coupled to the CPU 156, although other mountings and/or components could be used in further embodiments. The memory 154 has instructions which are executed by the CPU 156 and/or data operated on by the CPU 156. As further explained below, the non-volatile solid state storage 152 includes flash or, in further embodiments, other types of solid-state memory.

Referring to FIG. 22A, storage cluster 161 is scalable, meaning that storage capacity with non-uniform storage sizes is readily added, as described above. One or more storage nodes 150 can be plugged into or removed from each chassis and the storage cluster self-configures in some embodiments. Plug-in storage nodes 150, whether installed in a chassis as delivered or later added, can have different sizes. For example, in one embodiment a storage node 150 can have any multiple of 4 TB, e.g., 8 TB, 12 TB, 16 TB, 32 TB, etc. In further embodiments, a storage node 150 could have any multiple of other storage amounts or capacities. Storage capacity of each storage node 150 is broadcast, and influences decisions of how to stripe the data. For maximum storage efficiency, an embodiment can self-configure as wide as possible in the stripe, subject to a predetermined requirement of continued operation with loss of up to one, or up to two, non-volatile solid state storage 152 units or storage nodes 150 within the chassis.

FIG. 22B is a block diagram showing a communications interconnect 173 and power distribution bus 172 coupling multiple storage nodes 150. Referring back to FIG. 22A, the communications interconnect 173 can be included in or implemented with the switch fabric 146 in some embodiments. Where multiple storage clusters 161 occupy a rack, the communications interconnect 173 can be included in or implemented with a top of rack switch, in some embodiments. As illustrated in FIG. 22B, storage cluster 161 is enclosed within a single chassis 138. External port 176 is coupled to storage nodes 150 through communications interconnect 173, while external port 174 is coupled directly to a storage node. External power port 178 is coupled to power distribution bus 172. Storage nodes 150 may include varying amounts and differing capacities of non-volatile solid state storage 152 as described with reference to FIG. 22A. In addition, one or more storage nodes 150 may be a compute only storage node as illustrated in FIG. 22B. Authorities 168 are implemented on the non-volatile solid state storage 152, for example as lists or other data structures stored in memory. In some embodiments the authorities are stored within the non-volatile solid state storage 152 and supported by software executing on a controller or other processor of the non-volatile solid state storage 152. In a further embodiment, authorities 168 are implemented on the storage nodes 150, for example as lists or other data structures stored in the memory 154 and supported by software executing on the CPU 156 of the storage node 150. Authorities 168 control how and where data is stored in the non-volatile solid state storage 152 in some embodiments. This control assists in determining which type of erasure coding scheme is applied to the data, and which storage nodes 150 have which portions of the data. Each authority 168 may be assigned to a non-volatile solid state storage 152. Each authority may control a range of inode numbers, segment numbers, or other data identifiers which are assigned to data by a file system, by the storage nodes 150, or by the non-volatile solid state storage 152, in various embodiments.

Every piece of data, and every piece of metadata, has redundancy in the system in some embodiments. In addition, every piece of data and every piece of metadata has an owner, which may be referred to as an authority. If that authority is unreachable, for example through failure of a storage node, there is a plan of succession for how to find that data or that metadata. In various embodiments, there are redundant copies of authorities 168. Authorities 168 have a relationship to storage nodes 150 and non-volatile solid state storage 152 in some embodiments. Each authority 168, covering a range of data segment numbers or other identifiers of the data, may be assigned to a specific non-volatile solid state storage 152. In some embodiments the authorities 168 for all of such ranges are distributed over the non-volatile solid state storage 152 of a storage cluster. Each storage node 150 has a network port that provides access to the non-volatile solid state storage(s) 152 of that storage node 150. Data can be stored in a segment, which is associated with a segment number and that segment number is an indirection for a configuration of a RAID (redundant array of independent disks) stripe in some embodiments. The assignment and use of the authorities 168 thus establishes an indirection to data. Indirection may be referred to as the ability to reference data indirectly, in this case via an authority 168, in accordance with some embodiments. A segment identifies a set of non-volatile solid state storage 152 and a local identifier into the set of non-volatile solid state storage 152 that may contain data. In some embodiments, the local identifier is an offset into the device and may be reused sequentially by multiple segments. In other embodiments the local identifier is unique for a specific segment and never reused. The offsets in the non-volatile solid state storage 152 are applied to locating data for writing to or reading from the non-volatile solid state storage 152 (in the form of a RAID stripe). Data is striped across multiple units of non-volatile solid state storage 152, which may include or be different from the non-volatile solid state storage 152 having the authority 168 for a particular data segment.

If there is a change in where a particular segment of data is located, e.g., during a data move or a data reconstruction, the authority 168 for that data segment should be consulted, at that non-volatile solid state storage 152 or storage node 150 having that authority 168. In order to locate a particular piece of data, embodiments calculate a hash value for a data segment or apply an inode number or a data segment number. The output of this operation points to a non-volatile solid state storage 152 having the authority 168 for that particular piece of data. In some embodiments there are two stages to this operation. The first stage maps an entity identifier (ID), e.g., a segment number, inode number, or directory number to an authority identifier. This mapping may include a calculation such as a hash or a bit mask. The second stage is mapping the authority identifier to a particular non-volatile solid state storage 152, which may be done through an explicit mapping. The operation is repeatable, so that when the calculation is performed, the result of the calculation repeatably and reliably points to a particular non-volatile solid state storage 152 having that authority 168. The operation may include the set of reachable storage nodes as input. If the set of reachable non-volatile solid state storage units changes the optimal set changes. In some embodiments, the persisted value is the current assignment (which is always true) and the calculated value is the target assignment the cluster will attempt to reconfigure towards. This calculation may be used to determine the optimal non-volatile solid state storage 152 for an authority in the presence of a set of non-volatile solid state storage 152 that are reachable and constitute the same cluster. The calculation also determines an ordered set of peer non-volatile solid state storage 152 that will also record the authority to non-volatile solid state storage mapping so that the authority may be determined even if the assigned non-volatile solid state storage is unreachable. A duplicate or substitute authority 168 may be consulted if a specific authority 168 is unavailable in some embodiments.

With reference to FIGS. 22A and 22B, two of the many tasks of the CPU 156 on a storage node 150 are to break up write data, and reassemble read data. When the system has determined that data is to be written, the authority 168 for that data is located as above. When the segment ID for data is already determined the request to write is forwarded to the non-volatile solid state storage 152 currently determined to be the host of the authority 168 determined from the segment. The host CPU 156 of the storage node 150, on which the non-volatile solid state storage 152 and corresponding authority 168 reside, then breaks up or shards the data and transmits the data out to various non-volatile solid state storage 152. The transmitted data is written as a data stripe in accordance with an erasure coding scheme. In some embodiments, data is requested to be pulled, and in other embodiments, data is pushed. In reverse, when data is read, the authority 168 for the segment ID containing the data is located as described above. The host CPU 156 of the storage node 150 on which the non-volatile solid state storage 152 and corresponding authority 168 reside requests the data from the non-volatile solid state storage and corresponding storage nodes pointed to by the authority. In some embodiments the data is read from flash storage as a data stripe. The host CPU 156 of storage node 150 then reassembles the read data, correcting any errors (if present) according to the appropriate erasure coding scheme, and forwards the reassembled data to the network. In further embodiments, some or all of these tasks can be handled in the non-volatile solid state storage 152. In some embodiments, the segment host requests the data be sent to storage node 150 by requesting pages from storage and then sending the data to the storage node making the original request.

In embodiments, authorities 168 operate to determine how operations will proceed against particular logical elements. Each of the logical elements may be operated on through a particular authority across a plurality of storage controllers of a storage system. The authorities 168 may communicate with the plurality of storage controllers so that the plurality of storage controllers collectively perform operations against those particular logical elements.

In embodiments, logical elements could be, for example, files, directories, object buckets, individual objects, delineated parts of files or objects, other forms of key-value pair databases, or tables. In embodiments, performing an operation can involve, for example, ensuring consistency, structural integrity, and/or recoverability with other operations against the same logical element, reading metadata and data associated with that logical element, determining what data should be written durably into the storage system to persist any changes for the operation, or where metadata and data can be determined to be stored across modular storage devices attached to a plurality of the storage controllers in the storage system.

In some embodiments the operations are token based transactions to efficiently communicate within a distributed system. Each transaction may be accompanied by or associated with a token, which gives permission to execute the transaction. The authorities 168 are able to maintain a pre-transaction state of the system until completion of the operation in some embodiments. The token based communication may be accomplished without a global lock across the system, and also enables restart of an operation in case of a disruption or other failure.

In some systems, for example in UNIX-style file systems, data is handled with an index node or inode, which specifies a data structure that represents an object in a file system. The object could be a file or a directory, for example. Metadata may accompany the object, as attributes such as permission data and a creation timestamp, among other attributes. A segment number could be assigned to all or a portion of such an object in a file system. In other systems, data segments are handled with a segment number assigned elsewhere. For purposes of discussion, the unit of distribution is an entity, and an entity can be a file, a directory or a segment. That is, entities are units of data or metadata stored by a storage system. Entities are grouped into sets called authorities. Each authority has an authority owner, which is a storage node that has the exclusive right to update the entities in the authority. In other words, a storage node contains the authority, and that the authority, in turn, contains entities.

A segment is a logical container of data in accordance with some embodiments. A segment is an address space between medium address space and physical flash locations, i.e., the data segment number, are in this address space. Segments may also contain meta-data, which enable data redundancy to be restored (rewritten to different flash locations or devices) without the involvement of higher level software. In one embodiment, an internal format of a segment contains client data and medium mappings to determine the position of that data. Each data segment is protected, e.g., from memory and other failures, by breaking the segment into a number of data and parity shards, where applicable. The data and parity shards are distributed, i.e., striped, across non-volatile solid state storage 152 coupled to the host CPUs 156 (See FIGS. 22E and 22G) in accordance with an erasure coding scheme. Usage of the term segments refers to the container and its place in the address space of segments in some embodiments. Usage of the term stripe refers to the same set of shards as a segment and includes how the shards are distributed along with redundancy or parity information in accordance with some embodiments.

A series of address-space transformations takes place across an entire storage system. At the top are the directory entries (file names) which link to an inode. Inodes point into medium address space, where data is logically stored. Medium addresses may be mapped through a series of indirect mediums to spread the load of large files, or implement data services like deduplication or snapshots. Medium addresses may be mapped through a series of indirect mediums to spread the load of large files, or implement data services like deduplication or snapshots. Segment addresses are then translated into physical flash locations. Physical flash locations have an address range bounded by the amount of flash in the system in accordance with some embodiments. Medium addresses and segment addresses are logical containers, and in some embodiments use a 128 bit or larger identifier so as to be practically infinite, with a likelihood of reuse calculated as longer than the expected life of the system. Addresses from logical containers are allocated in a hierarchical fashion in some embodiments. Initially, each non-volatile solid state storage 152 unit may be assigned a range of address space. Within this assigned range, the non-volatile solid state storage 152 is able to allocate addresses without synchronization with other non-volatile solid state storage 152.

Data and metadata is stored by a set of underlying storage layouts that are optimized for varying workload patterns and storage devices. These layouts incorporate multiple redundancy schemes, compression formats and index algorithms. Some of these layouts store information about authorities and authority masters, while others store file metadata and file data. The redundancy schemes include error correction codes that tolerate corrupted bits within a single storage device (such as a NAND flash chip), erasure codes that tolerate the failure of multiple storage nodes, and replication schemes that tolerate data center or regional failures. In some embodiments, low density parity check (‘LDPC’) code is used within a single storage unit. Reed-Solomon encoding is used within a storage cluster, and mirroring is used within a storage grid in some embodiments. Metadata may be stored using an ordered log structured index (such as a Log Structured Merge Tree), and large data may not be stored in a log structured layout.

In order to maintain consistency across multiple copies of an entity, the storage nodes agree implicitly on two things through calculations: (1) the authority that contains the entity, and (2) the storage node that contains the authority. The assignment of entities to authorities can be done by pseudo randomly assigning entities to authorities, by splitting entities into ranges based upon an externally produced key, or by placing a single entity into each authority. Examples of pseudorandom schemes are linear hashing and the Replication Under Scalable Hashing (‘RUSH’) family of hashes, including Controlled Replication Under Scalable Hashing (‘CRUSH’). In some embodiments, pseudo-random assignment is utilized only for assigning authorities to nodes because the set of nodes can change. The set of authorities cannot change so any subjective function may be applied in these embodiments. Some placement schemes automatically place authorities on storage nodes, while other placement schemes rely on an explicit mapping of authorities to storage nodes. In some embodiments, a pseudorandom scheme is utilized to map from each authority to a set of candidate authority owners. A pseudorandom data distribution function related to CRUSH may assign authorities to storage nodes and create a list of where the authorities are assigned. Each storage node has a copy of the pseudorandom data distribution function, and can arrive at the same calculation for distributing, and later finding or locating an authority. Each of the pseudorandom schemes requires the reachable set of storage nodes as input in some embodiments in order to conclude the same target nodes. Once an entity has been placed in an authority, the entity may be stored on physical devices so that no expected failure will lead to unexpected data loss. In some embodiments, rebalancing algorithms attempt to store the copies of all entities within an authority in the same layout and on the same set of machines.

Examples of expected failures include device failures, stolen machines, datacenter fires, and regional disasters, such as nuclear or geological events. Different failures lead to different levels of acceptable data loss. In some embodiments, a stolen storage node impacts neither the security nor the reliability of the system, while depending on system configuration, a regional event could lead to no loss of data, a few seconds or minutes of lost updates, or even complete data loss.

In the embodiments, the placement of data for storage redundancy is independent of the placement of authorities for data consistency. In some embodiments, storage nodes that contain authorities do not contain any persistent storage. Instead, the storage nodes are connected to non-volatile solid state storage units that do not contain authorities. The communications interconnect between storage nodes and non-volatile solid state storage units consists of multiple communication technologies and has non-uniform performance and fault tolerance characteristics. In some embodiments, as mentioned above, non-volatile solid state storage units are connected to storage nodes via PCI express, storage nodes are connected together within a single chassis using Ethernet backplane, and chassis are connected together to form a storage cluster. Storage clusters are connected to clients using Ethernet or fiber channel in some embodiments. If multiple storage clusters are configured into a storage grid, the multiple storage clusters are connected using the Internet or other long-distance networking links, such as a “metro scale” link or private link that does not traverse the internet.

Authority owners have the exclusive right to modify entities, to migrate entities from one non-volatile solid state storage unit to another non-volatile solid state storage unit, and to add and remove copies of entities. This allows for maintaining the redundancy of the underlying data. When an authority owner fails, is going to be decommissioned, or is overloaded, the authority is transferred to a new storage node. Transient failures make it non-trivial to ensure that all non-faulty machines agree upon the new authority location. The ambiguity that arises due to transient failures can be achieved automatically by a consensus protocol such as Paxos, hot-warm failover schemes, via manual intervention by a remote system administrator, or by a local hardware administrator (such as by physically removing the failed machine from the cluster, or pressing a button on the failed machine). In some embodiments, a consensus protocol is used, and failover is automatic. If too many failures or replication events occur in too short a time period, the system goes into a self-preservation mode and halts replication and data movement activities until an administrator intervenes in accordance with some embodiments.

As authorities are transferred between storage nodes and authority owners update entities in their authorities, the system transfers messages between the storage nodes and non-volatile solid state storage units. With regard to persistent messages, messages that have different purposes are of different types. Depending on the type of the message, the system maintains different ordering and durability guarantees. As the persistent messages are being processed, the messages are temporarily stored in multiple durable and non-durable storage hardware technologies. In some embodiments, messages are stored in RAM, NVRAM and on NAND flash devices, and a variety of protocols are used in order to make efficient use of each storage medium. Latency-sensitive client requests may be persisted in replicated NVRAM, and then later NAND, while background rebalancing operations are persisted directly to NAND.

Persistent messages are persistently stored prior to being transmitted. This allows the system to continue to serve client requests despite failures and component replacement. Although many hardware components contain unique identifiers that are visible to system administrators, manufacturer, hardware supply chain and ongoing monitoring quality control infrastructure, applications running on top of the infrastructure address virtualize addresses. These virtualized addresses do not change over the lifetime of the storage system, regardless of component failures and replacements. This allows each component of the storage system to be replaced over time without reconfiguration or disruptions of client request processing, i.e., the system supports non-disruptive upgrades.

In some embodiments, the virtualized addresses are stored with sufficient redundancy. A continuous monitoring system correlates hardware and software status and the hardware identifiers. This allows detection and prediction of failures due to faulty components and manufacturing details. The monitoring system also enables the proactive transfer of authorities and entities away from impacted devices before failure occurs by removing the component from the critical path in some embodiments.

FIG. 22C is a multiple level block diagram, showing contents of a storage node 150 and contents of a non-volatile solid state storage 152 of the storage node 150. Data is communicated to and from the storage node 150 by a network interface controller (‘NIC’) 2202 in some embodiments. Each storage node 150 has a CPU 156, and one or more non-volatile solid state storage 152, as discussed above. Moving down one level in FIG. 22C, each non-volatile solid state storage 152 has a relatively fast non-volatile solid state memory, such as nonvolatile random access memory (‘NVRAM’) 2204, and flash memory 2206. In some embodiments, NVRAM 2204 may be a component that does not require program/erase cycles (DRAM, MRAM, PCM), and can be a memory that can support being written vastly more often than the memory is read from. Moving down another level in FIG. 22C, the NVRAM 2204 is implemented in one embodiment as high speed volatile memory, such as dynamic random access memory (DRAM) 2216, backed up by energy reserve 2218. Energy reserve 2218 provides sufficient electrical power to keep the DRAM 2216 powered long enough for contents to be transferred to the flash memory 2206 in the event of power failure. In some embodiments, energy reserve 2218 is a capacitor, super-capacitor, battery, or other device, that supplies a suitable supply of energy sufficient to enable the transfer of the contents of DRAM 2216 to a stable storage medium in the case of power loss. The flash memory 2206 is implemented as multiple flash dies 2222, which may be referred to as packages of flash dies 2222 or an array of flash dies 2222. It should be appreciated that the flash dies 2222 could be packaged in any number of ways, with a single die per package, multiple dies per package (i.e., multichip packages), in hybrid packages, as bare dies on a printed circuit board or other substrate, as encapsulated dies, etc. In the embodiment shown, the non-volatile solid state storage 152 has a controller 2212 or other processor, and an input output (I/O) port 2210 coupled to the controller 2212. I/O port 2210 is coupled to the CPU 156 and/or the network interface controller 2202 of the flash storage node 150. Flash input output (I/O) port 2220 is coupled to the flash dies 2222, and a direct memory access unit (DMA) 2214 is coupled to the controller 2212, the DRAM 2216 and the flash dies 2222. In the embodiment shown, the I/O port 2210, controller 2212, DMA unit 2214 and flash I/O port 2220 are implemented on a programmable logic device (‘PLD’) 2208, e.g., an FPGA. In this embodiment, each flash die 2222 has pages, organized as sixteen kB (kilobyte) pages 2224, and a register 2226 through which data can be written to or read from the flash die 2222. In further embodiments, other types of solid-state memory are used in place of, or in addition to flash memory illustrated within flash die 2222.

Storage clusters 161, in various embodiments as disclosed herein, can be contrasted with storage arrays in general. The storage nodes 150 are part of a collection that creates the storage cluster 161. Each storage node 150 owns a slice of data and computing required to provide the data. Multiple storage nodes 150 cooperate to store and retrieve the data. Storage memory or storage devices, as used in storage arrays in general, are less involved with processing and manipulating the data. Storage memory or storage devices in a storage array receive commands to read, write, or erase data. The storage memory or storage devices in a storage array are not aware of a larger system in which they are embedded, or what the data means. Storage memory or storage devices in storage arrays can include various types of storage memory, such as RAM, solid state drives, hard disk drives, etc. The non-volatile solid state storage 152 units described herein have multiple interfaces active simultaneously and serving multiple purposes. In some embodiments, some of the functionality of a storage node 150 is shifted into a storage unit 152, transforming the storage unit 152 into a combination of storage unit 152 and storage node 150. Placing computing (relative to storage data) into the storage unit 152 places this computing closer to the data itself. The various system embodiments have a hierarchy of storage node layers with different capabilities. By contrast, in a storage array, a controller owns and knows everything about all of the data that the controller manages in a shelf or storage devices. In a storage cluster 161, as described herein, multiple controllers in multiple non-volatile sold state storage 152 units and/or storage nodes 150 cooperate in various ways (e.g., for erasure coding, data sharding, metadata communication and redundancy, storage capacity expansion or contraction, data recovery, and so on).

FIG. 22D shows a storage server environment, which uses embodiments of the storage nodes 150 and storage 152 units of FIGS. 22A-C. In this version, each non-volatile solid state storage 152 unit has a processor such as controller 2212 (see FIG. 22C), an FPGA, flash memory 2206, and NVRAM 2204 (which is super-capacitor backed DRAM 2216, see FIGS. 22B and 22C) on a PCIe (peripheral component interconnect express) board in a chassis 138 (see FIG. 22A). The non-volatile solid state storage 152 unit may be implemented as a single board containing storage, and may be the largest tolerable failure domain inside the chassis. In some embodiments, up to two non-volatile solid state storage 152 units may fail and the device will continue with no data loss.

The physical storage is divided into named regions based on application usage in some embodiments. The NVRAM 2204 is a contiguous block of reserved memory in the non-volatile solid state storage 152 DRAM 2216, and is backed by NAND flash. NVRAM 2204 is logically divided into multiple memory regions written for two as spool (e.g., spool region). Space within the NVRAM 2204 spools is managed by each authority 168 independently. Each device provides an amount of storage space to each authority 168. That authority 168 further manages lifetimes and allocations within that space. Examples of a spool include distributed transactions or notions. When the primary power to a non-volatile solid state storage 152 unit fails, onboard super-capacitors provide a short duration of power hold up. During this holdup interval, the contents of the NVRAM 2204 are flushed to flash memory 2206. On the next power-on, the contents of the NVRAM 2204 are recovered from the flash memory 2206.

As for the storage unit controller, the responsibility of the logical “controller” is distributed across each of the blades containing authorities 168. This distribution of logical control is shown in FIG. 22D as a host controller 2242, mid-tier controller 2244 and storage unit controller(s) 2246. Management of the control plane and the storage plane are treated independently, although parts may be physically co-located on the same blade. Each authority 168 effectively serves as an independent controller. Each authority 168 provides its own data and metadata structures, its own background workers, and maintains its own lifecycle.

FIG. 22E is a blade 2252 hardware block diagram, showing a control plane 2254, compute and storage planes 2256, 2258, and authorities 168 interacting with underlying physical resources, using embodiments of the storage nodes 150 and storage units 152 of FIGS. 22A-C in the storage server environment of FIG. 22D. The control plane 2254 is partitioned into a number of authorities 168 which can use the compute resources in the compute plane 2256 to run on any of the blades 2252. The storage plane 2258 is partitioned into a set of devices, each of which provides access to flash 2206 and NVRAM 2204 resources. In one embodiment, the compute plane 2256 may perform the operations of a storage array controller, as described herein, on one or more devices of the storage plane 2258 (e.g., a storage array).

In the compute and storage planes 2256, 2258 of FIG. 22E, the authorities 168 interact with the underlying physical resources (i.e., devices). From the point of view of an authority 168, its resources are striped over all of the physical devices. From the point of view of a device, it provides resources to all authorities 168, irrespective of where the authorities happen to run. Each authority 168 has allocated or has been allocated one or more partitions 2260 of storage memory in the storage units 152, e.g., partitions 2260 in flash memory 2206 and NVRAM 2204. Each authority 168 uses those allocated partitions 2260 that belong to it, for writing or reading user data. Authorities can be associated with differing amounts of physical storage of the system. For example, one authority 168 could have a larger number of partitions 2260 or larger sized partitions 2260 in one or more storage units 152 than one or more other authorities 168.

FIG. 22F depicts elasticity software layers in blades 2252 of a storage cluster, in accordance with some embodiments. In the elasticity structure, elasticity software is symmetric, i.e., each blade's compute module 2270 runs the three identical layers of processes depicted in FIG. 22F. Storage managers 2274 execute read and write requests from other blades 2252 for data and metadata stored in local storage unit 152 NVRAM 2204 and flash 2206. Authorities 168 fulfill client requests by issuing the necessary reads and writes to the blades 2252 on whose storage units 152 the corresponding data or metadata resides. Endpoints 2272 parse client connection requests received from switch fabric 146 supervisory software, relay the client connection requests to the authorities 168 responsible for fulfillment, and relay the authorities' 168 responses to clients. The symmetric three-layer structure enables the storage system's high degree of concurrency. Elasticity scales out efficiently and reliably in these embodiments. In addition, elasticity implements a unique scale-out technique that balances work evenly across all resources regardless of client access pattern, and maximizes concurrency by eliminating much of the need for inter-blade coordination that typically occurs with conventional distributed locking.

Still referring to FIG. 22F, authorities 168 running in the compute modules 2270 of a blade 2252 perform the internal operations required to fulfill client requests. One feature of elasticity is that authorities 168 are stateless, i.e., they cache active data and metadata in their own blades' 2252 DRAMs for fast access, but the authorities store every update in their NVRAM 2204 partitions on three separate blades 2252 until the update has been written to flash 2206. All the storage system writes to NVRAM 2204 are in triplicate to partitions on three separate blades 2252 in some embodiments. With triple-mirrored NVRAM 2204 and persistent storage protected by parity and Reed-Solomon RAID checksums, the storage system can survive concurrent failure of two blades 2252 with no loss of data, metadata, or access to either.

Because authorities 168 are stateless, they can migrate between blades 2252. Each authority 168 has a unique identifier. NVRAM 2204 and flash 2206 partitions are associated with authorities' 168 identifiers, not with the blades 2252 on which they are running in some. Thus, when an authority 168 migrates, the authority 168 continues to manage the same storage partitions from its new location. When a new blade 2252 is installed in an embodiment of the storage cluster, the system automatically rebalances load by: partitioning the new blade's 2252 storage for use by the system's authorities 168, migrating selected authorities 168 to the new blade 2252, starting endpoints 2272 on the new blade 2252 and including them in the switch fabric's 146 client connection distribution algorithm.

From their new locations, migrated authorities 168 persist the contents of their NVRAM 2204 partitions on flash 2206, process read and write requests from other authorities 168, and fulfill the client requests that endpoints 2272 direct to them. Similarly, if a blade 2252 fails or is removed, the system redistributes its authorities 168 among the system's remaining blades 2252. The redistributed authorities 168 continue to perform their original functions from their new locations.

FIG. 22G depicts authorities 168 and storage resources in blades 2252 of a storage cluster, in accordance with some embodiments. Each authority 168 is exclusively responsible for a partition of the flash 2206 and NVRAM 2204 on each blade 2252. The authority 168 manages the content and integrity of its partitions independently of other authorities 168.

Authorities 168 compress incoming data and preserve it temporarily in their NVRAM 2204 partitions, and then consolidate, RAID-protect, and persist the data in segments of the storage in their flash 2206 partitions. As the authorities 168 write data to flash 2206, storage managers 2274 perform the necessary flash translation to optimize write performance and maximize media longevity. In the background, authorities 168 “garbage collect,” or reclaim space occupied by data that clients have made obsolete by overwriting the data. It should be appreciated that since authorities' 168 partitions are disjoint, there is no need for distributed locking to execute client and writes or to perform background functions.

The embodiments described herein may utilize various software, communication and/or networking protocols. In addition, the configuration of the hardware and/or software may be adjusted to accommodate various protocols. For example, the embodiments may utilize Active Directory, which is a database based system that provides authentication, directory, policy, and other services in a WINDOWS™ environment. In these embodiments, LDAP (Lightweight Directory Access Protocol) is one example application protocol for querying and modifying items in directory service providers such as Active Directory. In some embodiments, a network lock manager (‘NLM’) is utilized as a facility that works in cooperation with the Network File System (‘NFS’) to provide a System V style of advisory file and record locking over a network. The Server Message Block (‘SMB’) protocol, one version of which is also known as Common Internet File System (‘CIFS’), may be integrated with the storage systems discussed herein. SMP operates as an application-layer network protocol typically used for providing shared access to files, printers, and serial ports and miscellaneous communications between nodes on a network. SMB also provides an authenticated inter-process communication mechanism. AMAZON™ S3 (Simple Storage Service) is a web service offered by Amazon Web Services, and the systems described herein may interface with Amazon S3 through web services interfaces (REST (representational state transfer), SOAP (simple object access protocol), and BitTorrent). A RESTful API (application programming interface) breaks down a transaction to create a series of small modules. Each module addresses a particular underlying part of the transaction. The control or permissions provided with these embodiments, especially for object data, may include utilization of an access control list (‘ACL’). The ACL is a list of permissions attached to an object and the ACL specifies which users or system processes are granted access to objects, as well as what operations are allowed on given objects. The systems may utilize Internet Protocol version 6 (‘IPv6’), as well as IPv4, for the communications protocol that provides an identification and location system for computers on networks and routes traffic across the Internet. The routing of packets between networked systems may include Equal-cost multi-path routing (‘ECMP’), which is a routing strategy where next-hop packet forwarding to a single destination can occur over multiple “best paths” which tie for top place in routing metric calculations. Multi-path routing can be used in conjunction with most routing protocols, because it is a per-hop decision limited to a single router. The software may support Multi-tenancy, which is an architecture in which a single instance of a software application serves multiple customers. Each customer may be referred to as a tenant. Tenants may be given the ability to customize some parts of the application, but may not customize the application's code, in some embodiments. The embodiments may maintain audit logs. An audit log is a document that records an event in a computing system. In addition to documenting what resources were accessed, audit log entries typically include destination and source addresses, a timestamp, and user login information for compliance with various regulations. The embodiments may support various key management policies, such as encryption key rotation. In addition, the system may support dynamic root passwords or some variation dynamically changing passwords.

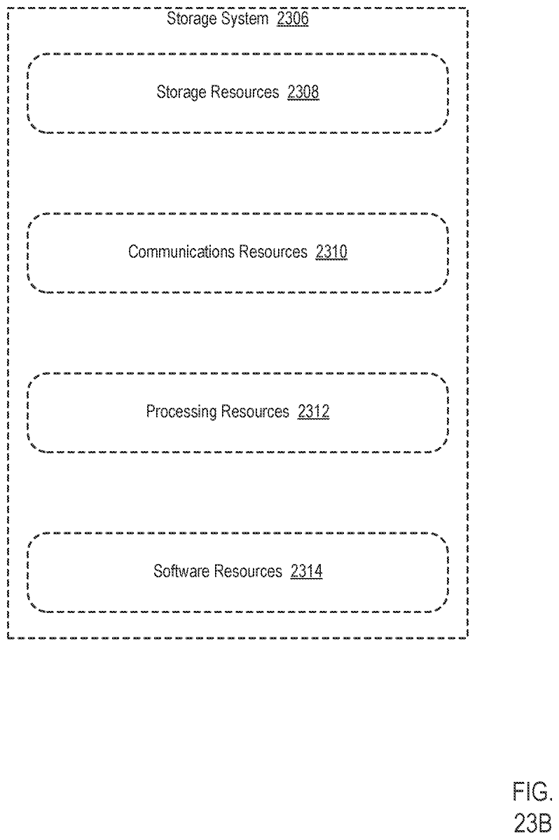

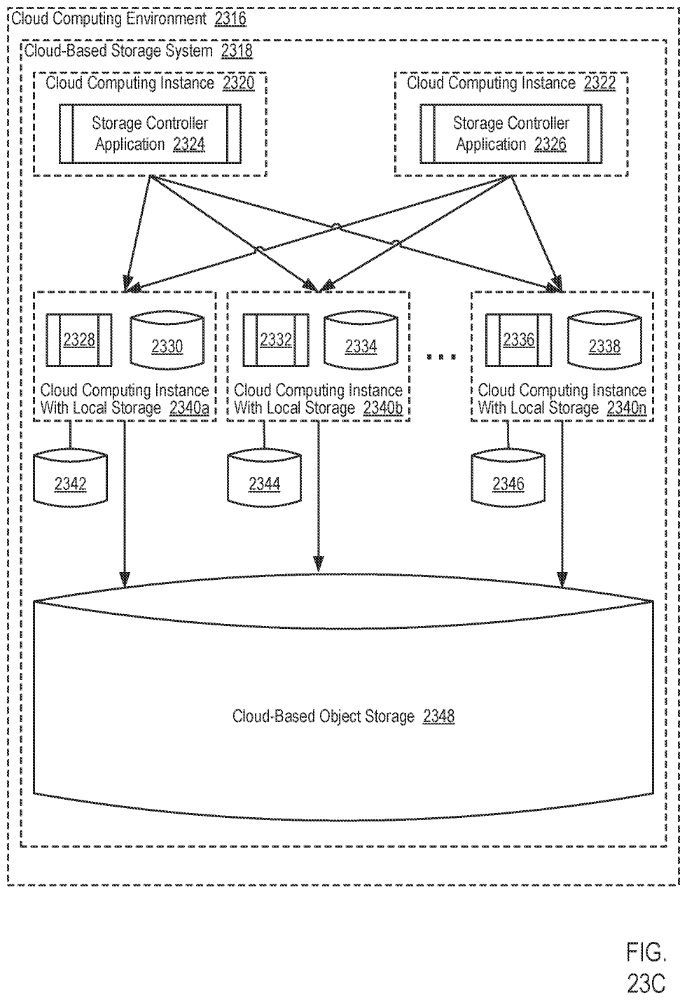

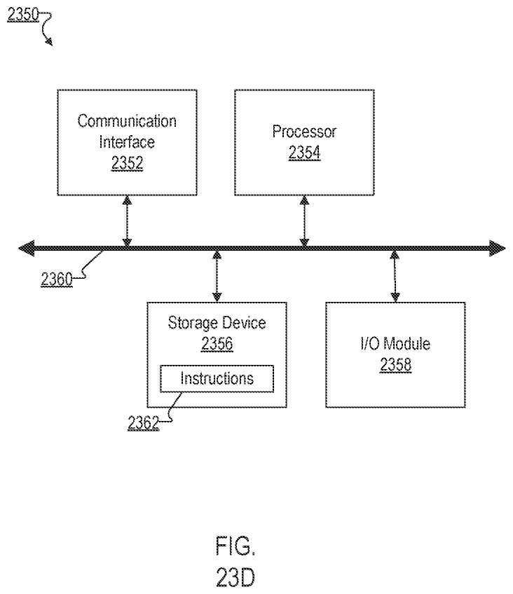

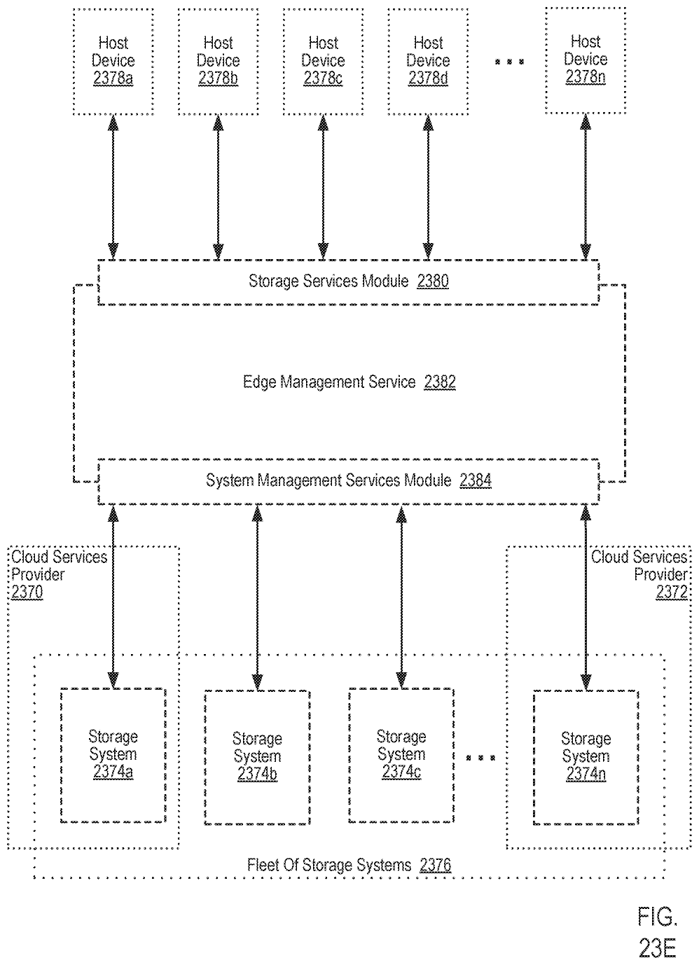

FIG. 23A sets forth a diagram of a storage system 2306 that is coupled for data communications with a cloud services provider 2302 in accordance with some embodiments of the present disclosure. Although depicted in less detail, the storage system 2306 depicted in FIG. 23A may be similar to the storage systems described above with reference to FIGS. 1A-1D and FIGS. 22A-22G. In some embodiments, the storage system 2306 depicted in FIG. 23A may be embodied as a storage system that includes imbalanced active/active controllers, as a storage system that includes balanced active/active controllers, as a storage system that includes active/active controllers where less than all of each controller's resources are utilized such that each controller has reserve resources that may be used to support failover, as a storage system that includes fully active/active controllers, as a storage system that includes dataset-segregated controllers, as a storage system that includes dual-layer architectures with front-end controllers and back-end integrated storage controllers, as a storage system that includes scale-out clusters of dual-controller arrays, as well as combinations of such embodiments.

In the example depicted in FIG. 23A, the storage system 2306 is coupled to the cloud services provider 2302 via a data communications link 2304. The data communications link 2304 may be embodied as a dedicated data communications link, as a data communications pathway that is provided through the use of one or data communications networks such as a wide area network (‘WAN’) or LAN, or as some other mechanism capable of transporting digital information between the storage system 2306 and the cloud services provider 2302. Such a data communications link 2304 may be fully wired, fully wireless, or some aggregation of wired and wireless data communications pathways. In such an example, digital information may be exchanged between the storage system 2306 and the cloud services provider 2302 via the data communications link 2304 using one or more data communications protocols. For example, digital information may be exchanged between the storage system 2306 and the cloud services provider 2302 via the data communications link 2304 using the handheld device transfer protocol (‘HDTP’), hypertext transfer protocol (‘HTTP’), internet protocol (‘IP’), real-time transfer protocol (‘RTP’), transmission control protocol (‘TCP’), user datagram protocol (‘UDP’), wireless application protocol (‘WAP’), or other protocol.

The cloud services provider 2302 depicted in FIG. 23A may be embodied, for example, as a system and computing environment that provides a vast array of services to users of the cloud services provider 2302 through the sharing of computing resources via the data communications link 2304. The cloud services provider 2302 may provide on-demand access to a shared pool of configurable computing resources such as computer networks, servers, storage, applications and services, and so on. The shared pool of configurable resources may be rapidly provisioned and released to a user of the cloud services provider 2302 with minimal management effort. Generally, the user of the cloud services provider 2302 is unaware of the exact computing resources utilized by the cloud services provider 2302 to provide the services. Although in many cases such a cloud services provider 2302 may be accessible via the Internet, readers of skill in the art will recognize that any system that abstracts the use of shared resources to provide services to a user through any data communications link may be considered a cloud services provider 2302.

In the example depicted in FIG. 23A, the cloud services provider 2302 may be configured to provide a variety of services to the storage system 2306 and users of the storage system 2306 through the implementation of various service models. For example, the cloud services provider 2302 may be configured to provide services through the implementation of an infrastructure as a service (‘IaaS’) service model, through the implementation of a platform as a service (‘PaaS’) service model, through the implementation of a software as a service (‘SaaS’) service model, through the implementation of an authentication as a service (‘AaaS’) service model, through the implementation of a storage as a service model where the cloud services provider 2302 offers access to its storage infrastructure for use by the storage system 2306 and users of the storage system 2306, and so on. Readers will appreciate that the cloud services provider 2302 may be configured to provide additional services to the storage system 2306 and users of the storage system 2306 through the implementation of additional service models, as the service models described above are included only for explanatory purposes and in no way represent a limitation of the services that may be offered by the cloud services provider 2302 or a limitation as to the service models that may be implemented by the cloud services provider 2302.

In the example depicted in FIG. 23A, the cloud services provider 2302 may be embodied, for example, as a private cloud, as a public cloud, or as a combination of a private cloud and public cloud. In an embodiment in which the cloud services provider 2302 is embodied as a private cloud, the cloud services provider 2302 may be dedicated to providing services to a single organization rather than providing services to multiple organizations. In an embodiment where the cloud services provider 2302 is embodied as a public cloud, the cloud services provider 2302 may provide services to multiple organizations. In still alternative embodiments, the cloud services provider 2302 may be embodied as a mix of a private and public cloud services with a hybrid cloud deployment.

Although not explicitly depicted in FIG. 23A, readers will appreciate that a vast amount of additional hardware components and additional software components may be necessary to facilitate the delivery of cloud services to the storage system 2306 and users of the storage system 2306. For example, the storage system 2306 may be coupled to (or even include) a cloud storage gateway. Such a cloud storage gateway may be embodied, for example, as hardware-based or software-based appliance that is located on premise with the storage system 2306. Such a cloud storage gateway may operate as a bridge between local applications that are executing on the storage system 2306 and remote, cloud-based storage that is utilized by the storage system 2306. Through the use of a cloud storage gateway, organizations may move primary iSCSI or NAS to the cloud services provider 2302, thereby enabling the organization to save space on their on-premises storage systems. Such a cloud storage gateway may be configured to emulate a disk array, a block-based device, a file server, or other storage system that can translate the SCSI commands, file server commands, or other appropriate command into REST-space protocols that facilitate communications with the cloud services provider 2302.

In order to enable the storage system 2306 and users of the storage system 2306 to make use of the services provided by the cloud services provider 2302, a cloud migration process may take place during which data, applications, or other elements from an organization's local systems (or even from another cloud environment) are moved to the cloud services provider 2302. In order to successfully migrate data, applications, or other elements to the cloud services provider's 2302 environment, middleware such as a cloud migration tool may be utilized to bridge gaps between the cloud services provider's 2302 environment and an organization's environment. Such cloud migration tools may also be configured to address potentially high network costs and long transfer times associated with migrating large volumes of data to the cloud services provider 2302, as well as addressing security concerns associated with sensitive data to the cloud services provider 2302 over data communications networks. In order to further enable the storage system 2306 and users of the storage system 2306 to make use of the services provided by the cloud services provider 2302, a cloud orchestrator may also be used to arrange and coordinate automated tasks in pursuit of creating a consolidated process or workflow. Such a cloud orchestrator may perform tasks such as configuring various components, whether those components are cloud components or on-premises components, as well as managing the interconnections between such components. The cloud orchestrator can simplify the inter-component communication and connections to ensure that links are correctly configured and maintained.

In the example depicted in FIG. 23A, and as described briefly above, the cloud services provider 2302 may be configured to provide services to the storage system 2306 and users of the storage system 2306 through the usage of a SaaS service model, eliminating the need to install and run the application on local computers, which may simplify maintenance and support of the application. Such applications may take many forms in accordance with various embodiments of the present disclosure. For example, the cloud services provider 2302 may be configured to provide access to data analytics applications to the storage system 2306 and users of the storage system 2306. Such data analytics applications may be configured, for example, to receive vast amounts of telemetry data phoned home by the storage system 2306. Such telemetry data may describe various operating characteristics of the storage system 2306 and may be analyzed for a vast array of purposes including, for example, to determine the health of the storage system 2306, to identify workloads that are executing on the storage system 2306, to predict when the storage system 2306 will run out of various resources, to recommend configuration changes, hardware or software upgrades, workflow migrations, or other actions that may improve the operation of the storage system 2306.

The cloud services provider 2302 may also be configured to provide access to virtualized computing environments to the storage system 2306 and users of the storage system 2306. Such virtualized computing environments may be embodied, for example, as a virtual machine or other virtualized computer hardware platforms, virtual storage devices, virtualized computer network resources, and so on. Examples of such virtualized environments can include virtual machines that are created to emulate an actual computer, virtualized desktop environments that separate a logical desktop from a physical machine, virtualized file systems that allow uniform access to different types of concrete file systems, and many others.

Although the example depicted in FIG. 23A illustrates the storage system 2306 being coupled for data communications with the cloud services provider 2302, in other embodiments the storage system 2306 may be part of a hybrid cloud deployment in which private cloud elements (e.g., private cloud services, on-premises infrastructure, and so on) and public cloud elements (e.g., public cloud services, infrastructure, and so on that may be provided by one or more cloud services providers) are combined to form a single solution, with orchestration among the various platforms. Such a hybrid cloud deployment may leverage hybrid cloud management software such as, for example, Azure™ Arc from Microsoft™, that centralize the management of the hybrid cloud deployment to any infrastructure and enable the deployment of services anywhere. In such an example, the hybrid cloud management software may be configured to create, update, and delete resources (both physical and virtual) that form the hybrid cloud deployment, to allocate compute and storage to specific workloads, to monitor workloads and resources for performance, policy compliance, updates and patches, security status, or to perform a variety of other tasks.

Readers will appreciate that by pairing the storage systems described herein with one or more cloud services providers, various offerings may be enabled. For example, disaster recovery as a service (‘DRaaS’) may be provided where cloud resources are utilized to protect applications and data from disruption caused by disaster, including in embodiments where the storage systems may serve as the primary data store. In such embodiments, a total system backup may be taken that allows for business continuity in the event of system failure. In such embodiments, cloud data backup techniques (by themselves or as part of a larger DRaaS solution) may also be integrated into an overall solution that includes the storage systems and cloud services providers described herein.

The storage systems described herein, as well as the cloud services providers, may be utilized to provide a wide array of security features. For example, the storage systems may encrypt data at rest (and data may be sent to and from the storage systems encrypted) and may make use of Key Management-as-a-Service (‘KMaaS’) to manage encryption keys, keys for locking and unlocking storage devices, and so on. Likewise, cloud data security gateways or similar mechanisms may be utilized to ensure that data stored within the storage systems does not improperly end up being stored in the cloud as part of a cloud data backup operation. Furthermore, microsegmentation or identity-based-segmentation may be utilized in a data center that includes the storage systems or within the cloud services provider, to create secure zones in data centers and cloud deployments that enables the isolation of workloads from one another.

For further explanation, FIG. 23B sets forth a diagram of a storage system 2306 in accordance with some embodiments of the present disclosure. Although depicted in less detail, the storage system 2306 depicted in FIG. 23B may be similar to the storage systems described above with reference to FIGS. 1A-1D and FIGS. 22A-22G as the storage system may include many of the components described above.

The storage system 2306 depicted in FIG. 23B may include a vast amount of storage resources 2308, which may be embodied in many forms. For example, the storage resources 2308 can include nano-RAM or another form of nonvolatile random access memory that utilizes carbon nanotubes deposited on a substrate, 23D crosspoint non-volatile memory, flash memory including single-level cell (‘SLC’) NAND flash, multi-level cell (‘MLC’) NAND flash, triple-level cell (‘TLC’) NAND flash, quad-level cell (‘QLC’) NAND flash, or others. Likewise, the storage resources 2308 may include non-volatile magnetoresistive random-access memory (‘MRAM’), including spin transfer torque (‘STT’) MRAM. The example storage resources 2308 may alternatively include non-volatile phase-change memory (‘PCM’), quantum memory that allows for the storage and retrieval of photonic quantum information, resistive random-access memory (‘ReRAM’), storage class memory (‘SCM’), or other form of storage resources, including any combination of resources described herein. Readers will appreciate that other forms of computer memories and storage devices may be utilized by the storage systems described above, including DRAM, SRAM, EEPROM, universal memory, and many others. The storage resources 2308 depicted in FIG. 23A may be embodied in a variety of form factors, including but not limited to, dual in-line memory modules (‘DIMMs’), non-volatile dual in-line memory modules (‘NVDIMMs’), M.2, U.2, and others.

The storage resources 2308 depicted in FIG. 23B may include various forms of SCM. SCM may effectively treat fast, non-volatile memory (e.g., NAND flash) as an extension of DRAM such that an entire dataset may be treated as an in-memory dataset that resides entirely in DRAM. SCM may include non-volatile media such as, for example, NAND flash. Such NAND flash may be accessed utilizing NVMe that can use the PCIe bus as its transport, providing for relatively low access latencies compared to older protocols. In fact, the network protocols used for SSDs in all-flash arrays can include NVMe using Ethernet (ROCE, NVME TCP), Fibre Channel (NVMe FC), InfiniBand (iWARP), and others that make it possible to treat fast, non-volatile memory as an extension of DRAM. In view of the fact that DRAM is often byte-addressable and fast, non-volatile memory such as NAND flash is block-addressable, a controller software/hardware stack may be needed to convert the block data to the bytes that are stored in the media. Examples of media and software that may be used as SCM can include, for example, 3D XPoint, Intel Memory Drive Technology, Samsung's Z-SSD, and others.

The storage resources 2308 depicted in FIG. 23B may also include racetrack memory (also referred to as domain-wall memory). Such racetrack memory may be embodied as a form of non-volatile, solid-state memory that relies on the intrinsic strength and orientation of the magnetic field created by an electron as it spins in addition to its electronic charge, in solid-state devices. Through the use of spin-coherent electric current to move magnetic domains along a nanoscopic permalloy wire, the domains may pass by magnetic read/write heads positioned near the wire as current is passed through the wire, which alter the domains to record patterns of bits. In order to create a racetrack memory device, many such wires and read/write elements may be packaged together.

The example storage system 2306 depicted in FIG. 23B may implement a variety of storage architectures. For example, storage systems in accordance with some embodiments of the present disclosure may utilize block storage where data is stored in blocks, and each block essentially acts as an individual hard drive. Storage systems in accordance with some embodiments of the present disclosure may utilize object storage, where data is managed as objects. Each object may include the data itself, a variable amount of metadata, and a globally unique identifier, where object storage can be implemented at multiple levels (e.g., device level, system level, interface level). Storage systems in accordance with some embodiments of the present disclosure utilize file storage in which data is stored in a hierarchical structure. Such data may be saved in files and folders, and presented to both the system storing it and the system retrieving it in the same format.

The example storage system 2306 depicted in FIG. 23B may be embodied as a storage system in which additional storage resources can be added through the use of a scale-up model, additional storage resources can be added through the use of a scale-out model, or through some combination thereof. In a scale-up model, additional storage may be added by adding additional storage devices. In a scale-out model, however, additional storage nodes may be added to a cluster of storage nodes, where such storage nodes can include additional processing resources, additional networking resources, and so on.

The example storage system 2306 depicted in FIG. 23B may leverage the storage resources described above in a variety of different ways. For example, some portion of the storage resources may be utilized to serve as a write cache, storage resources within the storage system may be utilized as a read cache, or tiering may be achieved within the storage systems by placing data within the storage system in accordance with one or more tiering policies.

The storage system 2306 depicted in FIG. 23B also includes communications resources 2310 that may be useful in facilitating data communications between components within the storage system 2306, as well as data communications between the storage system 2306 and computing devices that are outside of the storage system 2306, including embodiments where those resources are separated by a relatively vast expanse. The communications resources 2310 may be configured to utilize a variety of different protocols and data communication fabrics to facilitate data communications between components within the storage systems as well as computing devices that are outside of the storage system. For example, the communications resources 2310 can include fibre channel (‘FC’) technologies such as FC fabrics and FC protocols that can transport SCSI commands over FC network, FC over ethernet (‘FCoE’) technologies through which FC frames are encapsulated and transmitted over Ethernet networks, InfiniBand (‘IB’) technologies in which a switched fabric topology is utilized to facilitate transmissions between channel adapters, NVM Express (‘NVMe’) technologies and NVMe over fabrics (‘NVMeoF’) technologies through which non-volatile storage media attached via a PCI express (‘PCIe’) bus may be accessed, and others. In fact, the storage systems described above may, directly or indirectly, make use of neutrino communication technologies and devices through which information (including binary information) is transmitted using a beam of neutrinos.

The communications resources 2310 can also include mechanisms for accessing storage resources 2308 within the storage system 2306 utilizing serial attached SCSI (‘SAS’), serial ATA (‘SATA’) bus interfaces for connecting storage resources 2308 within the storage system 2306 to host bus adapters within the storage system 2306, internet small computer systems interface (‘iSCSI’) technologies to provide block-level access to storage resources 2308 within the storage system 2306, and other communications resources that that may be useful in facilitating data communications between components within the storage system 2306, as well as data communications between the storage system 2306 and computing devices that are outside of the storage system 2306.

The storage system 2306 depicted in FIG. 23B also includes processing resources 2312 that may be useful in useful in executing computer program instructions and performing other computational tasks within the storage system 2306. The processing resources 2312 may include one or more ASICs that are customized for some particular purpose as well as one or more CPUs. The processing resources 2312 may also include one or more DSPs, one or more FPGAs, one or more systems on a chip (‘SoCs’), or other form of processing resources 2312. The storage system 2306 may utilize the storage resources 2312 to perform a variety of tasks including, but not limited to, supporting the execution of software resources 2314 that will be described in greater detail below.

The storage system 2306 depicted in FIG. 23B also includes software resources 2314 that, when executed by processing resources 2312 within the storage system 2306, may perform a vast array of tasks. The software resources 2314 may include, for example, one or more modules of computer program instructions that when executed by processing resources 2312 within the storage system 2306 are useful in carrying out various data protection techniques. Such data protection techniques may be carried out, for example, by system software executing on computer hardware within the storage system, by a cloud services provider, or in other ways. Such data protection techniques can include data archiving, data backup, data replication, data snapshotting, data and database cloning, and other data protection techniques.

The software resources 2314 may also include software that is useful in implementing software-defined storage (‘SDS’). In such an example, the software resources 2314 may include one or more modules of computer program instructions that, when executed, are useful in policy-based provisioning and management of data storage that is independent of the underlying hardware. Such software resources 2314 may be useful in implementing storage virtualization to separate the storage hardware from the software that manages the storage hardware.

The software resources 2314 may also include software that is useful in facilitating and optimizing I/O operations that are directed to the storage system 2306. For example, the software resources 2314 may include software modules that perform various data reduction techniques such as, for example, data compression, data deduplication, and others. The software resources 2314 may include software modules that intelligently group together I/O operations to facilitate better usage of the underlying storage resource 2308, software modules that perform data migration operations to migrate from within a storage system, as well as software modules that perform other functions. Such software resources 2314 may be embodied as one or more software containers or in many other ways.

For further explanation, FIG. 23C sets forth an example of a cloud-based storage system 2318 in accordance with some embodiments of the present disclosure. In the example depicted in FIG. 23C, the cloud-based storage system 2318 is created entirely in a cloud computing environment 2316 such as, for example, Amazon Web Services (‘AWS’)™, Microsoft Azure™, Google Cloud Platform™, IBM Cloud™, Oracle Cloud™, and others. The cloud-based storage system 2318 may be used to provide services similar to the services that may be provided by the storage systems described above.

The cloud-based storage system 2318 depicted in FIG. 23C includes two cloud computing instances 2320, 2322 that each are used to support the execution of a storage controller application 2324, 2326. The cloud computing instances 2320, 2322 may be embodied, for example, as instances of cloud computing resources (e.g., virtual machines) that may be provided by the cloud computing environment 2316 to support the execution of software applications such as the storage controller application 2324, 2326. For example, each of the cloud computing instances 2320, 2322 may execute on an Azure VM, where each Azure VM may include high speed temporary storage that may be leveraged as a cache (e.g., as a read cache). In one embodiment, the cloud computing instances 2320, 2322 may be embodied as Amazon Elastic Compute Cloud (‘EC2’) instances. In such an example, an Amazon Machine Image (‘AMI’) that includes the storage controller application 2324, 2326 may be booted to create and configure a virtual machine that may execute the storage controller application 2324, 2326.

In the example method depicted in FIG. 23C, the storage controller application 2324, 2326 may be embodied as a module of computer program instructions that, when executed, carries out various storage tasks. For example, the storage controller application 2324, 2326 may be embodied as a module of computer program instructions that, when executed, carries out the same tasks as the controllers 110A, 110B in FIG. 1A described above such as writing data to the cloud-based storage system 2318, erasing data from the cloud-based storage system 2318, retrieving data from the cloud-based storage system 2318, monitoring and reporting of disk utilization and performance, performing redundancy operations, such as RAID or RAID-like data redundancy operations, compressing data, encrypting data, deduplicating data, and so forth. Readers will appreciate that because there are two cloud computing instances 2320, 2322 that each include the storage controller application 2324, 2326, in some embodiments one cloud computing instance 2320 may operate as the primary controller as described above while the other cloud computing instance 2322 may operate as the secondary controller as described above. Readers will appreciate that the storage controller application 2324, 2326 depicted in FIG. 23C may include identical source code that is executed within different cloud computing instances 2320, 2322 such as distinct EC2 instances.

Readers will appreciate that other embodiments that do not include a primary and secondary controller are within the scope of the present disclosure. For example, each cloud computing instance 2320, 2322 may operate as a primary controller for some portion of the address space supported by the cloud-based storage system 2318, each cloud computing instance 2320, 2322 may operate as a primary controller where the servicing of I/O operations directed to the cloud-based storage system 2318 are divided in some other way, and so on. In fact, in other embodiments where costs savings may be prioritized over performance demands, only a single cloud computing instance may exist that contains the storage controller application.

The cloud-based storage system 2318 depicted in FIG. 23C includes cloud computing instances 2340a, 2340b, 2340n with local storage 2330, 2334, 2338. The cloud computing instances 2340a, 2340b, 2340n may be embodied, for example, as instances of cloud computing resources that may be provided by the cloud computing environment 2316 to support the execution of software applications. The cloud computing instances 2340a, 2340b, 2340n of FIG. 23C may differ from the cloud computing instances 2320, 2322 described above as the cloud computing instances 2340a, 2340b, 2340n of FIG. 23C have local storage 2330, 2334, 2338 resources whereas the cloud computing instances 2320, 2322 that support the execution of the storage controller application 2324, 2326 need not have local storage resources. The cloud computing instances 2340a, 2340b, 2340n with local storage 2330, 2334, 2338 may be embodied, for example, as EC2 M5 instances that include one or more SSDs, as EC2 R5 instances that include one or more SSDs, as EC2 I3 instances that include one or more SSDs, and so on. In some embodiments, the local storage 2330, 2334, 2338 must be embodied as solid-state storage (e.g., SSDs) rather than storage that makes use of hard disk drives.

In the example depicted in FIG. 23C, each of the cloud computing instances 2340a, 2340b, 2340n with local storage 2330, 2334, 2338 can include a software daemon 2328, 2332, 2336 that, when executed by a cloud computing instance 2340a, 2340b, 2340n can present itself to the storage controller applications 2324, 2326 as if the cloud computing instance 2340a, 2340b, 2340n were a physical storage device (e.g., one or more SSDs). In such an example, the software daemon 2328, 2332, 2336 may include computer program instructions similar to those that would normally be contained on a storage device such that the storage controller applications 2324, 2326 can send and receive the same commands that a storage controller would send to storage devices. In such a way, the storage controller applications 2324, 2326 may include code that is identical to (or substantially identical to) the code that would be executed by the controllers in the storage systems described above. In these and similar embodiments, communications between the storage controller applications 2324, 2326 and the cloud computing instances 2340a, 2340b, 2340n with local storage 2330, 2334, 2338 may utilize iSCSI, NVMe over TCP, messaging, a custom protocol, or in some other mechanism.

In the example depicted in FIG. 23C, each of the cloud computing instances 2340a, 2340b, 2340n with local storage 2330, 2334, 2338 may also be coupled to block storage 2342, 2344, 2346 that is offered by the cloud computing environment 2316 such as, for example, as Amazon Elastic Block Store (‘EBS’) volumes. In such an example, the block storage 2342, 2344, 2346 that is offered by the cloud computing environment 2316 may be utilized in a manner that is similar to how the NVRAM devices described above are utilized, as the software daemon 2328, 2332, 2336 (or some other module) that is executing within a particular cloud comping instance 2340a, 2340b, 2340n may, upon receiving a request to write data, initiate a write of the data to its attached EBS volume as well as a write of the data to its local storage 2330, 2334, 2338 resources. In some alternative embodiments, data may only be written to the local storage 2330, 2334, 2338 resources within a particular cloud comping instance 2340a, 2340b, 2340n. In an alternative embodiment, rather than using the block storage 2342, 2344, 2346 that is offered by the cloud computing environment 2316 as NVRAM, actual RAM on each of the cloud computing instances 2340a, 2340b, 2340n with local storage 2330, 2334, 2338 may be used as NVRAM, thereby decreasing network utilization costs that would be associated with using an EBS volume as the NVRAM. In yet another embodiment, high performance block storage resources such as one or more Azure Ultra Disks may be utilized as the NVRAM.

The storage controller applications 2324, 2326 may be used to perform various tasks such as deduplicating the data contained in the request, compressing the data contained in the request, determining where to the write the data contained in the request, and so on, before ultimately sending a request to write a deduplicated, encrypted, or otherwise possibly updated version of the data to one or more of the cloud computing instances 2340a, 2340b, 2340n with local storage 2330, 2334, 2338. Either cloud computing instance 2320, 2322, in some embodiments, may receive a request to read data from the cloud-based storage system 2318 and may ultimately send a request to read data to one or more of the cloud computing instances 2340a, 2340b, 2340n with local storage 2330, 2334, 2338.

When a request to write data is received by a particular cloud computing instance 2340a, 2340b, 2340n with local storage 2330, 2334, 2338, the software daemon 2328, 2332, 2336 may be configured to not only write the data to its own local storage 2330, 2334, 2338 resources and any appropriate block storage 2342, 2344, 2346 resources, but the software daemon 2328, 2332, 2336 may also be configured to write the data to cloud-based object storage 2348 that is attached to the particular cloud computing instance 2340a, 2340b, 2340n. The cloud-based object storage 2348 that is attached to the particular cloud computing instance 2340a, 2340b, 2340n may be embodied, for example, as Amazon Simple Storage Service (‘S3’). In other embodiments, the cloud computing instances 2320, 2322 that each include the storage controller application 2324, 2326 may initiate the storage of the data in the local storage 2330, 2334, 2338 of the cloud computing instances 2340a, 2340b, 2340n and the cloud-based object storage 2348. In other embodiments, rather than using both the cloud computing instances 2340a, 2340b, 2340n with local storage 2330, 2334, 2338 (also referred to herein as ‘virtual drives’) and the cloud-based object storage 2348 to store data, a persistent storage layer may be implemented in other ways. For example, one or more Azure Ultra disks may be used to persistently store data (e.g., after the data has been written to the NVRAM layer).

While the local storage 2330, 2334, 2338 resources and the block storage 2342, 2344, 2346 resources that are utilized by the cloud computing instances 2340a, 2340b, 2340n may support block-level access, the cloud-based object storage 2348 that is attached to the particular cloud computing instance 2340a, 2340b, 2340n supports only object-based access. The software daemon 2328, 2332, 2336 may therefore be configured to take blocks of data, package those blocks into objects, and write the objects to the cloud-based object storage 2348 that is attached to the particular cloud computing instance 2340a, 2340b, 2340n.

Consider an example in which data is written to the local storage 2330, 2334, 2338 resources and the block storage 2342, 2344, 2346 resources that are utilized by the cloud computing instances 2340a, 2340b, 2340n in 1 MB blocks. In such an example, assume that a user of the cloud-based storage system 2318 issues a request to write data that, after being compressed and deduplicated by the storage controller application 2324, 2326 results in the need to write 5 MB of data. In such an example, writing the data to the local storage 2330, 2334, 2338 resources and the block storage 2342, 2344, 2346 resources that are utilized by the cloud computing instances 2340a, 2340b, 2340n is relatively straightforward as 5 blocks that are 1 MB in size are written to the local storage 2330, 2334, 2338 resources and the block storage 2342, 2344, 2346 resources that are utilized by the cloud computing instances 2340a, 2340b, 2340n. In such an example, the software daemon 2328, 2332, 2336 may also be configured to create five objects containing distinct 1 MB chunks of the data. As such, in some embodiments, each object that is written to the cloud-based object storage 2348 may be identical (or nearly identical) in size. Readers will appreciate that in such an example, metadata that is associated with the data itself may be included in each object (e.g., the first 1 MB of the object is data and the remaining portion is metadata associated with the data). Readers will appreciate that the cloud-based object storage 2348 may be incorporated into the cloud-based storage system 2318 to increase the durability of the cloud-based storage system 2318.

In some embodiments, all data that is stored by the cloud-based storage system 2318 may be stored in both: 1) the cloud-based object storage 2348, and 2) at least one of the local storage 2330, 2334, 2338 resources or block storage 2342, 2344, 2346 resources that are utilized by the cloud computing instances 2340a, 2340b, 2340n. In such embodiments, the local storage 2330, 2334, 2338 resources and block storage 2342, 2344, 2346 resources that are utilized by the cloud computing instances 2340a, 2340b, 2340n may effectively operate as cache that generally includes all data that is also stored in S3, such that all reads of data may be serviced by the cloud computing instances 2340a, 2340b, 2340n without requiring the cloud computing instances 2340a, 2340b, 2340n to access the cloud-based object storage 2348. Readers will appreciate that in other embodiments, however, all data that is stored by the cloud-based storage system 2318 may be stored in the cloud-based object storage 2348, but less than all data that is stored by the cloud-based storage system 2318 may be stored in at least one of the local storage 2330, 2334, 2338 resources or block storage 2342, 2344, 2346 resources that are utilized by the cloud computing instances 2340a, 2340b, 2340n. In such an example, various policies may be utilized to determine which subset of the data that is stored by the cloud-based storage system 2318 should reside in both: 1) the cloud-based object storage 2348, and 2) at least one of the local storage 2330, 2334, 2338 resources or block storage 2342, 2344, 2346 resources that are utilized by the cloud computing instances 2340a, 2340b, 2340n.

One or more modules of computer program instructions that are executing within the cloud-based storage system 2318 (e.g., a monitoring module that is executing on its own EC2 instance) may be designed to handle the failure of one or more of the cloud computing instances 2340a, 2340b, 2340n with local storage 2330, 2334, 2338. In such an example, the monitoring module may handle the failure of one or more of the cloud computing instances 2340a, 2340b, 2340n with local storage 2330, 2334, 2338 by creating one or more new cloud computing instances with local storage, retrieving data that was stored on the failed cloud computing instances 2340a, 2340b, 2340n from the cloud-based object storage 2348, and storing the data retrieved from the cloud-based object storage 2348 in local storage on the newly created cloud computing instances. Readers will appreciate that many variants of this process may be implemented.

Readers will appreciate that various performance aspects of the cloud-based storage system 2318 may be monitored (e.g., by a monitoring module that is executing in an EC2 instance) such that the cloud-based storage system 2318 can be scaled-up or scaled-out as needed. For example, if the cloud computing instances 2320, 2322 that are used to support the execution of a storage controller application 2324, 2326 are undersized and not sufficiently servicing the I/O requests that are issued by users of the cloud-based storage system 2318, a monitoring module may create a new, more powerful cloud computing instance (e.g., a cloud computing instance of a type that includes more processing power, more memory, etc. . . . ) that includes the storage controller application such that the new, more powerful cloud computing instance can begin operating as the primary controller. Likewise, if the monitoring module determines that the cloud computing instances 2320, 2322 that are used to support the execution of a storage controller application 2324, 2326 are oversized and that cost savings could be gained by switching to a smaller, less powerful cloud computing instance, the monitoring module may create a new, less powerful (and less expensive) cloud computing instance that includes the storage controller application such that the new, less powerful cloud computing instance can begin operating as the primary controller.

The storage systems described above may carry out intelligent data backup techniques through which data stored in the storage system may be copied and stored in a distinct location to avoid data loss in the event of equipment failure or some other form of catastrophe. For example, the storage systems described above may be configured to examine each backup to avoid restoring the storage system to an undesirable state. Consider an example in which malware infects the storage system. In such an example, the storage system may include software resources 2314 that can scan each backup to identify backups that were captured before the malware infected the storage system and those backups that were captured after the malware infected the storage system. In such an example, the storage system may restore itself from a backup that does not include the malware—or at least not restore the portions of a backup that contained the malware. In such an example, the storage system may include software resources 2314 that can scan each backup to identify the presences of malware (or a virus, or some other undesirable), for example, by identifying write operations that were serviced by the storage system and originated from a network subnet that is suspected to have delivered the malware, by identifying write operations that were serviced by the storage system and originated from a user that is suspected to have delivered the malware, by identifying write operations that were serviced by the storage system and examining the content of the write operation against fingerprints of the malware, and in many other ways.

Readers will further appreciate that the backups (often in the form of one or more snapshots) may also be utilized to perform rapid recovery of the storage system. Consider an example in which the storage system is infected with ransomware that locks users out of the storage system. In such an example, software resources 2314 within the storage system may be configured to detect the presence of ransomware and may be further configured to restore the storage system to a point-in-time, using the retained backups, prior to the point-in-time at which the ransomware infected the storage system. In such an example, the presence of ransomware may be explicitly detected through the use of software tools utilized by the system, through the use of a key (e.g., a USB drive) that is inserted into the storage system, or in a similar way. Likewise, the presence of ransomware may be inferred in response to system activity meeting a predetermined fingerprint such as, for example, no reads or writes coming into the system for a predetermined period of time.

Readers will appreciate that the various components described above may be grouped into one or more optimized computing packages as converged infrastructures. Such converged infrastructures may include pools of computers, storage and networking resources that can be shared by multiple applications and managed in a collective manner using policy-driven processes. Such converged infrastructures may be implemented with a converged infrastructure reference architecture, with standalone appliances, with a software driven hyper-converged approach (e.g., hyper-converged infrastructures), or in other ways.

Readers will appreciate that the storage systems described in this disclosure may be useful for supporting various types of software applications. In fact, the storage systems may be ‘application aware’ in the sense that the storage systems may obtain, maintain, or otherwise have access to information describing connected applications (e.g., applications that utilize the storage systems) to optimize the operation of the storage system based on intelligence about the applications and their utilization patterns. For example, the storage system may optimize data layouts, optimize caching behaviors, optimize ‘QoS’ levels, or perform some other optimization that is designed to improve the storage performance that is experienced by the application.

As an example of one type of application that may be supported by the storage systems describe herein, the storage system 2306 may be useful in supporting artificial intelligence (‘AI’) applications, database applications, XOps projects (e.g., DevOps projects, DataOps projects, MLOps projects, ModelOps projects, PlatformOps projects), electronic design automation tools, event-driven software applications, high performance computing applications, simulation applications, high-speed data capture and analysis applications, machine learning applications, media production applications, media serving applications, picture archiving and communication systems (‘PACS’) applications, software development applications, virtual reality applications, augmented reality applications, and many other types of applications by providing storage resources to such applications.

In view of the fact that the storage systems include compute resources, storage resources, and a wide variety of other resources, the storage systems may be well suited to support applications that are resource intensive such as, for example, AI applications. AI applications may be deployed in a variety of fields, including: predictive maintenance in manufacturing and related fields, healthcare applications such as patient data & risk analytics, retail and marketing deployments (e.g., search advertising, social media advertising), supply chains solutions, fintech solutions such as business analytics & reporting tools, operational deployments such as real-time analytics tools, application performance management tools, IT infrastructure management tools, and many others.

Such AI applications may enable devices to perceive their environment and take actions that maximize their chance of success at some goal. Examples of such AI applications can include IBM Watson™, Microsoft Oxford™, Google DeepMind™, Baidu Minwa™, and others.

The storage systems described above may also be well suited to support other types of applications that are resource intensive such as, for example, machine learning applications. Machine learning applications may perform various types of data analysis to automate analytical model building. Using algorithms that iteratively learn from data, machine learning applications can enable computers to learn without being explicitly programmed. One particular area of machine learning is referred to as reinforcement learning, which involves taking suitable actions to maximize reward in a particular situation.

In addition to the resources already described, the storage systems described above may also include graphics processing units (‘GPUs’), occasionally referred to as visual processing unit (‘VPUs’). Such GPUs may be embodied as specialized electronic circuits that rapidly manipulate and alter memory to accelerate the creation of images in a frame buffer intended for output to a display device. Such GPUs may be included within any of the computing devices that are part of the storage systems described above, including as one of many individually scalable components of a storage system, where other examples of individually scalable components of such storage system can include storage components, memory components, compute components (e.g., CPUs, FPGAs, ASICs), networking components, software components, and others. In addition to GPUs, the storage systems described above may also include neural network processors (‘NNPs’) for use in various aspects of neural network processing. Such NNPs may be used in place of (or in addition to) GPUs and may also be independently scalable.

As described above, the storage systems described herein may be configured to support artificial intelligence applications, machine learning applications, big data analytics applications, and many other types of applications. The rapid growth in these sort of applications is being driven by three technologies: deep learning (DL), GPU processors, and Big Data. Deep learning is a computing model that makes use of massively parallel neural networks inspired by the human brain. Instead of experts handcrafting software, a deep learning model writes its own software by learning from lots of examples. Such GPUs may include thousands of cores that are well-suited to run algorithms that loosely represent the parallel nature of the human brain.

Advances in deep neural networks, including the development of multi-layer neural networks, have ignited a new wave of algorithms and tools for data scientists to tap into their data with artificial intelligence (AI). With improved algorithms, larger data sets, and various frameworks (including open-source software libraries for machine learning across a range of tasks), data scientists are tackling new use cases like autonomous driving vehicles, natural language processing and understanding, computer vision, machine reasoning, strong AI, and many others. Applications of such techniques may include: machine and vehicular object detection, identification and avoidance; visual recognition, classification and tagging; algorithmic financial trading strategy performance management; simultaneous localization and mapping; predictive maintenance of high-value machinery; prevention against cyber security threats, expertise automation; image recognition and classification; question answering; robotics; text analytics (extraction, classification) and text generation and translation; and many others. Applications of AI techniques has materialized in a wide array of products include, for example, Amazon Echo's speech recognition technology that allows users to talk to their machines, Google Translate™ which allows for machine-based language translation, Spotify's Discover Weekly that provides recommendations on new songs and artists that a user may like based on the user's usage and traffic analysis, Quill's text generation offering that takes structured data and turns it into narrative stories, Chatbots that provide real-time, contextually specific answers to questions in a dialog format, and many others.

Data is the heart of modern AI and deep learning algorithms. Before training can begin, one problem that must be addressed revolves around collecting the labeled data that is crucial for training an accurate AI model. A full scale AI deployment may be required to continuously collect, clean, transform, label, and store large amounts of data. Adding additional high quality data points directly translates to more accurate models and better insights. Data samples may undergo a series of processing steps including, but not limited to: 1) ingesting the data from an external source into the training system and storing the data in raw form, 2) cleaning and transforming the data in a format convenient for training, including linking data samples to the appropriate label, 3) exploring parameters and models, quickly testing with a smaller dataset, and iterating to converge on the most promising models to push into the production cluster, 4) executing training phases to select random batches of input data, including both new and older samples, and feeding those into production GPU servers for computation to update model parameters, and 5) evaluating including using a holdback portion of the data not used in training in order to evaluate model accuracy on the holdout data. This lifecycle may apply for any type of parallelized machine learning, not just neural networks or deep learning. For example, standard machine learning frameworks may rely on CPUs instead of GPUs but the data ingest and training workflows may be the same. Readers will appreciate that a single shared storage data hub creates a coordination point throughout the lifecycle without the need for extra data copies among the ingest, preprocessing, and training stages. Rarely is the ingested data used for only one purpose, and shared storage gives the flexibility to train multiple different models or apply traditional analytics to the data.

Readers will appreciate that each stage in the AI data pipeline may have varying requirements from the data hub (e.g., the storage system or collection of storage systems). Scale-out storage systems must deliver uncompromising performance for all manner of access types and patterns—from small, metadata-heavy to large files, from random to sequential access patterns, and from low to high concurrency. The storage systems described above may serve as an ideal AI data hub as the systems may service unstructured workloads. In the first stage, data is ideally ingested and stored on to the same data hub that following stages will use, in order to avoid excess data copying. The next two steps can be done on a standard compute server that optionally includes a GPU, and then in the fourth and last stage, full training production jobs are run on powerful GPU-accelerated servers. Often, there is a production pipeline alongside an experimental pipeline operating on the same dataset. Further, the GPU-accelerated servers can be used independently for different models or joined together to train on one larger model, even spanning multiple systems for distributed training. If the shared storage tier is slow, then data must be copied to local storage for each phase, resulting in wasted time staging data onto different servers. The ideal data hub for the AI training pipeline delivers performance similar to data stored locally on the server node while also having the simplicity and performance to enable all pipeline stages to operate concurrently.

In order for the storage systems described above to serve as a data hub or as part of an AI deployment, in some embodiments the storage systems may be configured to provide DMA between storage devices that are included in the storage systems and one or more GPUs that are used in an AI or big data analytics pipeline. The one or more GPUs may be coupled to the storage system, for example, via NVMe-over-Fabrics (‘NVMe-oF’) such that bottlenecks such as the host CPU can be bypassed and the storage system (or one of the components contained therein) can directly access GPU memory. In such an example, the storage systems may leverage API hooks to the GPUs to transfer data directly to the GPUs. For example, the GPUs may be embodied as Nvidia™ GPUs and the storage systems may support GPUDirect Storage (‘GDS’) software, or have similar proprietary software, that enables the storage system to transfer data to the GPUs via RDMA or similar mechanism.

Although the preceding paragraphs discuss deep learning applications, readers will appreciate that the storage systems described herein may also be part of a distributed deep learning (‘DDL’) platform to support the execution of DDL algorithms. The storage systems described above may also be paired with other technologies such as TensorFlow, an open-source software library for dataflow programming across a range of tasks that may be used for machine learning applications such as neural networks, to facilitate the development of such machine learning models, applications, and so on.

The storage systems described above may also be used in a neuromorphic computing environment. Neuromorphic computing is a form of computing that mimics brain cells. To support neuromorphic computing, an architecture of interconnected “neurons” replace traditional computing models with low-powered signals that go directly between neurons for more efficient computation. Neuromorphic computing may make use of very-large-scale integration (VLSI) systems containing electronic analog circuits to mimic neuro-biological architectures present in the nervous system, as well as analog, digital, mixed-mode analog/digital VLSI, and software systems that implement models of neural systems for perception, motor control, or multisensory integration.

Readers will appreciate that the storage systems described above may be configured to support the storage or use of (among other types of data) blockchains and derivative items such as, for example, open source blockchains and related tools that are part of the IBM™ Hyperledger project, permissioned blockchains in which a certain number of trusted parties are allowed to access the block chain, blockchain products that enable developers to build their own distributed ledger projects, and others. Blockchains and the storage systems described herein may be leveraged to support on-chain storage of data as well as off-chain storage of data.

Off-chain storage of data can be implemented in a variety of ways and can occur when the data itself is not stored within the blockchain. For example, in one embodiment, a hash function may be utilized and the data itself may be fed into the hash function to generate a hash value. In such an example, the hashes of large pieces of data may be embedded within transactions, instead of the data itself. Readers will appreciate that, in other embodiments, alternatives to blockchains may be used to facilitate the decentralized storage of information.

For example, one alternative to a blockchain that may be used is a blockweave. While conventional blockchains store every transaction to achieve validation, a blockweave permits secure decentralization without the usage of the entire chain, thereby enabling low cost on-chain storage of data. Such blockweaves may utilize a consensus mechanism that is based on proof of access (PoA) and proof of work (PoW).

The storage systems described above may, either alone or in combination with other computing devices, be used to support in-memory computing applications. In-memory computing involves the storage of information in RAM that is distributed across a cluster of computers. Readers will appreciate that the storage systems described above, especially those that are configurable with customizable amounts of processing resources, storage resources, and memory resources (e.g., those systems in which blades that contain configurable amounts of each type of resource), may be configured in a way so as to provide an infrastructure that can support in-memory computing. Likewise, the storage systems described above may include component parts (e.g., NVDIMMs, 3D crosspoint storage that provide fast random access memory that is persistent) that can actually provide for an improved in-memory computing environment as compared to in-memory computing environments that rely on RAM distributed across dedicated servers.

In some embodiments, the storage systems described above may be configured to operate as a hybrid in-memory computing environment that includes a universal interface to all storage media (e.g., RAM, flash storage, 3D crosspoint storage). In such embodiments, users may have no knowledge regarding the details of where their data is stored but they can still use the same full, unified API to address data. In such embodiments, the storage system may (in the background) move data to the fastest layer available—including intelligently placing the data in dependence upon various characteristics of the data or in dependence upon some other heuristic. In such an example, the storage systems may even make use of existing products such as Apache Ignite and GridGain to move data between the various storage layers, or the storage systems may make use of custom software to move data between the various storage layers. The storage systems described herein may implement various optimizations to improve the performance of in-memory computing such as, for example, having computations occur as close to the data as possible.

Readers will further appreciate that in some embodiments, the storage systems described above may be paired with other resources to support the applications described above. For example, one infrastructure could include primary compute in the form of servers and workstations which specialize in using General-purpose computing on graphics processing units (‘GPGPU’) to accelerate deep learning applications that are interconnected into a computation engine to train parameters for deep neural networks. Each system may have Ethernet external connectivity, InfiniBand external connectivity, some other form of external connectivity, or some combination thereof. In such an example, the GPUs can be grouped for a single large training or used independently to train multiple models. The infrastructure could also include a storage system such as those described above to provide, for example, a scale-out all-flash file or object store through which data can be accessed via high-performance protocols such as NFS, S3, and so on. The infrastructure can also include, for example, redundant top-of-rack Ethernet switches connected to storage and compute via ports in MLAG port channels for redundancy. The infrastructure could also include additional compute in the form of whitebox servers, optionally with GPUs, for data ingestion, pre-processing, and model debugging. Readers will appreciate that additional infrastructures are also be possible.

Readers will appreciate that the storage systems described above, either alone or in coordination with other computing machinery may be configured to support other AI related tools. For example, the storage systems may make use of tools like ONXX or other open neural network exchange formats that make it easier to transfer models written in different AI frameworks. Likewise, the storage systems may be configured to support tools like Amazon's Gluon that allow developers to prototype, build, and train deep learning models. In fact, the storage systems described above may be part of a larger platform, such as IBM™ Cloud Private for Data, that includes integrated data science, data engineering and application building services.

Readers will further appreciate that the storage systems described above may also be deployed as an edge solution. Such an edge solution may be in place to optimize cloud computing systems by performing data processing at the edge of the network, near the source of the data. Edge computing can push applications, data and computing power (i.e., services) away from centralized points to the logical extremes of a network. Through the use of edge solutions such as the storage systems described above, computational tasks may be performed using the compute resources provided by such storage systems, data may be storage using the storage resources of the storage system, and cloud-based services may be accessed through the use of various resources of the storage system (including networking resources). By performing computational tasks on the edge solution, storing data on the edge solution, and generally making use of the edge solution, the consumption of expensive cloud-based resources may be avoided and, in fact, performance improvements may be experienced relative to a heavier reliance on cloud-based resources.

While many tasks may benefit from the utilization of an edge solution, some particular uses may be especially suited for deployment in such an environment. For example, devices like drones, autonomous cars, robots, and others may require extremely rapid processing—so fast, in fact, that sending data up to a cloud environment and back to receive data processing support may simply be too slow. As an additional example, some IoT devices such as connected video cameras may not be well-suited for the utilization of cloud-based resources as it may be impractical (not only from a privacy perspective, security perspective, or a financial perspective) to send the data to the cloud simply because of the pure volume of data that is involved. As such, many tasks that really on data processing, storage, or communications may be better suited by platforms that include edge solutions such as the storage systems described above.

The storage systems described above may alone, or in combination with other computing resources, serves as a network edge platform that combines compute resources, storage resources, networking resources, cloud technologies and network virtualization technologies, and so on. As part of the network, the edge may take on characteristics similar to other network facilities, from the customer premise and backhaul aggregation facilities to Points of Presence (PoPs) and regional data centers. Readers will appreciate that network workloads, such as Virtual Network Functions (VNFs) and others, will reside on the network edge platform. Enabled by a combination of containers and virtual machines, the network edge platform may rely on controllers and schedulers that are no longer geographically co-located with the data processing resources. The functions, as microservices, may split into control planes, user and data planes, or even state machines, allowing for independent optimization and scaling techniques to be applied. Such user and data planes may be enabled through increased accelerators, both those residing in server platforms, such as FPGAs and Smart NICs, and through SDN-enabled merchant silicon and programmable ASICs.

The storage systems described above may also be optimized for use in big data analytics, including being leveraged as part of a composable data analytics pipeline where containerized analytics architectures, for example, make analytics capabilities more composable. Big data analytics may be generally described as the process of examining large and varied data sets to uncover hidden patterns, unknown correlations, market trends, customer preferences and other useful information that can help organizations make more-informed business decisions. As part of that process, semi-structured and unstructured data such as, for example, internet clickstream data, web server logs, social media content, text from customer emails and survey responses, mobile-phone call-detail records, IoT sensor data, and other data may be converted to a structured form.

The storage systems described above may also support (including implementing as a system interface) applications that perform tasks in response to human speech. For example, the storage systems may support the execution intelligent personal assistant applications such as, for example, Amazon's Alexa™, Apple Siri™, Google Voice™, Samsung Bixby™, Microsoft Cortana™, and others. While the examples described in the previous sentence make use of voice as input, the storage systems described above may also support chatbots, talkbots, chatterbots, or artificial conversational entities or other applications that are configured to conduct a conversation via auditory or textual methods. Likewise, the storage system may actually execute such an application to enable a user such as a system administrator to interact with the storage system via speech. Such applications are generally capable of voice interaction, music playback, making to-do lists, setting alarms, streaming podcasts, playing audiobooks, and providing weather, traffic, and other real time information, such as news, although in embodiments in accordance with the present disclosure, such applications may be utilized as interfaces to various system management operations.

The storage systems described above may also implement AI platforms for delivering on the vision of self-driving storage. Such AI platforms may be configured to deliver global predictive intelligence by collecting and analyzing large amounts of storage system telemetry data points to enable effortless management, analytics and support. In fact, such storage systems may be capable of predicting both capacity and performance, as well as generating intelligent advice on workload deployment, interaction and optimization. Such AI platforms may be configured to scan all incoming storage system telemetry data against a library of issue fingerprints to predict and resolve incidents in real-time, before they impact customer environments, and captures hundreds of variables related to performance that are used to forecast performance load.

The storage systems described above may support the serialized or simultaneous execution of artificial intelligence applications, machine learning applications, data analytics applications, data transformations, and other tasks that collectively may form an AI ladder. Such an AI ladder may effectively be formed by combining such elements to form a complete data science pipeline, where exist dependencies between elements of the AI ladder. For example, AI may require that some form of machine learning has taken place, machine learning may require that some form of analytics has taken place, analytics may require that some form of data and information architecting has taken place, and so on. As such, each element may be viewed as a rung in an AI ladder that collectively can form a complete and sophisticated AI solution.

The storage systems described above may also, either alone or in combination with other computing environments, be used to deliver an AI everywhere experience where AI permeates wide and expansive aspects of business and life. For example, AI may play an important role in the delivery of deep learning solutions, deep reinforcement learning solutions, artificial general intelligence solutions, autonomous vehicles, cognitive computing solutions, commercial UAVs or drones, conversational user interfaces, enterprise taxonomies, ontology management solutions, machine learning solutions, smart dust, smart robots, smart workplaces, and many others.

The storage systems described above may also, either alone or in combination with other computing environments, be used to deliver a wide range of transparently immersive experiences (including those that use digital twins of various “things” such as people, places, processes, systems, and so on) where technology can introduce transparency between people, businesses, and things. Such transparently immersive experiences may be delivered as augmented reality technologies, connected homes, virtual reality technologies, brain-computer interfaces, human augmentation technologies, nanotube electronics, volumetric displays, 4D printing technologies, or others.

The storage systems described above may also, either alone or in combination with other computing environments, be used to support a wide variety of digital platforms. Such digital platforms can include, for example, 5G wireless systems and platforms, digital twin platforms, edge computing platforms, IoT platforms, quantum computing platforms, serverless PaaS, software-defined security, neuromorphic computing platforms, and so on.

The storage systems described above may also be part of a multi-cloud environment in which multiple cloud computing and storage services are deployed in a single heterogeneous architecture. In order to facilitate the operation of such a multi-cloud environment, DevOps tools may be deployed to enable orchestration across clouds. Likewise, continuous development and continuous integration tools may be deployed to standardize processes around continuous integration and delivery, new feature rollout and provisioning cloud workloads. By standardizing these processes, a multi-cloud strategy may be implemented that enables the utilization of the best provider for each workload.

The storage systems described above may be used as a part of a platform to enable the use of crypto-anchors that may be used to authenticate a product's origins and contents to ensure that it matches a blockchain record associated with the product. Similarly, as part of a suite of tools to secure data stored on the storage system, the storage systems described above may implement various encryption technologies and schemes, including lattice cryptography. Lattice cryptography can involve constructions of cryptographic primitives that involve lattices, either in the construction itself or in the security proof Unlike public-key schemes such as the RSA, Diffie-Hellman or Elliptic-Curve cryptosystems, which are easily attacked by a quantum computer, some lattice-based constructions appear to be resistant to attack by both classical and quantum computers.

A quantum computer is a device that performs quantum computing. Quantum computing is computing using quantum-mechanical phenomena, such as superposition and entanglement. Quantum computers differ from traditional computers that are based on transistors, as such traditional computers require that data be encoded into binary digits (bits), each of which is always in one of two definite states (0 or 1). In contrast to traditional computers, quantum computers use quantum bits, which can be in superpositions of states. A quantum computer maintains a sequence of qubits, where a single qubit can represent a one, a zero, or any quantum superposition of those two qubit states. A pair of qubits can be in any quantum superposition of 4 states, and three qubits in any superposition of 8 states. A quantum computer with n qubits can generally be in an arbitrary superposition of up to 2\hat{ }n different states simultaneously, whereas a traditional computer can only be in one of these states at any one time. A quantum Turing machine is a theoretical model of such a computer.

The storage systems described above may also be paired with FPGA-accelerated servers as part of a larger AI or ML infrastructure. Such FPGA-accelerated servers may reside near (e.g., in the same data center) the storage systems described above or even incorporated into an appliance that includes one or more storage systems, one or more FPGA-accelerated servers, networking infrastructure that supports communications between the one or more storage systems and the one or more FPGA-accelerated servers, as well as other hardware and software components. Alternatively, FPGA-accelerated servers may reside within a cloud computing environment that may be used to perform compute-related tasks for AI and ML jobs. Any of the embodiments described above may be used to collectively serve as a FPGA-based AI or ML platform. Readers will appreciate that, in some embodiments of the FPGA-based AI or ML platform, the FPGAs that are contained within the FPGA-accelerated servers may be reconfigured for different types of ML models (e.g., LSTMs, CNNs, GRUs). The ability to reconfigure the FPGAs that are contained within the FPGA-accelerated servers may enable the acceleration of a ML or AI application based on the most optimal numerical precision and memory model being used. Readers will appreciate that by treating the collection of FPGA-accelerated servers as a pool of FPGAs, any CPU in the data center may utilize the pool of FPGAs as a shared hardware microservice, rather than limiting a server to dedicated accelerators plugged into it.

The FPGA-accelerated servers and the GPU-accelerated servers described above may implement a model of computing where, rather than keeping a small amount of data in a CPU and running a long stream of instructions over it as occurred in more traditional computing models, the machine learning model and parameters are pinned into the high-bandwidth on-chip memory with lots of data streaming though the high-bandwidth on-chip memory. FPGAs may even be more efficient than GPUs for this computing model, as the FPGAs can be programmed with only the instructions needed to run this kind of computing model.

The storage systems described above may be configured to provide parallel storage, for example, through the use of a parallel file system such as BeeGFS. Such parallel files systems may include a distributed metadata architecture. For example, the parallel file system may include a plurality of metadata servers across which metadata is distributed, as well as components that include services for clients and storage servers.

The systems described above can support the execution of a wide array of software applications. Such software applications can be deployed in a variety of ways, including container-based deployment models. Containerized applications may be managed using a variety of tools. For example, containerized applications may be managed using Docker Swarm, Kubernetes, and others. Containerized applications may be used to facilitate a serverless, cloud native computing deployment and management model for software applications. In support of a serverless, cloud native computing deployment and management model for software applications, containers may be used as part of an event handling mechanisms (e.g., AWS Lambdas) such that various events cause a containerized application to be spun up to operate as an event handler.

The systems described above may be deployed in a variety of ways, including being deployed in ways that support fifth generation (‘5G’) networks. 5G networks may support substantially faster data communications than previous generations of mobile communications networks and, as a consequence may lead to the disaggregation of data and computing resources as modern massive data centers may become less prominent and may be replaced, for example, by more-local, micro data centers that are close to the mobile-network towers. The systems described above may be included in such local, micro data centers and may be part of or paired to multi-access edge computing (‘MEC’) systems. Such MEC systems may enable cloud computing capabilities and an IT service environment at the edge of the cellular network. By running applications and performing related processing tasks closer to the cellular customer, network congestion may be reduced and applications may perform better.

The storage systems described above may also be configured to implement NVMe Zoned Namespaces. Through the use of NVMe Zoned Namespaces, the logical address space of a namespace is divided into zones. Each zone provides a logical block address range that must be written sequentially and explicitly reset before rewriting, thereby enabling the creation of namespaces that expose the natural boundaries of the device and offload management of internal mapping tables to the host. In order to implement NVMe Zoned Name Spaces (‘ZNS’), ZNS SSDs or some other form of zoned block devices may be utilized that expose a namespace logical address space using zones. With the zones aligned to the internal physical properties of the device, several inefficiencies in the placement of data can be eliminated. In such embodiments, each zone may be mapped, for example, to a separate application such that functions like wear levelling and garbage collection could be performed on a per-zone or per-application basis rather than across the entire device. In order to support ZNS, the storage controllers described herein may be configured with to interact with zoned block devices through the usage of, for example, the Linux™ kernel zoned block device interface or other tools.

The storage systems described above may also be configured to implement zoned storage in other ways such as, for example, through the usage of shingled magnetic recording (SMR) storage devices. In examples where zoned storage is used, device-managed embodiments may be deployed where the storage devices hide this complexity by managing it in the firmware, presenting an interface like any other storage device. Alternatively, zoned storage may be implemented via a host-managed embodiment that depends on the operating system to know how to handle the drive, and only write sequentially to certain regions of the drive. Zoned storage may similarly be implemented using a host-aware embodiment in which a combination of a drive managed and host managed implementation is deployed.

The storage systems described herein may be used to form a data lake. A data lake may operate as the first place that an organization's data flows to, where such data may be in a raw format. Metadata tagging may be implemented to facilitate searches of data elements in the data lake, especially in embodiments where the data lake contains multiple stores of data, in formats not easily accessible or readable (e.g., unstructured data, semi-structured data, structured data). From the data lake, data may go downstream to a data warehouse where data may be stored in a more processed, packaged, and consumable format. The storage systems described above may also be used to implement such a data warehouse. In addition, a data mart or data hub may allow for data that is even more easily consumed, where the storage systems described above may also be used to provide the underlying storage resources necessary for a data mart or data hub. In embodiments, queries the data lake may require a schema-on-read approach, where data is applied to a plan or schema as it is pulled out of a stored location, rather than as it goes into the stored location.

The storage systems described herein may also be configured implement a recovery point objective (‘RPO’), which may be establish by a user, established by an administrator, established as a system default, established as part of a storage class or service that the storage system is participating in the delivery of, or in some other way. A “recovery point objective” is a goal for the maximum time difference between the last update to a source dataset and the last recoverable replicated dataset update that would be correctly recoverable, given a reason to do so, from a continuously or frequently updated copy of the source dataset. An update is correctly recoverable if it properly takes into account all updates that were processed on the source dataset prior to the last recoverable replicated dataset update.

In synchronous replication, the RPO would be zero, meaning that under normal operation, all completed updates on the source dataset should be present and correctly recoverable on the copy dataset. In best effort nearly synchronous replication, the RPO can be as low as a few seconds. In snapshot-based replication, the RPO can be roughly calculated as the interval between snapshots plus the time to transfer the modifications between a previous already transferred snapshot and the most recent to-be-replicated snapshot.

If updates accumulate faster than they are replicated, then an RPO can be missed. If more data to be replicated accumulates between two snapshots, for snapshot-based replication, than can be replicated between taking the snapshot and replicating that snapshot's cumulative updates to the copy, then the RPO can be missed. If, again in snapshot-based replication, data to be replicated accumulates at a faster rate than could be transferred in the time between subsequent snapshots, then replication can start to fall further behind which can extend the miss between the expected recovery point objective and the actual recovery point that is represented by the last correctly replicated update.

The storage systems described above may also be part of a shared nothing storage cluster. In a shared nothing storage cluster, each node of the cluster has local storage and communicates with other nodes in the cluster through networks, where the storage used by the cluster is (in general) provided only by the storage connected to each individual node. A collection of nodes that are synchronously replicating a dataset may be one example of a shared nothing storage cluster, as each storage system has local storage and communicates to other storage systems through a network, where those storage systems do not (in general) use storage from somewhere else that they share access to through some kind of interconnect. In contrast, some of the storage systems described above are themselves built as a shared-storage cluster, since there are drive shelves that are shared by the paired controllers. Other storage systems described above, however, are built as a shared nothing storage cluster, as all storage is local to a particular node (e.g., a blade) and all communication is through networks that link the compute nodes together.

In other embodiments, other forms of a shared nothing storage cluster can include embodiments where any node in the cluster has a local copy of all storage they need, and where data is mirrored through a synchronous style of replication to other nodes in the cluster either to ensure that the data isn't lost or because other nodes are also using that storage. In such an embodiment, if a new cluster node needs some data, that data can be copied to the new node from other nodes that have copies of the data.

In some embodiments, mirror-copy-based shared storage clusters may store multiple copies of all the cluster's stored data, with each subset of data replicated to a particular set of nodes, and different subsets of data replicated to different sets of nodes. In some variations, embodiments may store all of the cluster's stored data in all nodes, whereas in other variations nodes may be divided up such that a first set of nodes will all store the same set of data and a second, different set of nodes will all store a different set of data.

Readers will appreciate that RAFT-based databases (e.g., etcd) may operate like shared-nothing storage clusters where all RAFT nodes store all data. The amount of data stored in a RAFT cluster, however, may be limited so that extra copies don't consume too much storage. A container server cluster might also be able to replicate all data to all cluster nodes, presuming the containers don't tend to be too large and their bulk data (the data manipulated by the applications that run in the containers) is stored elsewhere such as in an S3 cluster or an external file server. In such an example, the container storage may be provided by the cluster directly through its shared-nothing storage model, with those containers providing the images that form the execution environment for parts of an application or service.

For further explanation, FIG. 23D illustrates an exemplary computing device 2350 that may be specifically configured to perform one or more of the processes described herein. As shown in FIG. 23D, computing device 2350 may include a communication interface 2352, a processor 2354, a storage device 2356, and an input/output (“I/O”) module 2358 communicatively connected one to another via a communication infrastructure 2360. While an exemplary computing device 2350 is shown in FIG. 23D, the components illustrated in FIG. 23D are not intended to be limiting. Additional or alternative components may be used in other embodiments. Components of computing device 2350 shown in FIG. 23D will now be described in additional detail.

Communication interface 2352 may be configured to communicate with one or more computing devices. Examples of communication interface 2352 include, without limitation, a wired network interface (such as a network interface card), a wireless network interface (such as a wireless network interface card), a modem, an audio/video connection, and any other suitable interface.

Processor 2354 generally represents any type or form of processing unit capable of processing data and/or interpreting, executing, and/or directing execution of one or more of the instructions, processes, and/or operations described herein. Processor 2354 may perform operations by executing computer-executable instructions 2362 (e.g., an application, software, code, and/or other executable data instance) stored in storage device 2356.

Storage device 2356 may include one or more data storage media, devices, or configurations and may employ any type, form, and combination of data storage media and/or device. For example, storage device 2356 may include, but is not limited to, any combination of the non-volatile media and/or volatile media described herein. Electronic data, including data described herein, may be temporarily and/or permanently stored in storage device 2356. For example, data representative of computer-executable instructions 2362 configured to direct processor 2354 to perform any of the operations described herein may be stored within storage device 2356. In some examples, data may be arranged in one or more databases residing within storage device 2356.

I/O module 2358 may include one or more I/O modules configured to receive user input and provide user output. I/O module 2358 may include any hardware, firmware, software, or combination thereof supportive of input and output capabilities. For example, I/O module 2358 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 2358 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 2358 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 2350.

For further explanation, FIG. 23E illustrates an example of a fleet of storage systems 2376 for providing storage services (also referred to herein as ‘data services’). The fleet of storage systems 2376 depicted in FIG. 23E includes a plurality of storage systems 2374a, 2374b, 2374c, 2374d, 2374n that may each be similar to the storage systems described herein. The storage systems 2374a, 2374b, 2374c, 2374d, 2374n in the fleet of storage systems 2376 may be embodied as identical storage systems or as different types of storage systems. For example, two of the storage systems 2374a, 2374n depicted in FIG. 23E are depicted as being cloud-based storage systems, as the resources that collectively form each of the storage systems 2374a, 2374n are provided by distinct cloud services providers 2370, 2372. For example, the first cloud services provider 2370 may be Amazon AWS™ whereas the second cloud services provider 2372 is Microsoft Azure™, although in other embodiments one or more public clouds, private clouds, or combinations thereof may be used to provide the underlying resources that are used to form a particular storage system in the fleet of storage systems 2376.

The example depicted in FIG. 23E includes an edge management service 2382 for delivering storage services in accordance with some embodiments of the present disclosure. The storage services (also referred to herein as ‘data services’) that are delivered may include, for example, services to provide a certain amount of storage to a consumer, services to provide storage to a consumer in accordance with a predetermined service level agreement, services to provide storage to a consumer in accordance with predetermined regulatory requirements, and many others.

The edge management service 2382 depicted in FIG. 23E may be embodied, for example, as one or more modules of computer program instructions executing on computer hardware such as one or more computer processors. Alternatively, the edge management service 2382 may be embodied as one or more modules of computer program instructions executing on a virtualized execution environment such as one or more virtual machines, in one or more containers, or in some other way. In other embodiments, the edge management service 2382 may be embodied as a combination of the embodiments described above, including embodiments where the one or more modules of computer program instructions that are included in the edge management service 2382 are distributed across multiple physical or virtual execution environments.

The edge management service 2382 may operate as a gateway for providing storage services to storage consumers, where the storage services leverage storage offered by one or more storage systems 2374a, 2374b, 2374c, 2374d, 2374n. For example, the edge management service 2382 may be configured to provide storage services to host devices 2378a, 2378b, 2378c, 2378d, 2378n that are executing one or more applications that consume the storage services. In such an example, the edge management service 2382 may operate as a gateway between the host devices 2378a, 2378b, 2378c, 2378d, 2378n and the storage systems 2374a, 2374b, 2374c, 2374d, 2374n, rather than requiring that the host devices 2378a, 2378b, 2378c, 2378d, 2378n directly access the storage systems 2374a, 2374b, 2374c, 2374d, 2374n.

The edge management service 2382 of FIG. 23E exposes a storage services module 2380 to the host devices 2378a, 2378b, 2378c, 2378d, 2378n of FIG. 23E, although in other embodiments the edge management service 2382 may expose the storage services module 2380 to other consumers of the various storage services. The various storage services may be presented to consumers via one or more user interfaces, via one or more APIs, or through some other mechanism provided by the storage services module 2380. As such, the storage services module 2380 depicted in FIG. 23E may be embodied as one or more modules of computer program instructions executing on physical hardware, on a virtualized execution environment, or combinations thereof, where executing such modules causes enables a consumer of storage services to be offered, select, and access the various storage services.

The edge management service 2382 of FIG. 23E also includes a system management services module 2384. The system management services module 2384 of FIG. 23E includes one or more modules of computer program instructions that, when executed, perform various operations in coordination with the storage systems 2374a, 2374b, 2374c, 2374d, 2374n to provide storage services to the host devices 2378a, 2378b, 2378c, 2378d, 2378n. The system management services module 2384 may be configured, for example, to perform tasks such as provisioning storage resources from the storage systems 2374a, 2374b, 2374c, 2374d, 2374n via one or more APIs exposed by the storage systems 2374a, 2374b, 2374c, 2374d, 2374n, migrating datasets or workloads amongst the storage systems 2374a, 2374b, 2374c, 2374d, 2374n via one or more APIs exposed by the storage systems 2374a, 2374b, 2374c, 2374d, 2374n, setting one or more tunable parameters (i.e., one or more configurable settings) on the storage systems 2374a, 2374b, 2374c, 2374d, 2374n via one or more APIs exposed by the storage systems 2374a, 2374b, 2374c, 2374d, 2374n, and so on. For example, many of the services described below relate to embodiments where the storage systems 2374a, 2374b, 2374c, 2374d, 2374n are configured to operate in some way. In such examples, the system management services module 2384 may be responsible for using APIs (or some other mechanism) provided by the storage systems 2374a, 2374b, 2374c, 2374d, 2374n to configure the storage systems 2374a, 2374b, 2374c, 2374d, 2374n to operate in the ways described below.

In addition to configuring the storage systems 2374a, 2374b, 2374c, 2374d, 2374n, the edge management service 2382 itself may be configured to perform various tasks required to provide the various storage services. Consider an example in which the storage service includes a service that, when selected and applied, causes personally identifiable information (‘PII’) contained in a dataset to be obfuscated when the dataset is accessed. In such an example, the storage systems 2374a, 2374b, 2374c, 2374d, 2374n may be configured to obfuscate PII when servicing read requests directed to the dataset. Alternatively, the storage systems 2374a, 2374b, 2374c, 2374d, 2374n may service reads by returning data that includes the PII, but the edge management service 2382 itself may obfuscate the PII as the data is passed through the edge management service 2382 on its way from the storage systems 2374a, 2374b, 2374c, 2374d, 2374n to the host devices 2378a, 2378b, 2378c, 2378d, 2378n.

The storage systems 2374a, 2374b, 2374c, 2374d, 2374n depicted in FIG. 23E may be embodied as one or more of the storage systems described above with reference to FIGS. 1A-23D, including variations thereof. In fact, the storage systems 2374a, 2374b, 2374c, 2374d, 2374n may serve as a pool of storage resources where the individual components in that pool have different performance characteristics, different storage characteristics, and so on. For example, one of the storage systems 2374a may be a cloud-based storage system, another storage system 2374b may be a storage system that provides block storage, another storage system 2374c may be a storage system that provides file storage, another storage system 2374d may be a relatively high-performance storage system while another storage system 2374n may be a relatively low-performance storage system, and so on. In alternative embodiments, only a single storage system may be present.

The storage systems 2374a, 2374b, 2374c, 2374d, 2374n depicted in FIG. 23E may also be organized into different failure domains so that the failure of one storage system 2374a should be totally unrelated to the failure of another storage system 2374b. For example, each of the storage systems may receive power from independent power systems, each of the storage systems may be coupled for data communications over independent data communications networks, and so on. Furthermore, the storage systems in a first failure domain may be accessed via a first gateway whereas storage systems in a second failure domain may be accessed via a second gateway. For example, the first gateway may be a first instance of the edge management service 2382 and the second gateway may be a second instance of the edge management service 2382, including embodiments where each instance is distinct, or each instance is part of a distributed edge management service 2382.

As an illustrative example of available storage services, storage services may be presented to a user that are associated with different levels of data protection. For example, storage services may be presented to the user that, when selected and enforced, guarantee the user that data associated with that user will be protected such that various recovery point objectives (‘RPO’) can be guaranteed. A first available storage service may ensure, for example, that some dataset associated with the user will be protected such that any data that is more than 5 seconds old can be recovered in the event of a failure of the primary data store whereas a second available storage service may ensure that the dataset that is associated with the user will be protected such that any data that is more than 5 minutes old can be recovered in the event of a failure of the primary data store.

An additional example of storage services that may be presented to a user, selected by a user, and ultimately applied to a dataset associated with the user can include one or more data compliance services. Such data compliance services may be embodied, for example, as services that may be provided to consumers (i.e., a user) the data compliance services to ensure that the user's datasets are managed in a way to adhere to various regulatory requirements. For example, one or more data compliance services may be offered to a user to ensure that the user's datasets are managed in a way so as to adhere to the General Data Protection Regulation (‘GDPR’), one or data compliance services may be offered to a user to ensure that the user's datasets are managed in a way so as to adhere to the Sarbanes-Oxley Act of 2002 (‘SOX’), or one or more data compliance services may be offered to a user to ensure that the user's datasets are managed in a way so as to adhere to some other regulatory act. In addition, the one or more data compliance services may be offered to a user to ensure that the user's datasets are managed in a way so as to adhere to some non-governmental guidance (e.g., to adhere to best practices for auditing purposes), the one or more data compliance services may be offered to a user to ensure that the user's datasets are managed in a way so as to adhere to a particular clients or organizations requirements, and so on.

Consider an example in which a particular data compliance service is designed to ensure that a user's datasets are managed in a way so as to adhere to the requirements set forth in the GDPR. While a listing of all requirements of the GDPR can be found in the regulation itself, for the purposes of illustration, an example requirement set forth in the GDPR requires that pseudonymization processes must be applied to stored data in order to transform personal data in such a way that the resulting data cannot be attributed to a specific data subject without the use of additional information. For example, data encryption techniques can be applied to render the original data unintelligible, and such data encryption techniques cannot be reversed without access to the correct decryption key. As such, the GDPR may require that the decryption key be kept separately from the pseudonymised data. One particular data compliance service may be offered to ensure adherence to the requirements set forth in this paragraph.

In order to provide this particular data compliance service, the data compliance service may be presented to a user (e.g., via a GUI) and selected by the user. In response to receiving the selection of the particular data compliance service, one or more storage services policies may be applied to a dataset associated with the user to carry out the particular data compliance service. For example, a storage services policy may be applied requiring that the dataset be encrypted prior to be stored in a storage system, prior to being stored in a cloud environment, or prior to being stored elsewhere. In order to enforce this policy, a requirement may be enforced not only requiring that the dataset be encrypted when stored, but a requirement may be put in place requiring that the dataset be encrypted prior to transmitting the dataset (e.g., sending the dataset to another party). In such an example, a storage services policy may also be put in place requiring that any encryption keys used to encrypt the dataset are not stored on the same system that stores the dataset itself. Readers will appreciate that many other forms of data compliance services may be offered and implemented in accordance with embodiments of the present disclosure.

The storage systems 2374a, 2374b, 2374c, 2374d, 2374n in the fleet of storage systems 2376 may be managed collectively, for example, by one or more fleet management modules. The fleet management modules may be part of or separate from the system management services module 2384 depicted in FIG. 23E. The fleet management modules may perform tasks such as monitoring the health of each storage system in the fleet, initiating updates or upgrades on one or more storage systems in the fleet, migrating workloads for loading balancing or other performance purposes, and many other tasks. As such, and for many other reasons, the storage systems 2374a, 2374b, 2374c, 2374d, 2374n may be coupled to each other via one or more data communications links in order to exchange data between the storage systems 2374a, 2374b, 2374c, 2374d, 2374n.

The storage systems described herein may support various forms of data replication. For example, two or more of the storage systems may synchronously replicate a dataset between each other. In synchronous replication, distinct copies of a particular dataset may be maintained by multiple storage systems, but all accesses (e.g., a read) of the dataset should yield consistent results regardless of which storage system the access was directed to. For example, a read directed to any of the storage systems that are synchronously replicating the dataset should return identical results. As such, while updates to the version of the dataset need not occur at exactly the same time, precautions must be taken to ensure consistent accesses to the dataset. For example, if an update (e.g., a write) that is directed to the dataset is received by a first storage system, the update may only be acknowledged as being completed if all storage systems that are synchronously replicating the dataset have applied the update to their copies of the dataset. In such an example, synchronous replication may be carried out through the use of I/O forwarding (e.g., a write received at a first storage system is forwarded to a second storage system), communications between the storage systems (e.g., each storage system indicating that it has completed the update), or in other ways.

In other embodiments, a dataset may be replicated through the use of checkpoints. In checkpoint-based replication (also referred to as ‘nearly synchronous replication’), a set of updates to a dataset (e.g., one or more write operations directed to the dataset) may occur between different checkpoints, such that a dataset has been updated to a specific checkpoint only if all updates to the dataset prior to the specific checkpoint have been completed. Consider an example in which a first storage system stores a live copy of a dataset that is being accessed by users of the dataset. In this example, assume that the dataset is being replicated from the first storage system to a second storage system using checkpoint-based replication. For example, the first storage system may send a first checkpoint (at time t=O) to the second storage system, followed by a first set of updates to the dataset, followed by a second checkpoint (at time t=1), followed by a second set of updates to the dataset, followed by a third checkpoint (at time t=2). In such an example, if the second storage system has performed all updates in the first set of updates but has not yet performed all updates in the second set of updates, the copy of the dataset that is stored on the second storage system may be up-to-date until the second checkpoint. Alternatively, if the second storage system has performed all updates in both the first set of updates and the second set of updates, the copy of the dataset that is stored on the second storage system may be up-to-date until the third checkpoint. Readers will appreciate that various types of checkpoints may be used (e.g., metadata only checkpoints), checkpoints may be spread out based on a variety of factors (e.g., time, number of operations, an RPO setting), and so on.

In other embodiments, a dataset may be replicated through snapshot-based replication (also referred to as ‘asynchronous replication’). In snapshot-based replication, snapshots of a dataset may be sent from a replication source such as a first storage system to a replication target such as a second storage system. In such an embodiment, each snapshot may include the entire dataset or a subset of the dataset such as, for example, only the portions of the dataset that have changed since the last snapshot was sent from the replication source to the replication target. Readers will appreciate that snapshots may be sent on-demand, based on a policy that takes a variety of factors into consideration (e.g., time, number of operations, an RPO setting), or in some other way.

The storage systems described above may, either alone or in combination, by configured to serve as a continuous data protection store. A continuous data protection store is a feature of a storage system that records updates to a dataset in such a way that consistent images of prior contents of the dataset can be accessed with a low time granularity (often on the order of seconds, or even less), and stretching back for a reasonable period of time (often hours or days). These allow access to very recent consistent points in time for the dataset, and also allow access to access to points in time for a dataset that might have just preceded some event that, for example, caused parts of the dataset to be corrupted or otherwise lost, while retaining close to the maximum number of updates that preceded that event. Conceptually, they are like a sequence of snapshots of a dataset taken very frequently and kept for a long period of time, though continuous data protection stores are often implemented quite differently from snapshots. A storage system implementing a data continuous data protection store may further provide a means of accessing these points in time, accessing one or more of these points in time as snapshots or as cloned copies, or reverting the dataset back to one of those recorded points in time.

Over time, to reduce overhead, some points in the time held in a continuous data protection store can be merged with other nearby points in time, essentially deleting some of these points in time from the store. This can reduce the capacity needed to store updates. It may also be possible to convert a limited number of these points in time into longer duration snapshots. For example, such a store might keep a low granularity sequence of points in time stretching back a few hours from the present, with some points in time merged or deleted to reduce overhead for up to an additional day. Stretching back in the past further than that, some of these points in time could be converted to snapshots representing consistent point-in-time images from only every few hours.

Although some embodiments are described largely in the context of a storage system, readers of skill in the art will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

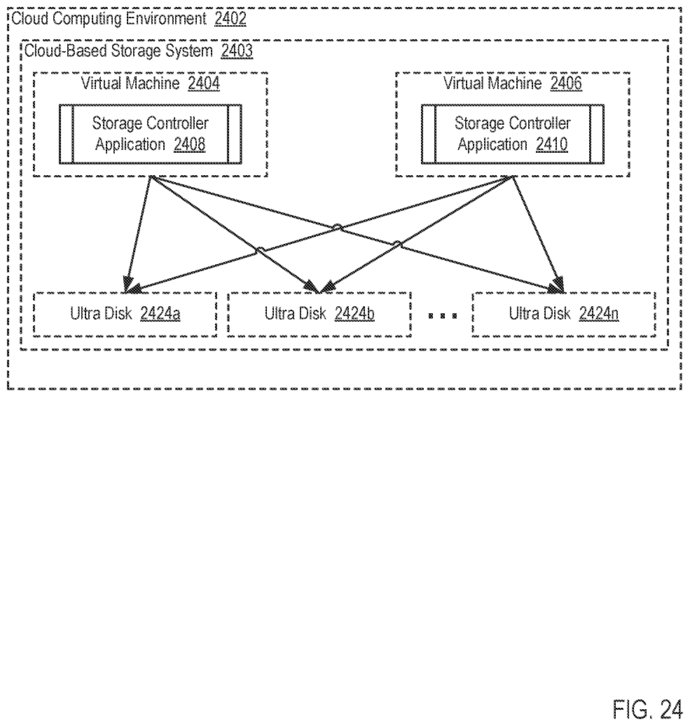

For further explanation, FIG. 24 sets forth an example of a cloud-based storage system (2403) in accordance with some embodiments of the present disclosure. In the example depicted in FIG. 24, the cloud-based storage system (2403) is created entirely in a cloud computing environment (2402) such as, for example, Amazon Web Services (‘AWS’), Microsoft Azure, Google Cloud Platform, IBM Cloud, Oracle Cloud, and others. The cloud-based storage system (2403) may be used to provide services similar to the services that may be provided by the storage systems described above. For example, the cloud-based storage system (2403) may be used to provide block storage services to users of the cloud-based storage system (2403), the cloud-based storage system (2403) may be used to provide storage services to users of the cloud-based storage system (2403) through the use of solid-state storage, and so on.

The cloud-based storage system (2403) depicted in FIG. 24 includes two virtual machines (2404, 2406) that each are used to support the execution of a storage controller application (2408, 2410). The virtual machines (2404, 2406) may be embodied, for example, as instances of cloud computing resources that may be provided by the cloud computing environment (2402) to support the execution of software applications such as the storage controller application (2408, 2410). In one embodiment, the virtual machines (2404, 2406) may be embodied as Azure H-Series Virtual Machines or as some other virtual machine. In other embodiments, other virtualized compute resources or compute environments such as containers may be utilized.

In the example method depicted in FIG. 24, the storage controller application (2408, 2410) may be embodied as a module of computer program instructions that, when executed, carries out various storage tasks. For example, the storage controller application (2408, 2410) may be embodied as a module of computer program instructions that, when executed, carries out the same tasks as the controllers (110A, 110B in FIG. 1A) described above such as writing data received from the users of the cloud-based storage system (2403) to the cloud-based storage system (2403), erasing data from the cloud-based storage system (2403), retrieving data from the cloud-based storage system (2403) and providing such data to users of the cloud-based storage system (2403), monitoring and reporting of disk utilization and performance, performing redundancy operations, such as Redundant Array of Independent Drives (‘RAID’) or RAID-like data redundancy operations, compressing data, encrypting data, deduplicating data, and so forth. Readers will appreciate that because there are two virtual machines (2404, 2406) that each include the storage controller application (2408, 2410), in some embodiments one virtual machine (2404) may operate as the primary controller as described above while the other virtual machine (2406) may operate as the secondary controller as described above. In such an example, in order to save costs, the virtual machine (2404) that operates as the primary controller may be deployed on a relatively high-performance and relatively expensive virtual machine instance while the virtual machine (2406) that operates as the secondary controller may be deployed on a relatively low-performance and relatively inexpensive virtual machine instance. Readers will appreciate that the storage controller application (2408, 2410) depicted in FIG. 24 may include identical source code that is executed within different virtual machines (2404, 2406).

Readers will appreciate that while the embodiments described above relate to embodiments where one virtual machine (2404) operates as the primary controller and the second virtual machine (2406) operates as the secondary controller, other embodiments are within the scope of the present disclosure. For example, each virtual machine (2404, 2406) may operate as a primary controller for some portion of the address space supported by the cloud-based storage system (2403), each virtual machine (2404, 2406) may operate as a primary controller where the servicing of I/O operations directed to the cloud-based storage system (2403) are divided in some other way, and so on. In fact, in other embodiments where costs savings may be prioritized over performance demands, only a single virtual machine may exist that contains the storage controller application. In such an example, a controller failure may take more time to recover from as a new virtual machine that includes the storage controller application would need to be spun up rather than having an already created virtual machine take on the role of servicing I/O operations that would have otherwise been handled by the failed virtual machine.

The cloud-based storage system (2403) depicted in FIG. 24 includes ultra disks (2424a, 2424b, 2424n). The ultra disks (2424a, 2424b, 2424n) depicted in FIG. 24 may be embodied, for example, as Azure ultra disks (2424a, 2424b, 2424n) that can be used to offer block storage resources to the connected virtual machines (2406, 2408). In such a way, the storage controller applications (2408, 2410) may include code that is identical to (or substantially identical to) the code that would be executed by the controllers in the storage systems described above. In these and similar embodiments, communications between the storage controller applications (2408, 2410) and the ultra disks (2424a, 2424b, 2424n) may utilize iSCSI, NVMe over TCP, messaging, a custom protocol, or in some other mechanism.

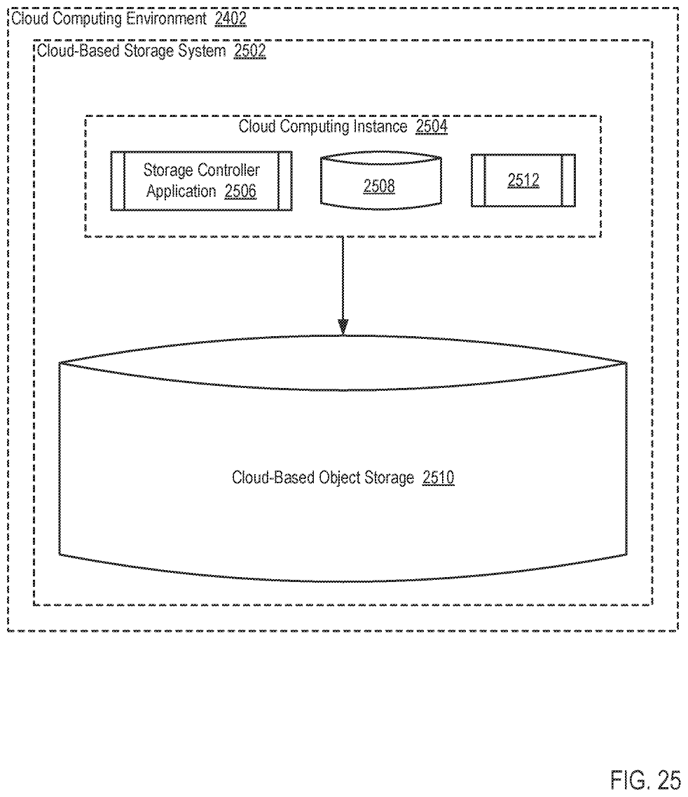

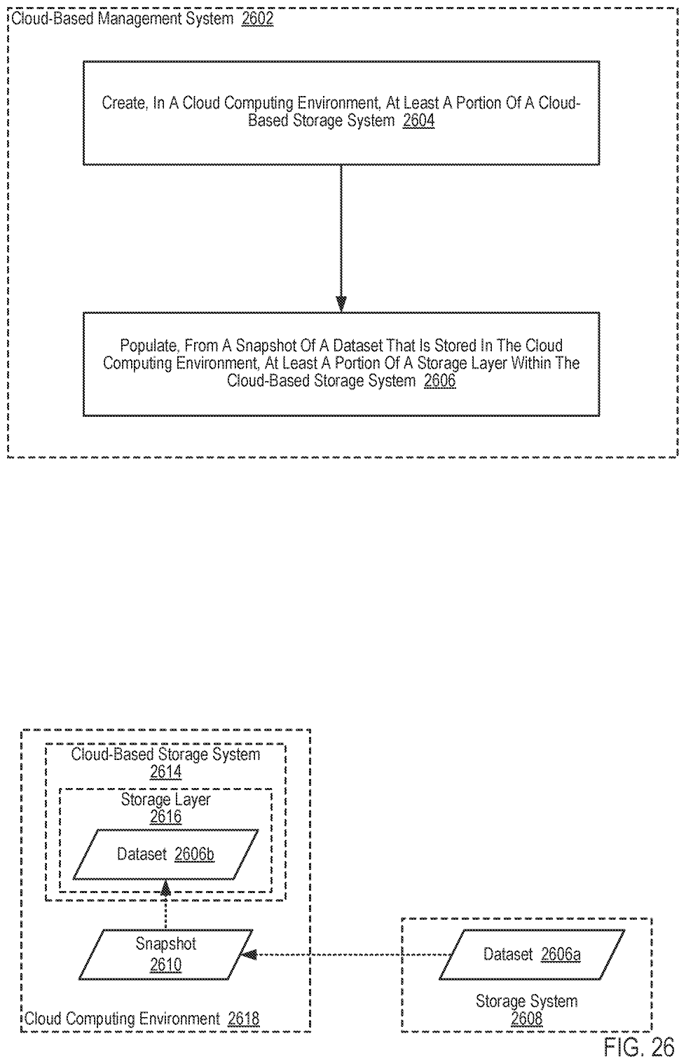

For further explanation, FIG. 25 sets forth an example of an additional cloud-based storage system (2502) in accordance with some embodiments of the present disclosure. In the example depicted in FIG. 25, the cloud-based storage system (2502) is created entirely in a cloud computing environment (2402) such as, for example, AWS, Microsoft Azure, Google Cloud Platform, IBM Cloud, Oracle Cloud, and others. The cloud-based storage system (2502) may be used to provide services similar to the services that may be provided by the storage systems described above. For example, the cloud-based storage system (2502) may be used to provide block storage services to users of the cloud-based storage system (2502), the cloud-based storage system (2403) may be used to provide storage services to users of the cloud-based storage system (2403) through the use of solid-state storage, and so on.

The cloud-based storage system (2502) depicted in FIG. 25 may operate in a manner that is somewhat similar to the cloud-based storage system (2403) depicted in FIG. 24, as the cloud-based storage system (2502) depicted in FIG. 25 includes a storage controller application (2506) that is being executed in a cloud computing instance (2504). In the example depicted in FIG. 25, however, the cloud computing instance (2504) that executes the storage controller application (2506) is a cloud computing instance (2504) with local storage (2508). In such an example, data written to the cloud-based storage system (2502) may be stored in both the local storage (2508) of the cloud computing instance (2504) and also in cloud-based object storage (2510) in the same manner that the cloud-based object storage (2510) was used above. In some embodiments, for example, the storage controller application (2506) may be responsible for writing data to the local storage (2508) of the cloud computing instance (2504) while a software daemon (2512) may be responsible for ensuring that the data is written to the cloud-based object storage (2510) in the same manner that the cloud-based object storage (2510) was used above. In other embodiments, the same entity (e.g., the storage controller application) may be responsible for writing data to the local storage (2508) of the cloud computing instance (2504) and also responsible for ensuring that the data is written to the cloud-based object storage (2510) in the same manner that the cloud-based object storage (2510) was used above

Readers will appreciate that a cloud-based storage system (2502) depicted in FIG. 25 may represent a less expensive, less robust version of a cloud-based storage system than was depicted in FIG. 24. In yet alternative embodiments, the cloud-based storage system (2502) depicted in FIG. 25 could include additional cloud computing instances with local storage that supported the execution of the storage controller application (2506), such that failover can occur if the cloud computing instance (2504) that executes the storage controller application (2506) fails. Likewise, in other embodiments, the cloud-based storage system (2502) depicted in FIG. 25 can include additional cloud computing instances with local storage to expand the amount local storage that is offered by the cloud computing instances in the cloud-based storage system (2502).

Readers will appreciate that many of the failure scenarios described above with reference to FIG. 24 would also apply cloud-based storage system (2502) depicted in FIG. 25. Likewise, the cloud-based storage system (2502) depicted in FIG. 25 may be dynamically scaled up and down in a similar manner as described above. The performance of various system-level tasks may also be executed by the cloud-based storage system (2502) depicted in FIG. 25 in an intelligent way, as described above.

Readers will appreciate that, in an effort to increase the resiliency of the cloud-based storage systems described above, various components may be located within different availability zones. For example, a first cloud computing instance that supports the execution of the storage controller application may be located within a first availability zone while a second cloud computing instance that also supports the execution of the storage controller application may be located within a second availability zone. Likewise, the cloud computing instances with local storage may be distributed across multiple availability zones. In fact, in some embodiments, an entire second cloud-based storage system could be created in a different availability zone, where data in the original cloud-based storage system is replicated (synchronously or asynchronously) to the second cloud-based storage system so that if the entire original cloud-based storage system went down, a replacement cloud-based storage system (the second cloud-based storage system) could be brought up in a trivial amount of time.

Readers will appreciate that the cloud-based storage systems described herein may be used as part of a fleet of storage systems. In fact, the cloud-based storage systems described herein may be paired with on-premises storage systems. In such an example, data stored in the on-premises storage may be replicated (synchronously or asynchronously) to the cloud-based storage system, and vice versa.

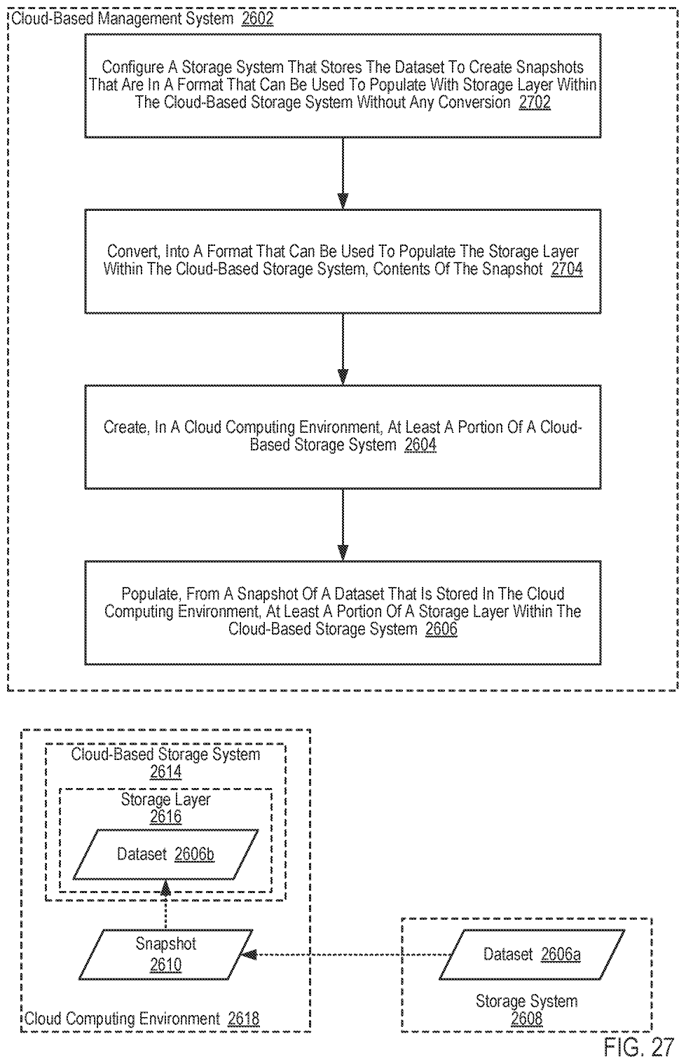

For further explanation, FIG. 26 sets forth a flowchart illustrating an example method of snapshot-based hydration of a cloud-based storage system 2614 in accordance with embodiments of the present disclosure. The cloud-based storage system 2614 of FIG. 26 may be similar to the cloud-based storage systems described elsewhere in this disclosure. The cloud-based storage system 2614 of FIG. 26 may be ‘hydrated’ in the sense that a dataset 2606b may be loaded into the cloud-based storage system 2614 (e.g., the cloud-based storage system 2614 stores a copy of the dataset 2606b after hydration occurs). The cloud-based storage system 2614 may be hydrated by retrieving or receiving data that is stored elsewhere in the cloud-computing environment 2618 and storing such data using one or more storage resources (e.g., virtual drives, ultra disks, EBS volumes) that are components of the cloud-based storage system 2614.

In the example depicted in FIG. 26, one or more snapshots of a dataset may be used to hydrate the cloud-based storage system 2614. The one or more snapshots represent a point-in-time copy of the dataset, with different points-in-time represented by different snapshots. For example, a first snapshot may include a copy of the dataset as it existed at a first time and a second snapshot may include a copy of the same dataset as it existed at a second (e.g., later) time.

In some embodiments, each snapshot may include only the changes that were made to the dataset since the previous snapshot was taken, such that a collection of snapshots may be needed to represent the entire dataset. For example, a first snapshot of the dataset may include all data in the dataset, a second snapshot of the dataset may include only data associated with changes to the dataset (e.g., an identification of portions of the dataset that were deleted after the first snapshot was taken, data that was written to the dataset after the first snapshot was taken, and so on) that occurred after the first snapshot was taken, a third snapshot of the dataset may include only data associated with changes to the dataset that occurred after the second snapshot was taken, and so on. Readers will appreciate that each snapshot may also include metadata that is associated with the data. Readers will further appreciate that although the term ‘snapshot’ is used specifically with respect to embodiments depicted in FIGS. 26-28, the concepts described in FIGS. 26-28 may be similarly applied to any copy of a dataset (e.g., a backup copy), including copies that are stored in one location (e.g., a cloud environment) that is distinct from one or more storage systems that store the original, live version of the dataset that is used to generate the copy.

The example method depicted in FIG. 26 includes storing 2603, in a cloud computing environment 2618, a snapshot 2610 of a dataset 2606a that is stored on a separate storage system 2608. The snapshot 2610 of the dataset 2606a that is stored on a separate storage system 2608 may be stored 2603 in the cloud computing environment 2618, for example, as a result of the separate storage system 2608 storing the snapshot 2610 in one or more cloud storage services that are distinct from a cloud-based storage system 2614. For example, the separate storage system 2608 may create a snapshot and store the snapshot in an S3 bucket that is provided by the cloud computing environment 2618.

The snapshot 2610 depicted in FIG. 26 includes a self-described copy of the dataset 2606a such that the dataset 2606a can be reconstructed without accessing the separate storage system 2608. That is, the snapshot 2610 is not intended to operate a copy of a dataset that is stored by a running storage system (running in the sense that the storage system can service I/O operations that are directed to the dataset from users of the storage systems such as a host computing device that is executing some application that stores and accesses data using the storage system). Instead, the snapshot 2610 is created and structured for the purpose of making it easy to reconstruct the content of a snapshot entirely from data self described within the snapshot store.

The example method depicted in FIG. 26 includes creating 2604, in a cloud computing environment 2618, at least a portion of a cloud-based storage system 2614. Creating 2604 at least a portion of a cloud-based storage system 2614 may be carried out as described above, including instantiating cloud computing instances that support the execution of a storage controller application, creating virtual machines that support the execution of a storage controller application, creating virtual drives that will be included in the cloud-based storage system 2614, creating Azure ultra disks that will be included in the cloud-based storage system 2614, creating Amazon EBS volumes that will be included in the cloud-based storage system 2614, and so on. Readers will appreciate that ‘at least a portion’ of a cloud-based storage system 2614 will be created 2602 as some components of the cloud-based storage system 2614 may already exist and the newly created components may be added to the already existing cloud-based storage system 2614. For example, creating 2604 at least a portion of a cloud-based storage system 2614 may include creating virtual drives that will be added to an already existing cloud-based storage system 2614. In other embodiments, an all of the compute resources and virtual drive components of the cloud-based storage system 2614 may be created 2602 in its entirety without leveraging any already existing instances of these components.

The example method depicted in FIG. 26 also includes populating 2606, from a snapshot 2610 of a dataset that is stored in the cloud computing environment 2618, at least a portion of a storage layer 2616 within the cloud-based storage system 2614. The storage layer 2616 may be embodied, for example, as a collection of virtual drives, as a collection of Azure ultra disks, as one or more Amazon EBS volumes, or embodied in some other way. Populating 2606 at least a portion of a storage layer 2616 from a snapshot 2610 of a dataset that is stored in the cloud computing environment 2618 may be carried out, for example, by storing the contents of the dataset that is contained in one or more snapshots 2610 in one or more of the storage resources described in the previous sentence, or otherwise extracting the contents of the dataset from the one or more snapshots 2610 and storing the extracted contents of the dataset in storage resources that are included in the cloud-based storage system 2614.

In FIG. 26, populating 2606 at least a portion of a storage layer 2616 within the cloud-based storage system 2614 from a snapshot 2610 of a dataset that is stored in the cloud computing environment 2618 can include loading 2607 at least a portion of the dataset 2606b into a virtual drive layer of the cloud-based storage system 2614. Loading 2607 at least a portion of the dataset into a virtual drive layer of the cloud-based storage system 2614 may be carried out, for example, by reading the contents of the dataset 2606b from the snapshot 2610, performing any steps necessary to prepare the dataset 2606b or the virtual drives for making the dataset 2606b available for I/O operations that are directed to the cloud-based storage system 2614 (including preparing any internal metadata representations of the dataset 2606b that are used by the cloud-based storage system 2614 to manage the dataset 2606b), and writing the contents of the dataset 2606b to the virtual drives. In other embodiments, the contents of the dataset 2606b may be written in part to the virtual drives or written in part to a backend object store for the cloud-based storage system 2614 as described above, written to one or more ultra disks that are included in the cloud-based storage system 2614, or otherwise written to some storage layer within the cloud-based storage system 2614.

In FIG. 26, populating 2606 at least a portion of a storage layer 2616 within the cloud-based storage system 2614 from a snapshot 2610 of a dataset that is stored in the cloud computing environment 2618 can alternatively include loading 2609 portions of the dataset into a virtual drive layer of the cloud-based storage system 2614 as those portions of the dataset 2606b are accessed by a user of the cloud-based storage system 2614. Loading 2609 portions of the dataset into a virtual drive layer of the cloud-based storage system 2614 as those portions of the dataset 2606b are accessed by a user of the cloud-based storage system 2614 may be carried out, for example, by creating a logical map of the blocks stored into a backup/snapshot store and using such a map to retrieve portions of the dataset on-demand or as needed, such that the cloud-based storage system 2614 may begin presenting the dataset 2606b to users and servicing I/O operations that are directed to the dataset 2606b in an incremental manner and without needing to first load an entire copy of the dataset 2606b into the cloud-based storage system 2614. In other embodiments, the contents of the dataset 2606b may be written in part to the virtual drives or written in part to a backend object store for the cloud-based storage system 2614 as those portions of the dataset 2606b are accessed by a user of the cloud-based storage system 2614, written to one or more ultra disks that are included in the cloud-based storage system 2614 as those portions of the dataset 2606b are accessed by a user of the cloud-based storage system 2614, or otherwise written to some storage layer within the cloud-based storage system 2614 as those portions of the dataset 2606b are accessed by a user of the cloud-based storage system 2614.

In other embodiments, the process of loading portions of a dataset whose contents are contained in a snapshot 2610 may run as a background process that loads the contents of the dataset 2606b into the cloud-based storage system 2614 over some period of time. Such a background process may prioritize the loading of the dataset 2606b based on some heuristics (e.g., a ‘hot’ portion of the dataset 2606b may be loaded into the cloud-based storage system 2614 before a ‘cold’ portion of the dataset 2606b is loaded into the cloud-based storage system 2614), or in some other way as guided by a set of rules or similar constructs. Readers will appreciate that the cloud-based storage system 2614 can service I/O operations to the dataset 2606b after the storage layer 2616 has been populated 2606.

The example depicted in FIG. 26 illustrates an embodiment in which a cloud-based management system 2602 carries out the steps of creating 2604 at least a portion of a cloud-based storage system 2614 and populating 2606 at least a portion of a storage layer 2616 within the cloud-based storage system 2614. The cloud-based management system 2602 may be embodied as one or more modules of computer program instructions executing on computer hardware, virtualized computer hardware, or some other execution environment. The cloud-based management system 2602 may be configured to monitor, manage, or otherwise observe one or more storage systems. In such an example, the cloud-based management system 2602 may include user interfaces such as a GUI, a CLI, or some other user interface through which a user (e.g., a system administrator) may monitor, manage, or otherwise observe one or more storage systems.

Readers will appreciate that although the cloud-based management system 2602 is depicted as carrying out the steps of creating 2604 at least a portion of a cloud-based storage system 2614 and populating 2606 at least a portion of a storage layer 2616 within the cloud-based storage system 2614, in other embodiments the cloud-based management system 2602 may simply initiate these functions. For example, the cloud-based management system 2602 may issue one or more commands or requests to other modules to create 2604 at least a portion of a cloud-based storage system 2614 and/or populate 2606 at least a portion of a storage layer 2616 within the cloud-based storage system 2614.

In addition to using the one or more snapshots 2610 to populate 2606 at least a portion of a storage layer 2616, other information that is contained in the snapshots may be extracted and utilized by the cloud-based storage system 2614. For example, the one or more snapshots 2610 may include metadata describing the dataset and such metadata may be utilized when configuring the cloud-based storage system 2614. Such metadata may include, for example, information that associates particular pieces of data with an internal metadata representation of the dataset, information that maps some portion of the dataset to another portion of the dataset for data deduplication purposes (e.g., some portion of the dataset may be represented using a pointer to another portion of the dataset so that that duplicated content does not need to be stored multiple times), and so on.

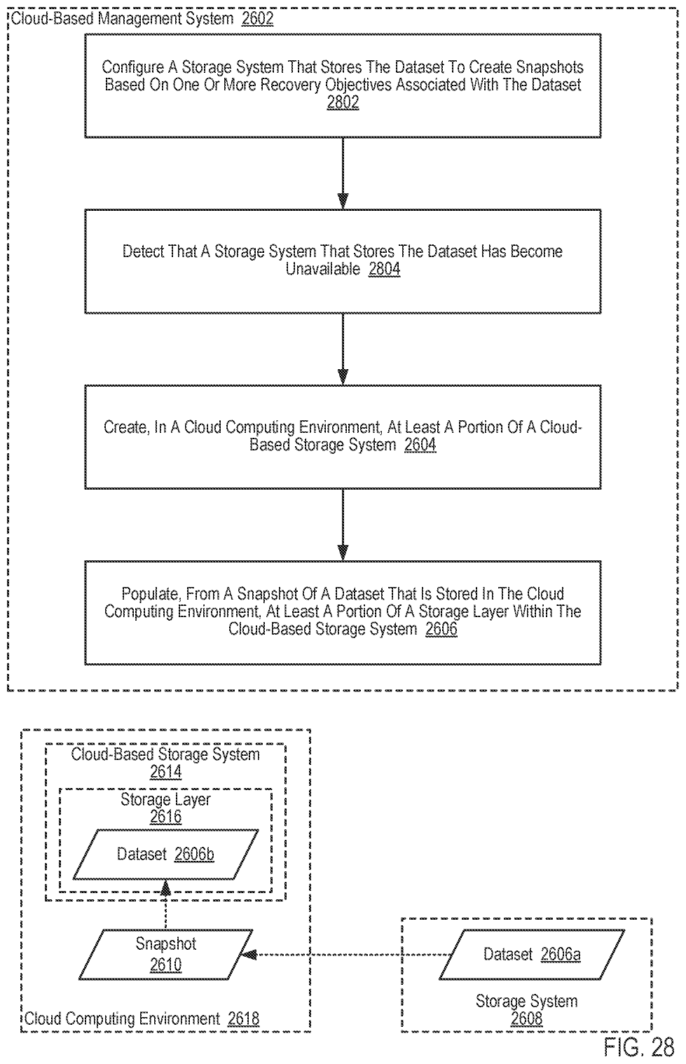

For further explanation, FIG. 27 sets forth a flowchart illustrating an example method of snapshot-based hydration of a cloud-based storage system 2614 in accordance with embodiments of the present disclosure. The example depicted in FIG. 27 is similar to the example depicted in FIG. 26, as the example depicted in FIG. 27 also includes creating 2604 at least a portion of a cloud-based storage system 2614 and populating 2606 at least a portion of a storage layer 2616 within the cloud-based storage system 2614.

The example depicted in FIG. 27 also includes converting 2704, into a format that can be used to populate the storage layer 2616 within the cloud-based storage system 2614, contents of the snapshot 2610. Readers will appreciate that in some embodiments the snapshot 2610 may be stored in a format that is not compatible with the storage layer 2616. In particular, the snapshot 2610 may be intended to serve as a backup copy of a dataset that was formatted to make it easy to reconstruct the content of a snapshot entirely from data that is self-described within the snapshot store. In contrast, data that is used to populate the storage layer 2616 within the cloud-based storage system 2614 is intended for a running storage system. Having a different history and different initial requirements can lead to format incompatibility. As such, the contents of the snapshot 2610 may need to be converted 2704 into a format that can be used to populate the storage layer 2616 within the cloud-based storage system 2614.

In other embodiments, other conversions may be carried out and such conversions may even include combining the data that is contained in the snapshot 2610 with some other data. For example, if the snapshot 2610 includes new data that overwrites a portion of an existing block of data, the new data from the 2610 may be combined with the portion of the existing block of data that was not overwritten to form a new block of data, which may be subsequently loaded into the storage layer 2616 of the to the cloud-based storage system 2614. Furthermore, such conversions handle the transformation of a format that was oriented toward storing snapshot data with a format that is oriented toward serving as a running storage system that can store new live data in whatever manner the running storage system would store new live data.

Readers will appreciate that although the term ‘snapshot’ is used in this disclosure, such a ‘snapshot’ may actually be organized a sequence of snapshots to operate more efficiently. For example, if some of a set of snapshots are stored as differential updates (i.e., incremental backups) while others are stored as “full” snapshots then only the the “full” snapshots might actually be completely self described. This can result in a situation where a dataset is conceptually reconstructed by reading the most recent “full” snapshot prior to a desired snapshot and then reading and applying updates from each subsequent snapshot until the desired “snapshot” is read and applied to create the desired complete snapshot. It can be appreciated content in earlier snapshots that is deleted or replaced in later snapshots could be elided if the implementation is sophisticated enough to account for those later deletions and replacements.

Readers will appreciate that such incremental forever stores can be expensive to restore, as there may be many of these incremental updates to apply in order. In embodiments in which a storage system utilized tape or disk storage, these were entirely impractical so it is common for “full” backups to be created periodically (e.g., every dozen or so backups). Other embodiments allowed for “synthetic” full backups which would be reconstructed by converting the last several snapshots into a “full” image that was either a sequential image on a new tape or a logical image that leaves the data in its original location but that constructs a map of a “full” to the blocks of that full with the results of logical overlays accounted for. Storage systems that leverage flash storage, however, can perform the creation of synthetic fulls less often, or with less concern for the randomization that occurs from leaving scattered blocks in their original locations, and that also allows the locations of stored data for synthetic full backups to be far more randomly scattered than is practical with disks and tapes. In fact, if logical map of the blocks stored into a backup/snapshot store can be created, that map can then be used to construct a map of the backing content needed for a running storage system. As such, a running storage system can be created by reading all that data to form a dataset that can be stored in a storage system to serve as the basis for operating that dataset in the running storage system.

In an alternative embodiment, the map of the stored locations for the dataset may be used as the initial dataset for the running storage system which can cache on-the-fly. In the on-the-fly cache model, the running storage system would know how to read the data as needed, but would then operate for all subsequent operations by storing new data as it would normally, gradually transforming the original data (such as through migration or garbage collection or a combination) into the run-time oriented formats and structures used by the running storage system implementation. In some embodiments, portions of the dataset may be loaded into a virtual drive layer (or some other layer of the cloud-based storage system) of the cloud-based storage system 2614 as those portions of the dataset are accessed by a user of the cloud-based storage system 2616. Likewise, in some embodiments, the cloud-based storage system 2614 may, upon receiving an operation to add new data to the dataset, write the new data to the dataset in accordance with the the more run-time oriented formats and structures used by the running storage system implementation. As such, in situations where the new data represents an overwrite of old data that was stored in a snapshot, the new data may be written to the cloud-based storage system 2614 without ever retrieving, from the snapshot, any old data that is being overwritten by the new data. Furthermore, once data is written into the cloud-based storage system 2614 in its run-time oriented format (e.g., due to an overwrite, due to data being loaded or migrated into the cloud-based storage system 2614, or for some other reason), subsequent reads will retrieve the data that is stored in its run-time oriented format from cloud-based storage system 2614. Further, the cloud-based storage system 2614 may track the locations in the snapshot store and in the cloud-based storage system's 2614 native storage (e.g., a storage layer of the cloud-based storage system 2614) of unaffected, modified, deleted, and replaced data in its native storage and in its native run-time oriented format. In short, the cloud-based storage system's 2614 operates normally except when operating on data that has not yet been migrated, modified, deleted, or replaced. Stated differently, once a particular portion of the dataset has been loaded into the storage layer (i.e., the portion of the dataset is stored in the storage layer) within the cloud-based storage system, the cloud-based storage system utilizes the particular portion of the dataset that is loaded into the storage layer within the cloud-based storage system (rather than the snapshot) for subsequent accesses of the particular portion of the dataset. Such data may be stored in the storage layer, for example, as the result of the data being migrated from a snapshot, as the result of an overwrite operation that is received from a user of the cloud-based storage system, or in some other way.

Readers will appreciate that in some embodiments, a garbage collection process may be useful to add into the processes described herein. Through the use of a garbage collection process, only a subset of snapshots may be retained over the course of time, with fewer aged snapshots retained. In fact, a garbage collection can be one of the processes for reorganizing the remaining retained data so that some of it can be deleted.

In an alternative embodiment, the snapshot 2610 of the dataset 2606b may already be in a format that can be used to populate 2606 the portion of a storage layer 2616 within the cloud-based storage system 2614 without any conversion. In such an example, the storage system 2608 that creates the snapshot (or some other module that creates snapshots 2610 of the dataset 2606a that is stored on the storage system 2608) may be configured to format the snapshots 2610 in a format that can be used to populate the storage layer 2616 within the cloud-based storage system 2614 without any conversion, such that the formatting of the content of the snapshots 2610 occurs prior to storing the snapshots 2610 in the cloud computing environment 2618. Readers will appreciate that this process can save costs associated with the cloud computing environment 2618, where reading data, writing data, and utilizing computing resources that may be required to perform a conversion may all come with an associated financial cost. To that end, the example depicted in FIG. 27 also includes configuring 2702 a storage system 2608 that stores the dataset 2606a to create snapshots 2610 that are in a format that can be used to populate the storage layer 2616 within the cloud-based storage system 2614 without any conversion.

Configuring 2702 a storage system 2608 that stores the dataset 2606a to create snapshots 2610 that are in a format that can be used to populate the storage layer 2616 within the cloud-based storage system 2614 without any conversion may be carried out in a variety of ways. For example, the cloud-based management system 2602 or some other entity may configure 2702 the storage system 2608 (or send requests/instructions to the storage system 2608 to configure itself) to generate snapshot that that are in a format that can be used to populate the storage layer 2616 within the cloud-based storage system 2614 without any conversion. Alternatively, the cloud-based management system 2602 or some other entity may provide the storage system 2608 with a conversion module (that would be similar to a conversion module executed in the cloud computing environment 2618 in embodiments where the conversion took place in the cloud) that could converting 2704 the contents of the snapshot 2610 into a format that can be used to populate the storage layer 2616 within the cloud-based storage system 2614. In yet an alternative embodiment, the cloud-based management system 2602 or some other entity may execute the conversion module and may store the converted version of the snapshot 2610 in the cloud computing environment 2618.

For further explanation, FIG. 28 sets forth a flowchart illustrating an example method of snapshot-based hydration of a cloud-based storage system 2614 in accordance with embodiments of the present disclosure. The example depicted in FIG. 28 is similar to the example depicted in FIGS. 26-27, as the example depicted in FIG. 28 also includes creating 2604 at least a portion of a cloud-based storage system 2614 and populating 2606 at least a portion of a storage layer 2616 within the cloud-based storage system 2614.

The example depicted in FIG. 28 also includes detecting 2804 that at least a portion of the storage system 2608 that stores the dataset 2606a has become unavailable. In some embodiments, the storage system 2608 that has become unavailable is an on-premises storage system. In other embodiments, the storage system 2608 has become unavailable is a cloud-based storage system. Detecting 2804 that at least a portion of the storage system 2608 that stores the dataset 2606a has become unavailable may therefore be carried out in a variety of ways, some of which are based on the nature (e.g., on premises or cloud-base) of the storage system 2608 itself. Detecting 2804 that at least a portion of the storage system 2608 that stores the dataset 2606a has become unavailable may be carried out, for example, by detecting that a response has not been received from the storage system 2608 via a heartbeating mechanism that is used to monitor the storage system 2608, by detecting that one or more I/O operations that are directed to the storage system 2608 have timed out or otherwise encountered an error, by determining that one or more cloud computing resources (e.g., a virtual machine, an EC2 instance) that are used as a virtual drive or virtual storage controller have failed or otherwise become unavailable, by determining that one or more Azure ultra disks have failed or otherwise become unavailable, or otherwise carried out in some other way. In some embodiments, the cloud-based management system 2602 may be responsible for monitoring the storage system 2608 and may be the entity that detects 2804 that at least a portion of the storage system 2608 that stores the dataset 2606a has become unavailable.

In some embodiments, creating 2604 at least a portion of a cloud-based storage system 2614 and populating 2606 at least a portion of a storage layer 2616 within the cloud-based storage system 2614 may be carried out in response to detecting 2804 that the storage system 2608 that stores the dataset 2606a has become unavailable. In such embodiments, the cloud-based storage system 2614 may therefore serve as a dynamically created failover system that is not created until an actual failure has occurred. In other embodiments, however, the cloud-based management system 2602 may predict that a failure is coming based on monitoring the storage system 2608, such that creating 2604 at least a portion of a cloud-based storage system 2614 and populating 2606 at least a portion of a storage layer 2616 within the cloud-based storage system 2614 may be carried out in advance of an actual failure. In some embodiments, once the storage system 2608 recovers and begins operating normally (or some other failover system is in a condition to service I/O operations directed to the dataset 2606a), the cloud-based storage system 2614 may be torn down by terminating all of the computing resources that are included in the cloud-based storage system 2614, releasing any storage resources that are included in the cloud-based storage system 2614, and performing any other steps required to terminate (in whole or in part) the cloud-based storage system 2614.

The example depicted in FIG. 28 also includes configuring 2802 a storage system 2608 that stores the dataset 2606a to create snapshots 2610 based on one or more recovery objectives associated with the dataset 2606a. The recovery objectives associated with the dataset 2606a may specify, for example, a recovery time objective (‘RTO’) associated with the dataset 2606a that specifies an amount of time after the occurrence of a disaster (e.g., storage system 2608 becomes unavailable) that the dataset 2606a should become available again (e.g., via the cloud-based storage system 2614). The recovery objectives associated with the dataset 2606a may also specify, for example, a recovery point objective (‘RPO’) associated with the dataset 2606a that specifies an amount of data loss that is acceptable in the event of a disaster, typically expressed in terms of time (e.g., an RPO of 5 seconds means that data written to the storage system 2608 within 5 seconds of the storage system 2608 failing can be lost without violating the RPO). The recovery objectives associated with the dataset 2606a may be received, for example, via a GUI that is presented to a user (e.g., a system administrator) by the cloud-based management system 2602.

Configuring 2802 a storage system 2608 that stores the dataset 2606a to create snapshots 2610 based on one or more recovery objectives associated with the dataset 2606a may be carried out, for example, by cloud-based management system 2602 configuring a snapshot schedule for the storage system 2608, by the cloud-based management system 2602 instructing the storage system 2608 to create a snapshot 2610 upon detecting a predetermined amount of activity (e.g., a predetermined amount of data has been written or modified) on the storage system 2608, or in some other way. In such an example, the storage system 2608 may therefore be configured to create snapshots 2610 and replicate the snapshots 2610 to the cloud computing environment 2618 such that the recovery objectives may be met. Consider an example in which the recovery objectives includes an RPO setting for the dataset 2606a indicating that, if the storage system 2608 fails, all data that was included within the dataset up to 5 minutes prior to the failure should be recoverable. In such an example, the storage system 2608 may be configured to take snapshots of the dataset 2606a every 5 minutes such that the RPO can always be achieved.

Readers will appreciate that in the examples described above, the cloud-based management system 2602 is depicted as performing a variety of steps. In other embodiments, the cloud-based management system 2602 may instruct other modules to perform these steps, request that other modules perform these steps, or otherwise initiate the performance of such steps even if they are not actually carried out by the cloud-based management system 2602 itself.

It is noted that the above-described embodiments may comprise software. In such an embodiment, the program instructions that implement the methods and/or mechanisms may be conveyed or stored on a non-transitory computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
storing, in a cloud computing environment, a snapshot of a dataset that is stored on a separate storage system, wherein the snapshot includes a self-described copy of the dataset such that the dataset can be reconstructed without accessing the separate storage system;
creating, in a cloud computing environment, at least a portion of a cloud-based storage system; and
populating, from the snapshot that is stored in the cloud computing environment, at least a portion of a storage layer within the cloud-based storage system, wherein the cloud-based storage system can service I/O operations to the dataset after the storage layer has been populated.

2. The method of claim 1 wherein populating the storage layer within the cloud-based storage system can include loading at least a portion of the dataset into a virtual drive layer of the cloud-based storage system.

3. The method of claim 1 wherein populating the storage layer within the cloud-based storage system can include loading portions of the dataset into a virtual drive layer of the cloud-based storage system as those portions of the dataset are accessed by a user of the cloud-based storage system.

4. The method of claim 1 wherein, once a particular portion of the dataset has been stored in the storage layer within the cloud-based storage system, the cloud-based storage system utilizes the particular portion of the dataset that is stored in the storage layer within the cloud-based storage system for subsequent accesses of the particular portion of the dataset.

5. The method of claim 1 wherein the snapshot includes a plurality of incremental updates.

6. The method of claim 1 further comprising converting, into a format that can be used to populate the storage layer within the cloud-based storage system, contents of the snapshot.

7. The method of claim 1 further comprising configuring a storage system that stores the dataset to create snapshots that are in a format that can be used to populate the storage layer within the cloud-based storage system.

8. The method of claim 1 further comprising detecting that at least a portion of a storage system that stores the dataset has become unavailable.

9. The method of claim 8 wherein the storage system that has become unavailable is an on-premises storage system.

10. The method of claim 8 wherein the storage system that has become unavailable is a cloud-based storage system.

11. The method of claim 8 wherein creating at least the portion of the cloud-based storage system and populating at least the portion of the storage layer within the cloud-based storage system are responsive to detecting that at least a portion of the storage system that stores the dataset has become unavailable.

12. The method of claim 1 further comprising configuring a storage system that stores the dataset to create snapshots based on one or more recovery objectives associated with the dataset.

13. An apparatus comprising a computer processor, a computer memory operatively coupled to the computer processor, the computer memory having disposed within it computer program instructions that, when executed by the computer processor, cause the apparatus to carry out the steps of:
storing, in a cloud computing environment, a snapshot of a dataset that is stored on a separate storage system, wherein the snapshot includes a self-described copy of the dataset such that the dataset can be reconstructed without accessing the separate storage system;
creating, in a cloud computing environment, at least a portion of a cloud-based storage system; and
populating, from the snapshot that is stored in the cloud computing environment, at least a portion of a storage layer within the cloud-based storage system, wherein the cloud-based storage system can service I/O operations to the dataset after the storage layer has been populated.

14. The apparatus of claim 13 further comprising computer program instructions that, when executed by the computer processor, cause the apparatus to carry out the step of loading at least a portion of the dataset into a virtual drive layer of the cloud-based storage system.

15. The apparatus of claim 13 further comprising computer program instructions that, when executed by the computer processor, cause the apparatus to carry out the step of loading portions of the dataset into a virtual drive layer of the cloud-based storage system as those portions of the dataset are accessed by a user of the cloud-based storage system.

16. The apparatus of claim 13 further comprising computer program instructions that, when executed by the computer processor, cause the apparatus to carry out the step of converting, into a format that can be used to populate the storage layer within the cloud-based storage system, contents of the snapshot.

17. The apparatus of claim 13 further comprising computer program instructions that, when executed by the computer processor, cause the apparatus to carry out the step of detecting that at least a portion of a storage system that stores the dataset has become unavailable.

18. The apparatus of claim 13 further comprising computer program instructions that, when executed by the computer processor, cause the apparatus to carry out the step of configuring a storage system that stores the dataset to create snapshots based on one or more recovery objectives associated with the dataset.

19. A computer program product disposed upon a computer readable medium, the computer program product comprising computer program instructions that, when executed, cause a computer to carry out the steps of:
storing, in a cloud computing environment, a snapshot of a dataset that is stored on a separate storage system, wherein the snapshot includes a self-described copy of the dataset such that the dataset can be reconstructed without accessing the separate storage system;
creating, in a cloud computing environment, at least a portion of a cloud-based storage system; and
populating, from the snapshot that is stored in the cloud computing environment, at least a portion of a storage layer within the cloud-based storage system, wherein the cloud-based storage system can service I/O operations to the dataset after the storage layer has been populated.

20. The computer program product of claim 19 further comprising computer program instructions that, when executed, cause a computer to carry out the step of loading at least a portion of the dataset into a virtual drive layer of the cloud-based storage system.
